(19) United States
(12) Patent Application Publication
(10) Pub. No.: US 2026/0165907 A1
(43) Pub. Date: Jun. 18, 2026

(54) SELF-PROPELLING BODY LIMB MASSAGING DEVICE

(71) Applicant: Rollvy Inc., Pleasanton, CA (US)

(72) Inventors: Andre Maxim PERSIDSKY, Mill Valley, CA (US); Michael P. WALLACE, Pleasanton, CA (US)

(21) Appl. No.: 19/465,995

(22) Filed: Jan. 30, 2026

Related U.S. Application Data
(63) Continuation-in-part of application No. 18/103,467, filed on Jan. 30, 2023.
(60) Provisional application No. 63/331,896, filed on Apr. 18, 2022.
(60) Provisional application No. 63/431,723, filed on Dec. 11, 2022.
(60) Provisional application No. 63/751,842, filed on Jan. 31, 2025.

(51) Int. Cl. A61H 15/00

(52) U.S. Cl. CPC A61H 15/0078; A61H 2015/0014; A61H 2015/0021; A61H 2015/0071; A61H 2201/0192; A61H 2201/1215; A61H 2201/1695; A61H 2201/5071

(57) ABSTRACT

Self-propelling, portable massaging device which can move back and forth along an arm, leg, or other body part of a user while providing a massage to the user. A self-propelling, portable massaging device may include a housing having first and second ends, a massage element having a first end, a second end, and a longitudinal axis, said massage element being configured to be rotatably coupled to the first and second ends of the housing and to form a limb opening, and at least one drive motor in the housing configured to rotate the massage element about its longitudinal axis relative to the housing, wherein massage element is configured to travel along the limb as the drive motor rotates. Also described herein are methods of operating any of the self-propelling, portable massaging devices described herein.

### CLAIM OF PRIORITY

This application is a continuation-in-part of U.S. patent application Ser. No. 18/103,467, filed Jan. 30, 2023, which claims the benefit of U.S. Provisional Patent Application No. 63/331,896, filed Apr. 18, 2022, and of U.S. Provisional Patent Application No. 63/431,723, filed Dec. 11, 2022. This application also claims the benefit of U.S. Provisional Patent Application No. 63/751,842 filed Jan. 31, 2025. The entire contents of each of these applications are incorporated herein by reference.

### TECHNICAL FIELD

The present invention relates to a massaging device, in particular, to a self-propelling, portable massaging device which can move back and forth along an arm, leg, or other body parts of a user while providing a massage to the user.

### BACKGROUND OF THE INVENTION

Many different arm and leg massager devices are available today, which operate either in a manual or electronic form. For example, roller-based devices exist for manually massaging the arm, forearm, leg, calf, or other body parts of the user. The user can manually move or roll such a device back and forth across the desired body area, or alternately, can move his arm, hand, leg, or foot back and forth through a relatively stationary version of the device. Also, various massaging elements exist such as rollers, rotating balls, beads, and many more. Additionally, many vibration or percussive or pressure-based electronic massagers are available in various form factors for applying a vibration to a selected body area, or a controlled pressure using air for example.

However, one of the common problems with existing portable massaging devices is requiring the user to frequently move or reposition the device in order to target a new area or range of areas on the body for massage. This can negatively impact the relaxation effect sought by the user since it entails work and effort from the user. Special electronic massage devices such as chairs or massage cushions exist, which can largely automate the process of continuously moving a massage element through a pre-selected range of distance on the body, but these devices tend to be relatively large, expensive, and not particularly portable.

A large variety of percussive or percussion gun-type massagers are available today, typically marketed for sports recovery and post-workout recovery and relaxation. These percussive massagers are typically hand operated, requiring the user to manually move the device back and forth across the target body area, such as arms or legs, while it percusses. Many of these percussive massagers tend to be on the heavy side, requiring a non-insignificant effort on the user's part to move and handle, interfering with the intended relaxation goal. Another disadvantage is inconsistency and non-uniformity of the user's coverage of the target body area in terms of both duration and location, since again the device relies on manual movement, resulting in potential inconsistent application to body areas and inconsistent recovery.

Another class of relevant devices are the pneumatic compression or sequential compression devices. These are full-leg or arm compression boots or sleeves, which typically apply sequential pressure across inflatable air chambers for delivering sequential pressure to the affected limbs or even torso. These devices are marketed today for both consumer and medical applications, including sports and post-workout recovery, and for conditions such as lymphedema, venous insufficiency, and edema. While these devices can automate the delivery of pressure, they tend to be extremely bulky, not portable, and very costly, impacting users'willingness to use them. Additionally, because these devices typically work with discrete air chambers, they are not applying a truly continuous massage movement from distal to proximal on the target limb, but rather in steps, which can be sub-optimal for the continuous consistent movement of lymphatic fluid for example, and potentially less effective than MLD (manual lymphatic drainage) massage. Additionally, since they use air pressure through chambers as the means of contact, there can be a lessened tactile feel against skin.

Japanese Patent Application Number JP2010029612A illustrates one of the existing massaging devices. In particular, the document proposes a massager with a bracelet function. Both ends of a curled cord, made of a soft material, are connected to each other via a ball in a ring form. One end of the curled cord is supplied with an adhesive and inserted into an installation hole of the ball made of acrylic resin, up to its middle. Similarly, the other end supplied with an adhesive is inserted into the hole from the opposite side and both the ends are connected to each other. Subsequently, a ring shape assembled with the curled cord and the ball is produced. A user can fit the ring between the thumb and the first finger through the palm and back of the hand. This arrangement allows the user to vary the intensity of the massage. For instance, when a strong massage is needed, the ball is brought to the palm, but when a weak or moderate massage is required, the curled cord is placed onto the palm and rolled to give the massage.

However, the device illustrated in JP2010029612A must be operated manually by the user throughout the duration of the massage. Consequently, the device does not allow the user to completely relax during the massage. Therefore, it is desirable to have a massaging device that operates automatically according to the massaging requirements of a user.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

In a first aspect of the disclosed technologies, a self-propelling massaging device comprises a housing having first and second ends. A massage element having a first end, a second end, and a longitudinal axis, is configured to be rotatably coupled to the first and second ends of the housing and to form a limb opening. At least one drive motor in the housing configured to rotate the massage element about its longitudinal axis relative to the housing, causing the massage element to travel along the limb as the drive motor rotates.

In some instances, the massaging device may further comprise one or more rollers on the housing, where said one or more rollers may be driven by the at least one motor.

In such instances, the one or more rollers may comprise first and second rollers which are configured to be coupled to the first and second ends of the massage element.

In such instances, the first and second rollers may be driven by a single drive motor.

Alternatively, in such instances, first and second drive motors may be coupled to the first and second rollers respectively.

In some instances, the housing may be configured to hold the rollers in a V-shaped orientation.

In some instances, the housing may be configured to hold the rollers in a parallel orientation.

In some instances, the housing may be configured to hold the rollers in a laterally offset orientation.

In some instances, the rollers may have hinged connections to the housing.

In some instances, the massage element may be configured to longitudinally stretch over the limb. For example, the massage element may comprise a coil, a cord, a stretch band, a bellows, or a tubular braid mesh.

In some instances, the massage element may comprise a tubular massage element.

In some instances, the massaging device may further comprise a tensioning member disposed in a lumen of the tubular massage element. For example, the tensioning element comprises a cable or any similar elongate element configured to provide a tensioning force when pulled at one or both ends.

In such instances, a tension motor may be provided to draw on at least one end of the cable to controllably constrict the tubular massage element about the limb.

In such instances, the massaging device may further comprise a spool coupled to the tension motor and configured to take up the at least one end of the cable as the tension motor is driven.

In such instances, the massaging device may further comprise a sensor configured to measure the pressure applied on the limb by the tensioning element.

In such instances, the massaging device may further comprise a feedback system configured to control a tension force applied by the tension motor based on an output of the pressure sensor.

In some instances, the massage element may be detachable and replaceable from the massaging device.

In some instances, the tubular massage element may be configurable with a plurality of textured protrusions for causing an enhanced massage stimulation to the body part.

In some instances, the massage element may be made of elastic material.

In some instances, a diameter of the massage element may dynamically adapt to a diameter of the body part as the massaging device travels along the limb.

In some instances, the rollers may be configured to function as secondary massage elements as the massaging device travels along the limb.

In some instances, the rollers may each comprise a plurality of protruding elements around an outer surface thereof to provide an enhanced massage stimulation to the limb.

In some instances, the massaging device may further comprise a control unit for controlling operation of the massaging device.

In such instances, the control unit may be disposed on or within the housing

In such instances, the control unit may be external to the housing.

In such instances, the control unit may be configured to control at least one of setting a distance range for each cycle of movement of the massage device along the body part, controlling speed of rotation of the one or more drive motors, and powering-on or powering-off of the massaging device.

In such instances, the control unit may be configured to autonomously control the massaging device.

In such instances, the control unit may be configured to allow a user to manually control the massaging device.

In such instances, the control unit may be configured to be programmed by an external wireless device.

In a second aspect of the disclosed technologies, a method for massaging a user's body limb comprises placing the body limb in an opening of a massaging device so that a massage element of the massaging device at least partially surrounds and contacts the body limb. A drive motor within the massaging device may then be turned on to cause the massage element to rotate about its longitudinal axis and to travel along the limb to massage the limb as it travels.

In some instances, the drive motor is located in a housing and the massage element rotates relative to the housing which does not rotate.

In some instances, the massage element stretches over the body limb to apply constricting tension on the body limb as the massage element travels along the body limb.

In some instances, the method further comprises controlling tension on a tensioning element within the massage element as the massage element travels along the body limb.

In such instances, tension on the tensioning element may be controlled in response to pressure on the limb measured by a sensor.

Disclosed herein is a self-propelling massaging device. The massaging device comprises a massage element having two ends. In an embodiment, the two ends of the massage element may be open, such that the massage element may be connected or attached to one or more rotational connectors using any suitable attaching means. Alternatively, the two ends of the massage element may be closed and/or plugged and connected to the one or more rotational connectors.

The ends of the massage element are attached to the one or more rotational connectors to form a limb opening, wherein the limb opening is at least partially surrounded by the massage element. A user inserts a body part into the limb opening for contact with and massaging by the massage element. The one or more rotational connectors are connected to one or more motors. The one or more motors provide a rotational movement to the one or more rotational connectors. The one or more rotational connectors cause a rotation of the ends of the massage element resulting in a rotation of the massage element, and the propelling of the massaging device along the limb inserted into the limb opening, when the one or more rotational connectors are rotated by the one or more motors. In an embodiment, the massage element may be rotated either from the ends connected to the one or more rotational connectors or rotated with reference to any other point along the length of the massage element. As an example, the massage element may be rotated from the middle of the massage element.

Further, the present disclosure relates to a method of controlling operations of a self-propelling massaging device. The method comprises counting, by a control unit of the massaging device, a total number of rotations completed by the one or more rotational connectors in a first direction during operation of the massaging device. Further, the method comprises detecting an input provided by a user of the massaging device. Furthermore, the method comprises changing the movement of the one or more rotational connectors to a second direction upon detecting the user command. Thereafter, the method comprises counting a total number of rotations completed by the one or more rotational connectors in the second direction. Subsequently, the method comprises reversing the movement of the one or more rotational connectors to the first direction when the total number of rotations completed in the second direction is equal to the total number of rotations completed in the first direction, thereby facilitating automated propelling of the massaging device. In an alternative embodiment, the method may change the direction of the one or more rotational connectors based on a predefined time count instead of the number of rotations. That is, the one or more rotational connectors may be configured to reverse the direction of their movement after every 10 seconds of operation for example, causing a to-and-fro movement of the massage element on the surface of the body part. In an embodiment, the parameters such as speed of rotation and the predefined time count may be dynamically set by the user of the massaging device.

One object of the present invention is to provide a self-propelling massaging device which can independently move back and forth along a range of distance on a selected body area or limb such as an arm or leg, or other body areas such as the torso, neck, foot, hand, or fingers without requiring the user to move the device or frequently intervene in other aspects of its operation.

Another object of the present invention is to provide a self-propelling massaging device which can maintain adequate pressure as it moves along a body limb of varying diameter, to provide a pleasing and satisfying massage sensation to the user throughout the range of movement.

Another object of the present invention is to provide a self-propelling massaging device which can utilize a massage element that can dynamically vary in diameter to accommodate the changing diameter of a body limb as the massaging device moves along its length.

Another object of the present invention is to provide a detachable and replaceable massage element which can be provided in different lengths to accommodate different diameter body areas with large average differences in diameter such as a leg or arm, or alternately, provide a mechanism for lengthening or shortening the massage element without requiring detachment.

Another object of the present invention is to provide a self-propelling massaging device for which the range of distance traveled on the body can be cycled based on an input provided by the user.

In another object of the present invention, the self-propelling massaging device can be powered by a rechargeable battery to make it convenient to reuse.

In another object of the present invention, the self-propelling massaging device can be employed for a wide range of potential benefits across the following non-exhaustive list of applications, including: sports medicine and athletic performance (e.g., pre and post-workout muscle preparation and recovery, reduction of muscle soreness and fatigue, and enhancement of athletic performance through muscle relaxation and improved circulation, etc.); decreasing inflammation (e.g., provide targeted massage therapy to areas of inflammation, such as the joints or muscles, etc.); promoting relaxation (e.g., provide a relaxing massage, which could help to improve sleep, reduce anxiety, and boost the immune system, etc.); lymphatic disorders (e.g., lymphedema management and reduction of limb swelling, lymphatic drainage enhancement for individuals with compromised lymphatic systems, etc.); management of conditions like lipedema, where abnormal fat distribution causes swelling; circulatory conditions (e.g., promotion of blood circulation in individuals with peripheral arterial disease, assistance in venous insufficiency by improving venous return, reduction of edema in individuals with chronic venous disorders, etc.); rehabilitation and physical therapy (e.g., facilitation of muscle relaxation and recovery after strenuous exercise, assistance in muscle re-education following injuries or surgeries, aid in restoring range of motion and flexibility after orthopedic procedures, promotion of neurorehabilitation for stroke patients or individuals with motor impairments, support for gait training and improving balance in patients with mobility impairments, etc.); pain management (e.g., alleviation of muscular pain and tension caused by conditions like fibromyalgia, relief from chronic pain associated with musculoskeletal disorders, relaxation of muscle spasms and reduction of trigger point pain, etc.); occupational health (e.g., prevention and reduction of work-related musculoskeletal disorders, alleviation of muscle fatigue and tension in individuals with physically demanding jobs, relaxation and stress reduction for individuals with sedentary work lifestyles, etc.); elderly care (e.g., enhanced circulation and reduction of swelling in the aging population, promotion of muscle tone and flexibility in older adults, support for mobility and fall prevention in the elderly, etc.); chronic conditions (e.g., symptom management for chronic pain conditions like arthritis, support for individuals with conditions like multiple sclerosis or muscular dystrophy, assistance in managing chronic fatigue syndrome or fibromyalgia symptoms, etc.); home healthcare (e.g., provision of therapeutic benefits in a home setting for various medical conditions, support for individuals with limited access to regular medical appointments, etc.); and improving wound healing (e.g., provide targeted massage therapy to areas with wounds, such as pressure sores or surgical incisions, etc.).

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. The same numbers are used throughout the figures to reference like features and components, in which:

FIG. 1 shows an exemplary front view of a first embodiment of the proposed self-propelling massaging device.

FIGS. 1A and 1B show the placement of the massage element on the user's body part (i.e., arm of the user) inserted through the limb opening of the massage element.

FIGS. 1C and 1D show exemplary views of a functional prototype of the proposed massaging device.

FIG. 2 shows an exemplary transparent front view of a first embodiment of the self-propelling massaging device.

FIG. 3 shows an exemplary block diagram of a control unit of the self-propelling messaging device.

FIG. 4 shows a top view of a first embodiment of the massage element.

FIG. 5 shows an exemplary variation in the structure of the massage element.

FIG. 6 shows an exemplary flowchart illustrating a method of controlling the self-propelling messaging device.

FIG. 7 shows an exemplary front view of a second embodiment of the proposed self-propelling massaging device with the cover removed.

FIG. 8 shows an exemplary front view of a second embodiment of the self-propelling massaging device with the cover in place.

FIG. 9 shows a sectional view of the second embodiment of the self-propelling massaging device.

FIG. 10 shows an alternate embodiment of the self-propelling massaging device where rotational connectors or secondary massage elements are actively rotated by a motor.

FIG. 11 shows a partial view of a massage element where the coils are textured with small protrusions.

FIG. 12 shows a bottom perspective view of a second embodiment of the self-propelling massaging device with a vibrational device inside.

FIG. 13 shows a front rendered view of the self-propelling massaging device utilizing two separate massage elements.

FIG. 14A shows a front rendered view of an alternate embodiment of the self-propelling massaging device where the motors are driving the secondary massage elements, and the massage element freely rotates on its own.

FIG. 14B shows a front rendered view of an alternate embodiment of the self-propelling massaging device where one motor is driving the rotation of a massage element, and a second motor is driving the rotation of one secondary massage element.

FIG. 15 shows a wireframe view of an embodiment of the present invention utilizing motors with 90-degree shafts to drive the massage element, and a central roller driven by a third motor.

FIG. 16 shows a cutaway rendered view of an embodiment of the present invention utilizing motors with 90-degree shafts to drive the massage element, and a central roller driven by a third motor.

FIG. 17 shows a side rendered view of an embodiment of the present invention containing a battery and the PCB onboard the moving massage device with no external wires needed.

FIG. 18 shows an elevated wireframe view of an embodiment of the present invention containing a battery and the PCB onboard the moving massage device with no external wires needed.

FIG. 19 shows a working prototype of an embodiment of the present invention containing a battery and the PCB onboard the moving massage device with no external wires needed, and with a tubular braided wire mesh as the massage element.

FIG. 20 shows a side wireframe view of another embodiment of the present invention containing a battery and the PCB onboard the moving massage device with no external wires needed.

FIG. 21 shows an elevated wireframe view of another embodiment of the present invention containing a battery and the PCB onboard the moving massage device with no external wires needed.

FIG. 22 shows a working prototype of an embodiment of the present invention containing a battery and the PCB onboard the moving massage device with no external wires needed, and with a tubular braided wire mesh as the massage element.

FIG. 23 shows a tubular braided wire mesh with surface corrugations as the massage element, heat-set in a radially expanded configuration.

FIG. 24 shows a tubular braided wire mesh with surface corrugations as the massage element, heat-set in a radially expanded configuration, and partially axially extended.

FIG. 25 shows a tubular braided wire mesh with surface corrugations as the massage element, heat-set in a radially expanded configuration, and further axially extended.

FIG. 26 shows a tubular braided wire mesh with surface corrugations as the massage element, heat-set in a radially expanded configuration, and fully axially extended.

FIG. 27 shows a tubular braided wire mesh on a mandrel prior to formation of corrugations and prior to heat treating.

FIG. 28 shows a rendered view of a percussive element mounted on platform for applying a percussive massage as the self-propelling massage device travels on the body.

FIG. 29 shows a sectional view of another embodiment of the present invention where the rotational connectors can be contained inside the massage element.

FIG. 30 shows an enlarged sectional view of rotational connectors contained inside the massage element, along with a device housing and mounted motors.

FIG. 31 shows a wireframe view of an embodiment similar to the embodiment in FIG. 29 but with a different angle orientation for the fixed motors with respect to the device housing and the massage element.

FIG. 32 shows a sectional view of an embodiment of the present invention with a feature to allow a user to manually change the circumference of a massage element by utilizing two separate massage element segments which telescopically fit into each other.

FIG. 33 shows a cutaway rendered view of an embodiment of the present invention with a feature to allow a user to manually change the circumference of a massage element by utilizing two separate massage element segments which telescopically fit into each other.

FIG. 34 shows a sectional view of another embodiment for adjusting the length of the massage element utilizing a lead screw which can function as a linear actuator, and where such an adjustment can occur automatically based on the device firmware and motor control, and with the lead screw shown in the fully tightened position.

FIG. 35 shows a sectional view of an embodiment for adjusting the length of the massage element utilizing a lead screw which can function as a linear actuator, and where such an adjustment can occur automatically based on the device firmware and motor control, and with the lead screw shown in the fully loosened position.

FIG. 36 shows a sectional view of an embodiment combining manual length adjustment of the massage element with the automatic length adjustment by a lead screw placed near one of the motors, with the lead screw shown in the tightened position.

FIG. 37 shows a sectional view of an embodiment combining manual length adjustment of the massage element with the automatic length adjustment by a lead screw placed near one of the motors, with the lead screw shown in the loosened position.

FIG. 38 shows a side rendered view of an alternate mechanism for adjusting the length of the massage element by retracting or extracting an end of the massage element into a secondary massage element or roller.

FIG. 39 shows a side rendered view of an embodiment of the present invention utilizing curved rollers shaped to fill in a gap to create a more circular limb opening.

FIG. 40 shows a side rendered view of another embodiment of the present invention where the PCB and battery are contained in the motor housings, and a hinge between them.

FIG. 41 shows a side rendered partially cutaway view of an embodiment of the present invention where the PCB and battery are contained in the motor housings, and a hinge between them.

FIG. 42 shows a wireframe view of another embodiment of the present invention with secondary massage elements attached in a flat orientation relative to the motors, and with no hinges.

FIG. 43 shows a wireframe view of another embodiment of the present invention with secondary massage elements attached at an angled orientation relative to the motors, and with no hinges.

FIG. 44 shows a sectional and schematic view of another embodiment of the present invention utilizing a tensioning system for applying pressure on a body limb via the massage element.

FIG. 45 shows a photo of a prototype of the massaging device on a calf muscle.

FIG. 46 shows a photo of a prototype of the massaging device on a forearm.

FIG. 47 shows a photo of a prototype of the massaging device with the cable inside the massage element with tension released, allowing the massage element to return to its baseline longer circumferential length.

FIG. 48 shows a photo of a prototype of the massaging device with the cable inside the massage element with maximum tension applied, compressing the length of the massaging element.

FIG. 49 shows a graph relating the braid stretch factor to the pressure applied on the leg by the massaging element.

FIG. 50 shows a sectional view of the present embodiment, detailing the winch components as well as the cable attachment on the opposite roller of the massaging device.

FIG. 51 shows a sectional view of the present embodiment, detailing the interfacing of two bevel gears and their attached rollers.

FIG. 52 shows an example of a motor having an open hollow central shaft.

FIG. 53A shows an external side view of another embodiment of the present invention, where the two roller bevel gears are interfaced via a gear train, and the angle between the rollers is 90 degrees.

FIG. 53B shows a wireframe view of another embodiment of the present invention, where the two roller bevel gears are interfaced via a gear train, and the angle between the rollers is 90 degrees.

FIG. 54A shows an external side view of another embodiment of the present invention, where the two roller bevel gears are interfaced via a gear train, and the angle between the rollers is 120 degrees.

FIG. 54B shows a wireframe view of another embodiment of the present invention, where the two roller bevel gears are interfaced via a gear train, and the angle between the rollers is 120 degrees.

FIG. 55 shows two band markers positioned on a limb for designating the desired travel range for the massaging device.

FIG. 56 shows an open housing view of another embodiment of the present invention, utilizing a drive belt or roller chain for rotating one of the massage element rollers.

FIG. 57 shows an open housing view of another embodiment of the present invention, utilizing a spur gear on a motor shaft for driving both massage element rollers.

FIG. 58 shows an open housing view of another embodiment of the present invention, utilizing a spur gear on a motor shaft for driving one of the massage element rollers, which in turn via bevel gears drives the other massage element roller.

FIG. 59 shows an elevated side of another embodiment of the present invention detailing a single motor for driving both roller, and with the rollers in-line with the motor.

FIG. 60 shows an open housing view of another embodiment of the present invention, utilizing a dual shaft motor for driving both massage element rollers using gears.

FIG. 61 shows an open housing view of another embodiment of the present invention, with a roller mounted over a motor, and a side post for mounting the second roller driven via bevel gears by the first roller.

FIG. 62 shows an elevated view of another embodiment of the present invention, detailing an arch or double-V shaped housing for helping to minimize housing wobbling on a limb as the device travels.

FIG. 63 shows an open housing view of another embodiment of the present invention, detailing an arch or double-V shaped housing for helping to minimize housing wobbling on a limb as the device travels.

FIG. 64 shows an elevated view of another embodiment of the present invention, where the massage element ends are arranged in a spiral.

FIG. 65 shows an elevated view of another embodiment of the present invention, where the massage element ends are arranged in a spiral and the housing forms a V or arch shape forming wings into which the massage element ends can be moved.

FIG. 66 shows a photo of a prototype of another embodiment of the present invention, where the massage element ends are perpendicular to the device housing, forming a U shape.

FIG. 67 shows a top open view of a prototype of another embodiment of the present invention, detailing a possible gear train for rotating the U shape massage element.

FIG. 68 shows a photo of a 90-degree motor and the possible arrangement of gears and rollers for driving a U-shaped massage element perpendicular to the motor body.

FIG. 69 shows a schematic of two 90-degree motors and the possible arrangement of gears and rollers for driving a U-shaped massage element in the middle between the motors, and perpendicular to the motor bodies.

FIG. 70 shows an elevated view of a crossed helical gear arrangement for driving the massage element rollers.

FIG. 71 shows a wireframe view of a minimalist version of the present invention, detailing a hexagonal housing shape and two roller drive motors at a preset, or hinge-supported variable angle.

FIG. 72A shows a cutaway view of another embodiment of the massaging device featuring a center roller.

FIG. 72B shows a sectional view of the massaging device.

FIG. 73 shows a non-cutaway view of the massaging device without the massage element attached.

FIG. 74 shows a perspective and cutaway view of the massaging device of the present embodiment wherein the winch is visible.

FIG. 75 shows a perspective and cutaway view of the massaging device of the present embodiment wherein the winch and cable guide are visible.

FIG. 76 shows a perspective view of a spool used in the winch in the present embodiment.

FIG. 77 shows the interior of the center roller where a nut can be used to secure the motor shaft.

FIG. 78A shows a perspective view of a motor holder attached to a motor.

FIG. 78B show the backside of the motor holder.

FIG. 79 shows a cutaway view of the device housing revealing a receptacle for the motor holder lug.

FIG. 80 shows a sectional view of an alternate location for the winch inside the massage element.

FIG. 81 shows a photograph of a prototype of the massaging device of the present embodiment.

FIG. 82 shows a photograph of a prototype of the massaging device of the present embodiment where the massage element rollers can be rotationally mounted over necks on the device housing.

FIG. 83 shows a photograph of a vacuum hose which can be used as a massage element.

FIG. 84 shows a sectional view of a coil with a covering which can be used as the massage element.

FIG. 85A shows a side view of another embodiment of the massaging device utilizing two center rollers.

FIG. 85B shows a cutaway view of the massaging device of the present embodiment utilizing two center rollers.

FIG. 85C shows a sectional view of the massaging device of the present embodiment utilizing two center rollers.

FIG. 86A shows a photo of a prototype of the massaging device of the present embodiment which utilizes two center rollers.

FIG. 86B shows a photo of a prototype of the massaging device of the present embodiment which utilizes two center rollers and actively massaging a calf muscle on the leg.

FIG. 87A shows a side view of another embodiment of the massaging device utilizing two center rollers with a hinge.

FIG. 87B shows a sectional view of the massaging device of the present embodiment utilizing two center rollers with a hinge.

FIG. 88 shows a side view of the massaging device of the present embodiment with the hinge in the rotated position.

FIG. 89 shows a photo of a prototype of the hinged massaging device of the present embodiment.

FIG. 90 shows a photo of a prototype of the hinged massaging device of the present embodiment with a winch placed between the center rollers.

FIG. 91 shows a photo of a prototype of the hinged massaging device of the present embodiment actively massaging the upper leg.

FIG. 92A shows a front perspective view of another embodiment of the massaging device utilizing two massage elements.

FIG. 92B shows a cutaway view of the massaging device of the present embodiment utilizing two massage elements.

FIG. 92C shows a side perspective view of the massaging device of the present embodiment utilizing two massage elements.

FIG. 92D shows a sectional view of the massaging device of the present embodiment utilizing two massage elements.

FIG. 93 shows a photo of a prototype of the massaging device of the present embodiment utilizing two massage elements.

FIG. 94 shows a photo of a prototype of the massaging device of the present embodiment moving on the leg and utilizing two massage elements.

FIG. 95 from below shows another photo of a prototype of the massaging device of the present embodiment moving on the leg and utilizing two massage elements.

FIG. 96 shows a perspective view of another embodiment of the massaging device utilizing two center roller housings driving two massage elements.

FIG. 97 shows a photo of a prototype of the massaging device of the present embodiment utilizing two center roller housings driving two massage elements.

FIG. 98 shows a photo of a prototype of another embodiment of the present invention utilizing two device housings and two massage elements all formed into one loop.

FIG. 99 shows a photo of a prototype of another embodiment of the present invention utilizing two device housings and two massage elements all formed into one loop and with the massage elements of equal length.

FIG. 100 shows a top view of another embodiment of the present invention utilizing three device housings and three massage elements all formed into one loop.

FIG. 101A shows a perspective view of another embodiment of the present invention with hidden massage element rollers inside the housing.

FIG. 101B shows a cutaway view of the present embodiment with hidden massage element rollers inside the housing.

FIG. 102A shows a side view of another embodiment of the present invention using a double-sided bevel gear for driving the massage element rollers.

FIG. 102B shows a cutaway view of the present embodiment using a double-sided bevel gear for driving the massage element rollers.

FIG. 103 shows an alternate gear train with a single drive motor longitudinally disposed.

FIG. 104A shows a perspective view of another embodiment of the present invention with two drive motors longitudinally disposed for driving the massage element rollers situated over the motors.

FIG. 104B shows a perspective cutaway view of the present embodiment with two drive motors longitudinally disposed for driving the massage element rollers situated over the motors.

FIG. 104C shows a photo of a prototype of the present embodiment with two drive motors longitudinally disposed for driving the massage element rollers situated over the motors.

FIG. 105A shows a perspective view of another embodiment of the present invention utilizing two drive motors and two belts for rotating the massage element rollers.

FIG. 105B shows a perspective cutaway view of the present embodiment utilizing two drive motors and two belts for rotating the massage element rollers.

FIG. 106A shows a side view of another embodiment of the massaging device with a winged shaped housing.

FIG. 106B shows a perspective cutaway view of the present embodiment of the massaging device with a winged shaped housing.

FIG. 107 shows a top view of a gear train utilizing internal and planetary gears for driving a massage element roller.

FIG. 108 shows a side view of a massaging device utilizing the gear train of the present embodiment.

FIG. 109 shows a side cutaway view of an alternate gear train for allowing winch cable passage.

FIG. 110 shows a photo of a partial prototype of a belt and gear train combination.

FIG. 111 shows a perspective view of another embodiment of the present invention with a center roller design with an added large passive roller.

FIG. 112A shows a cutaway side view of another embodiment of the massaging device with driver motors lying flat.

FIG. 112B shows a cutaway side view of the present embodiment of the massaging device with driver motors pitched at an upwards angle.

FIG. 113A shows a sectional view of another embodiment of the massaging device with a hinging element between the housing halves and with the halves in a flat orientation.

FIG. 113B shows a sectional view of the present embodiment of the massaging device with a hinging element between the housing halves and with the halves rotated outwards.

FIG. 114 shows a side view of the present embodiment of the massaging device with the massage element stretched and the hinging element pivoting the housing halves outwards along with the massage element ends.

FIG. 115 shows a sectional view of the present embodiment of the massaging device with a winch, winch cable, and pressure sensor added.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternatives falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises... a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

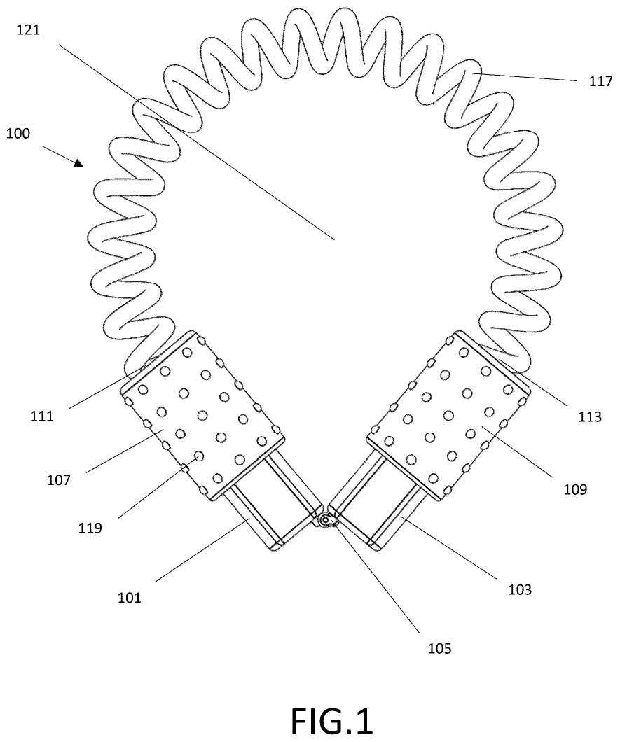

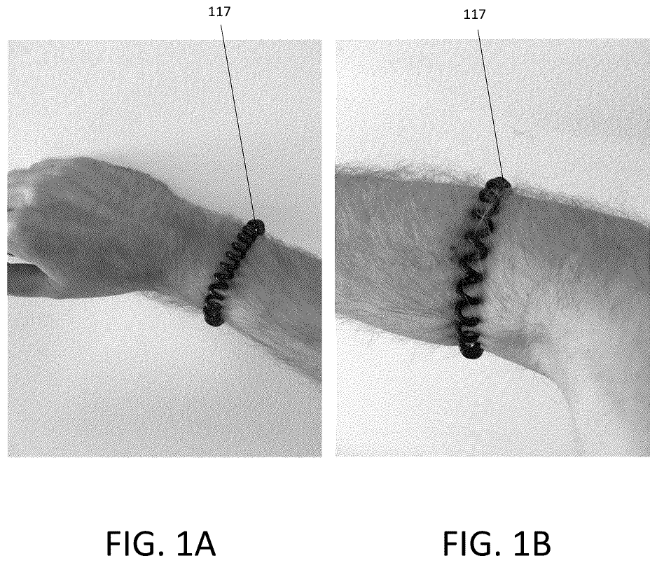

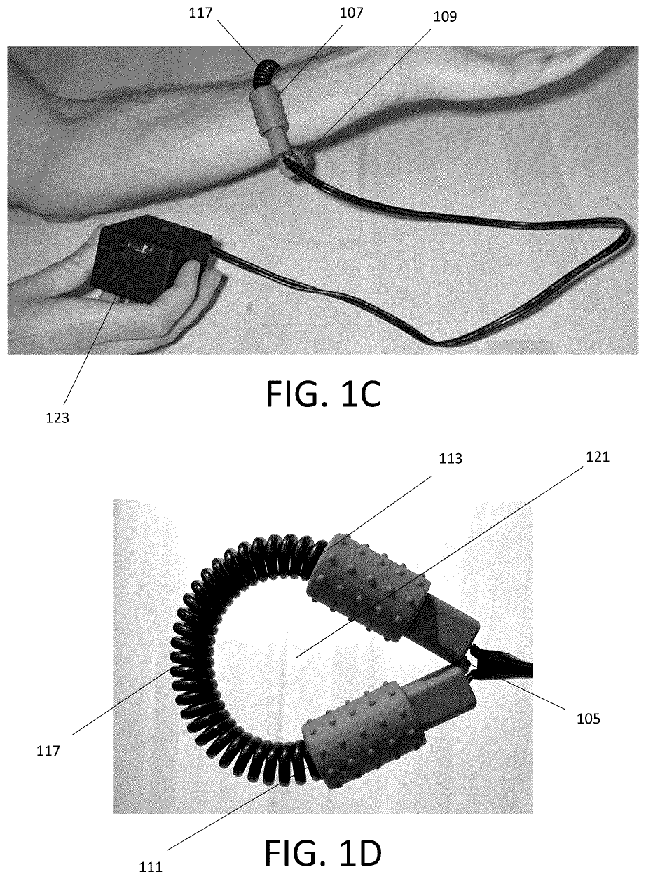

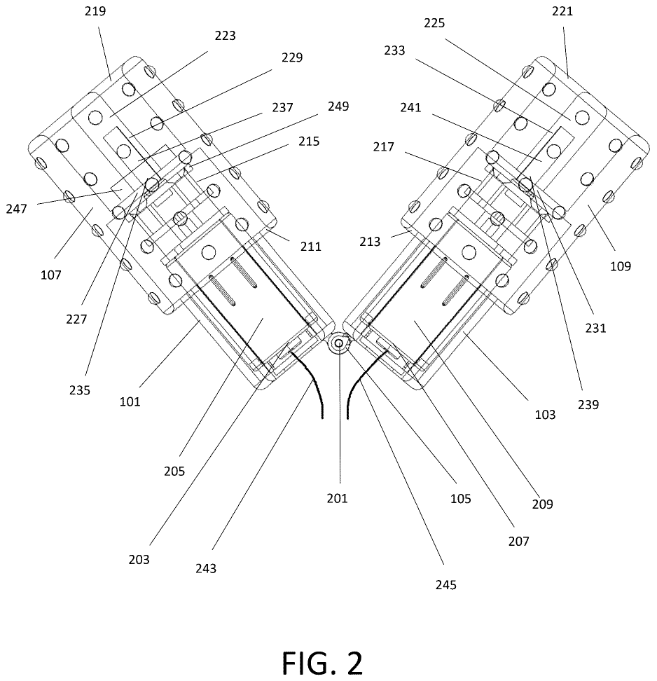

A first embodiment of a self-propelling massaging device 100 or massaging device 100 is shown in FIGS. 1-2. In an embodiment, massaging device 100 can include two motor housings 101 and 103, connected by a hinge 105, allowing motor housings 101 and 103 to rotate around a hinge axis 201 as shown in FIG. 2. Further, as shown in the transparent view in FIG. 2, the motor housings 101 and 103 can be open on their top ends for inserting and holding lower motor sections 203 and 207 of motors 205 and 209. The motors 205 and 209 are used to rotate rotational connectors 107 and 109 fitted onto the motor shafts 237 and 241. Further, the rotational connectors 107 and 109 can be cylindrically shaped to function as rollers, with open proximal compartments 211 and 213 into which upper motor sections 215 and 217 of motors 205 and 209 are inserted and held.

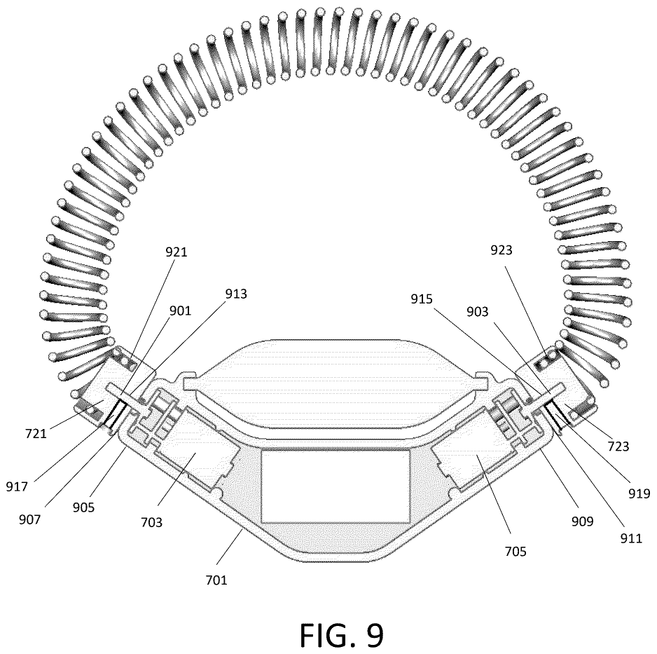

In an embodiment, the diameters of rotational connectors 107 and 109 are wide enough to provide clearance to rotate around the contained upper motor sections 215 and 217, as well as motor housings 101 and 103 which can partially reside therein. The top ends of rotational connectors 107 and 109 can have open distal compartments 219 and 221 for holding the ends 111 and 113 of a massage element 117 as shown in FIG. 1, and can be secured in a similar manner therein, for example, as shown in FIG. 9 for circular channels 921 and 923. The open distal compartments 219 and 221 can contain motor shaft posts 223 and 225 mounted onto center walls 227 and 231 inside of rotational connectors 107 and 109.

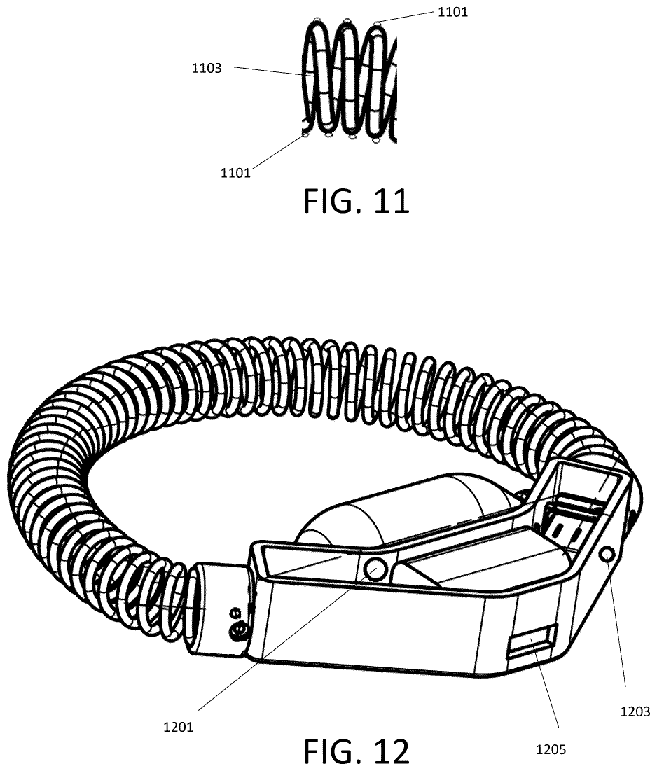

In an embodiment, the ends 111 and 113 of the massage element 117 may have a central open axis 1103 as shown in FIG. 11. The central open axes 1103 of the ends 111 and 113 can be placed over motor shaft posts 223 and 225 and secured by gluing for example. In an embodiment, the motor shaft posts 223 and 225 can contain shaft channels 229 and 233 with openings 235 and 239 from the proximal sides of center walls 227 and 231 for inserting and holding motor shafts 237 and 241. The motor shafts 237 and 241 can be ‘D’ shaped shafts for example, fitting into shaft channels 229 and 233, which can have corresponding female ‘D’ shaped profiles. In this overall arrangement, the rotational connectors 107 and 109 are covering and rotating around upper motor sections 215 and 217, while motor housings 101 and 103 contain and hold lower motor sections 203 and 207 to ensure that only motor shafts 237 and 241 and attached rotational connectors 107 and 109 rotate when motors 205 and 209 are switched on. In an implementation, the massage element 117 may have a coiled structure as shown in FIG. 4.

In an embodiment, the rotational connectors 107 and 109 which rotate the ends 111 and 113 of the massage element 117, can also further function as secondary massage elements (and be referred to as secondary massage elements 107 and 109 hereinafter), for example functioning as massage rollers which roll along and press against a limb such as an arm or leg and also assist in moving or propelling massaging device 100 along the limb. Combining the functions of rotational connectors and secondary massage elements provides a more compact and efficient design. Secondary massage elements 107 and 109 can be a roller for example, a ball transfer bearing, kneading-type ball-based massage elements, or other rotational structures. In case of a ball structure, it can have similar means for attaching ends 111 and 113 of massage element 117, as already discussed. It can optionally have a variety of textures on its surface, such as small bumps or protrusions for example, for enhancing the massage sensation while rolling against a body limb, and can be made from plastic, rubber, or other materials.

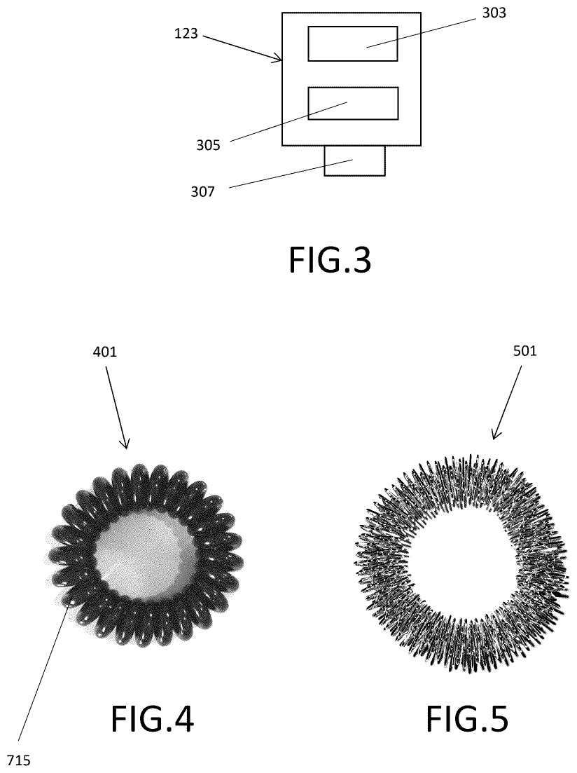

In an embodiment, the massaging device 100 can include a battery, a Printed Circuit Board (PCB), a user interface, comprising at least one or more buttons, and can include a switch, which enables a user for turning the device ‘ON’ or ‘OFF’. For example, motor housings 101 and 103 can be enlarged to contain these electrical components. Alternately, an external control unit or a control box 123 can be provided as shown in FIG. 3 and FIG. 1C for controlling the operation of massaging device 100. The control box 123 can include a battery 303, which may be a rechargeable battery, an optional PCB 305 similar to the PCB 709 later described, and a user control interface 307 which may comprise, without limiting to, one or more buttons, a 3-way slider switch for example, or other input means. The control box 123 can be electrically connected to motors 205 and 209 by wires 243 and 245 for example as shown in FIG. 2, for controlling the motors 205 and 209, or can be wirelessly connected to control motors 205 and 209 by using a wireless communication interface such as Bluetooth for example.

In an embodiment, to operate the massaging device 100, a user places a limb such as an arm or leg into a limb opening 121, as shown in figures FIG. 1, FIG. 1C, and FIG. 1D such that the massage element 117 at least partially surrounds the limb. The user can then operate user control 307 to turn on the motors and set their rotational directions. For example, the secondary massage elements 107 and 109 can both rotate inwards or outwards along with the massage element 117 to propel massaging device 100 proximally or distally along a limb. For example, the user can also manually operate user control 307 to change the direction of movement of massaging device 100 by changing the rotational direction of motors 205 and 209, in which case a PCB 305 may not be needed which simplifies manufacturing, or the user can set a program to automatically change directions along a limb, in which case it is preferable to include PCB 305.

In an embodiment, as the massaging device 100 moves along a limb of varying diameter as shown in FIGS. 1C and 1D, hinge 105 allows motor housings 101 and 103 along with secondary massage elements 107 and 109 to rotate towards or away from each other to accommodate the limb diameter of various shapes, and to keep secondary massage elements 107 and 109 more flat against the limb surface to help maximize contact as it moves, while the massage element 117 stretches in diameter.

The secondary massage elements 107 and 109 along with attached massage element 117 can be removeable from massaging device 100 and replaced with another set (secondary massage elements together with attached massage element), allowing the user to change the length of the deployed massage element 117, or the surface textures or bumps of the secondary massage elements, or just to replace these parts if worn out. For example, when using the massaging device 100 on an arm, the desirable length of massage element 117 may be shorter than when using the device on a thigh. In an embodiment, allowing to change the lengths of the massage element 117 also helps to accommodate naturally occurring ranges in body dimensions between different people. The secondary massage elements 107 and 109 can include a magnet 247 for example as shown in FIG. 2 for secondary massage element 107, which can be a ring magnet fitted over shaft post 223 and resting and secured to center wall 227. The magnet can be magnetically attracted to a plate 249 on motor 205. The plate 249 can be part of motor 205 or can for example be an external stainless-steel washer placed over motor shaft 237. In this arrangement, the secondary massage elements 107 and 109 can be magnetically held on motor shafts 237 and 241 as they rotate, preventing them from inadvertently sliding off while in contact with a limb. When the user applies a sufficient pulling force, they can break the magnetic hold and slide off secondary massage elements 107 and 109 from motor shafts 237 and 241, along with attached massage element 117 for replacement.

In an embodiment, the massage element 117 can consist of coils 715, and has a structure similar to a spiral hair tie 401 as shown in FIG. 4, which is typically used to hold women's hair in a ponytail for example, also similar to a coiled phone cord. Spiral hair ties, sometimes also known as coiled hair ties or phone cord hair ties, have interesting and useful properties with respect to the present invention. They are highly elastic and easily stretchable to varying diameters. Another useful property is that it can be twisted along its main longitudinal axis, even when that axis is on a curved path. For example, while holding a spiral hair tie at two opposite points on its diameter and rotating its coils in opposite directions with fingers, one can twist the entire spiral hair tie inwardly or outwardly even while it maintains a circular or arc or ring shape. This property makes it possible to move or roll the spiral hair tie along a limb as shown in FIGS. 1A and 1B, while its elasticity allows it to stretch in diameter to accommodate limbs of varying widths along their lengths, while consistently gripping the limb with circumferential pressure. Another useful property is that the coiled wire (or coiled cord or coiled band) structure of the spiral hair tie can impart a pleasing massage sensation as it rolls against the skin, with each coil functioning like a mini roller. The massage element 117 can differ from a typical spiral hair tie in that it's not closed into a loop or continuous ring. Rather, its ends 111 and 113 are attached to rotational connectors as previously discussed for causing its rotation.

FIG. 5 shows an alternate structure 501 for the massage element 117. In an embodiment, the structure 501 can be similar to acupressure massage rings, which utilize small triangular shaped connected metal scaffolds. The structure 501 is also able to change its diameter when rolling along a limb while applying pressure. In an embodiment, many such different alternate structures for the massage element 117 may be possible within the scope of the present invention, such as various elastic bands or cords, coiled or non-coiled for example.

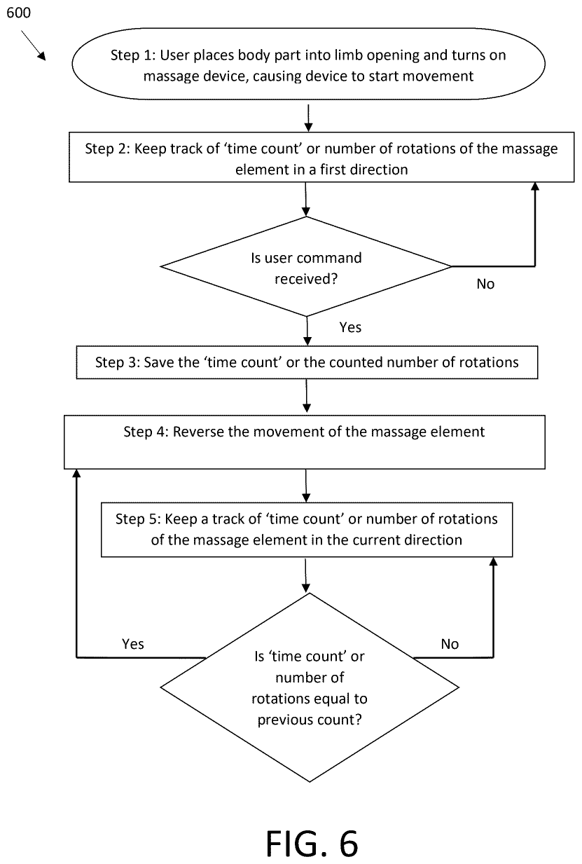

FIG. 6 shows a flowchart detailing a method 600 to control the operations of the proposed self-propelling massaging device. In step 1, a user's body limb is placed into limb opening 121 and massaging device is turned on, activating the rotation of motors 205 and 209 causing massaging device 100 to start traveling. In step 2, the control unit can start counting how many turns the motor shafts 237 and 241 and consequently massage element 117 are undergoing. For example, based on the known rotational speed of the motors 205 and 209, the number of rotations can be counted based on elapsed time. Alternatively, the control unit may measure a total time elapsed (referred as ‘time count’) since the massaging device has started moving in a particular direction. In step 3, when the user issues a user command, for example by pressing the button 1203, the method 600 can save the ‘time count’ or the total number of turns that the shaft motor has taken to reach that point. In step 4, the motors 205 and 209 are reversed in direction by the CPU which is running the method 600 for example. In step 5, the method 600 again can measure the ‘time count’ or count the motor shaft turns on the reverse travel direction. When this is equal to the saved values in step 3, this corresponds to massaging device 100 reaching its starting location. Subsequently, the method 600 can jump back to step 4, where the massaging device 100 reverses direction again and continues moving to its saved reversal point to repeat the cycle.

The motors 205 and 209 can be relatively high torque electrical motors and can use gear box speed reduction for example as is well known in the art. Motor speed can preferably vary and be controllable by CPU 711, for example, by varying the voltage. Speed for example can include 30 or 60 RPM but can be set higher or lower.

In an embodiment, the control unit or CPU 711 of the massaging device could be wirelessly controllable by using a mobile phone application, for example, through a Bluetooth connection. Such an application could be used to define the range of motion, select preset ranges, and set more complex programs and options, such as when to turn on a vibrational device 1201, for how long the massage should take place, when to vary the range of motion, and the speed of motors 205 and 209 for setting how fast massaging device 100 moves along the limb. In another example, the massaging device 100 could be set to move up and down on a leg for 10 minutes to aid in falling asleep while lying in bed. As an example, after 10 minutes, the device could automatically move completely off the leg and foot and shut down.

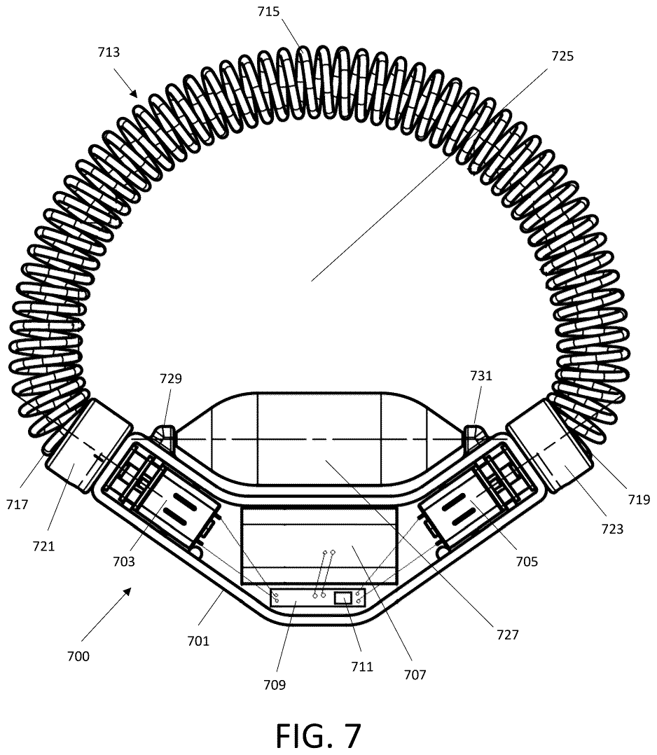

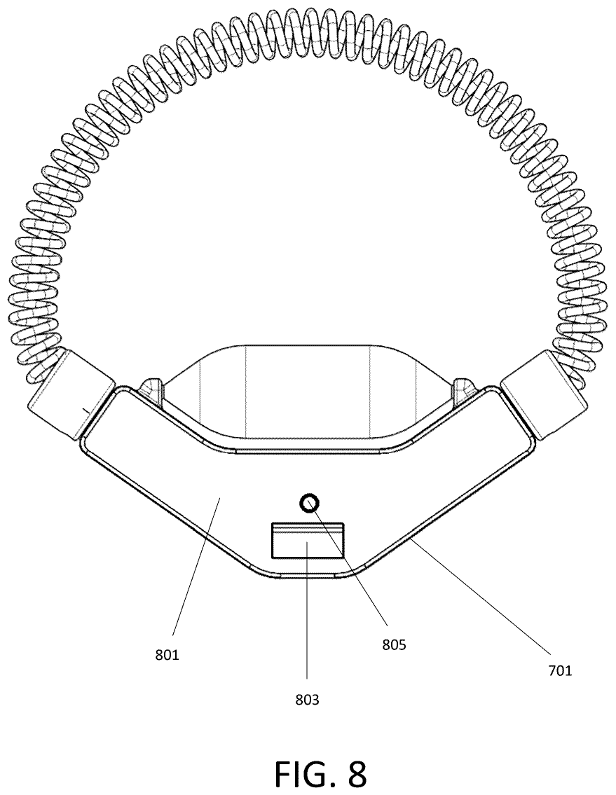

A second embodiment of the self-propelling massaging device 700 or massaging device 700 is shown in FIGS. 7-9. The Massaging device 700 consists of a housing 701 which can contain motors 703 and 705, a battery 707, and a PCB 709 with a CPU 711. The housing 701 can have a cover 801 as shown in FIG. 8, which can be closed using screws or gluing for example. Further, as shown in FIG. 7, the self-propelling massaging device 700 utilizes a massage element 713 similar to the massage element 117 to circumferentially grip, massage, and move massaging device 700 along a limb of varying diameter, such as an arm or leg, or torso or neck. The massage element 713 mainly differs from a typical spiral hair tie in that it's not closed into a loop. Rather, its cut ends 717, 719 (also referred as coiled ends 717, 719 or open ends 717, 719 or ends 717, 719) are attached to rotational connectors 721 and 723, forming a limb opening 725 through which an arm, leg, foot, or hand for example can be inserted. A secondary massage element 727 can be mounted as shown on posts 729 and 731 on housing 701 at the bottom of limb opening 725 for providing an additional massage on the section of the limb not in contact with massage element 713, and to assist in moving massaging device 700 along the limb. Secondary massage element 727 can be a roller for example, a ball transfer bearing, kneading-type ball-based massage elements, or other rotational structure. It can optionally have a variety of textures on its surface, such as small bumps or protrusions for example, for enhancing the massage sensation, and can be made from plastic, rubber, or other materials.

In an embodiment, the housing 701, rotational connectors 721 and 723, cover 801, and secondary massage element 727 can be made from plastic for example, using injection molding. Other materials can be used such as aluminum or other metals as well. The battery 707 can be a rechargeable battery such as lithium ion, and charged using a USB cable for example connected to a USB port 803 as shown in FIG. 8, as well known in the art. A charging status LED 805 can be provided, which can turn green when the device is fully charged or show red when charging is needed.

In the second embodiment, as shown sectionally in FIG. 9, the housing 701 can have wing ends 905 and 909 where motors 703 and 705 can be mounted therein. The rotational connectors 721 and 723 can be mounted on exterior surfaces 907 and 911 of wing ends 905 and 909 and attached to motor shafts 901 and 903 of motors 703 and 705, such that when motor shafts 901 and 903 are rotating, rotational connectors 721 and 723 are rotating along with them. A small gap can be provided between rotational connectors 721 and 723 and exterior surfaces 907 and 911 to reduce friction. Motor shafts 901 and 903 can be D shaped for example or cylindrically shaped and inserted into corresponding female axes 913 and 915 in rotational connectors 721 and 723. Set screws 917 and 919 can be used to secure rotational connectors 721 and 723 with respect to motor shafts 901 and 903, and to keep massage element 713 locked onto massaging device 700. The rotational connectors 721 and 723 can have circular channels 921 and 923 for holding cut ends 717 and 719 of massage element 713. Cut ends 717 and 719 can be glued for example inside circular channels 921 and 923 for holding one or more coils 715 therein for transmitting twisting motion onto massage element 713. The massage element 713 can be replaced by the user. For example, if the user wishes to target a wider body limb like a leg, they can replace or interchange the massage element 713 with different sizes. The massage elements could be provided with rotational connectors already secured to their ends, so the user would only need to loosen the set screws to replace them for example.

In an embodiment, when the motors 703 and 705 are turned on, motor shafts 901 and 903 are rotating in opposite directions along with rotational connectors 721 and 723, this causes overall massage element 713 to rotate inwardly or outwardly, wherein all coils 715 rotate together inwardly or outwardly against the at least partially surrounded or encompassed skin of a body limb in the case where massage element is implemented as the coiled structure in FIG. 4. This can be used to drive the overall movement of massaging device 700 or 100 along a limb, when the limb is inserted into limb opening 725, in either the proximal or distal direction, depending on if coils 715 are rolling either inwardly or outwardly. By making the wing ends 905 and 909 angled, and consequently the orientations of motors 703 and 705 and rotational connectors 721 and 723 angled as shown in FIG. 7 and FIG. 9, this can help to stretch, encompass, and grip massage element 713 around the sides of a body limb in addition to the surface of the limb in contact with the top part of massage element 713. This in turn helps to provide a more uniform massage around the body limb, as well as to help move the device along the limb by being in contact with a greater circumferential surface area of the limb compared to if motors 703 and 705 were just mounted vertically with respect to massage element 713, though such vertical mounting is possible within the scope of the present invention.

In an embodiment, to help facilitate this angled placement of motors 703 and 705, the housing 701 can be approximately ‘V’ shaped for example as shown in FIG. 7, or shaped like a segment arc of a circle, or more generally curved, but many other housing shape configurations are possible such as rectangular or square within the scope of the present invention. While the massaging device 700 moves along a limb, massage element 713 also functions as a spring, pulling housing 701 with attached secondary massage element 727 upwards against a surface of the limb to apply pressure while rolling against the skin. This allows secondary massage element 727 to cover and massage that area of the limb not in contact with massage element 713. In the present embodiment, secondary massage element 727 is passively rotating due to the motor-driven rotation and movement of massage element 713.

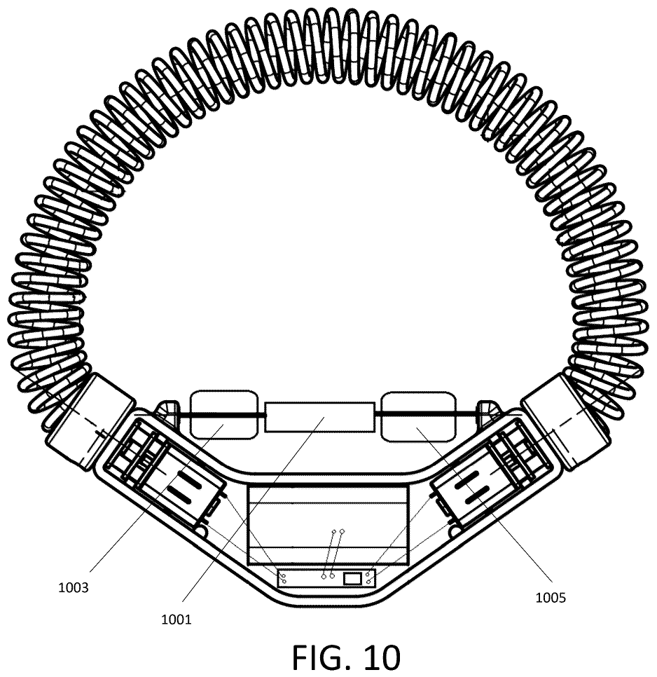

In an alternate embodiment as shown in FIG. 10, the secondary massage element could be actively rotating by utilizing a secondary massage element motor 1001 to further assist in propelling massaging device 700 along a limb. Secondary massage element motor 1001 could for example be a dual shaft motor with secondary massage elements 1003 and 1005 mounted on the shafts as shown or could be a single shaft motor with a single driven roller. Secondary massage elements 1003 and 1005 can be rollers for example.

In an embodiment, the coils 715 of massage element 713 or massage element 117 could be made from TPU for example, or other non-toxic and flexible plastic materials for contact with the skin. Furthermore, coils 715 could be optionally textured with small bumps or protrusions 1101 as shown in FIG. 11 to aid in the frictional movement of massage element 713 against the skin. Optionally, protrusions 1101 could be made from rubber for example, for enhanced frictional gripping strength against the skin as coils 715 roll inwards or outwards.

In an embodiment, as shown in FIG. 12, the vibrational device 1201 can be optionally included in housing 701 for the purpose of also vibrating secondary massage element 727 as it rolls against the skin to further enhance the massage sensation. The vibrational device 1201 can be a coin cell buzzer for example, a vibrating motor, or any other electronic vibrating device. Further, as shown in FIG. 12, a range setting button 1203 can be provided. Button 1203 can be connected to CPU 711 for the purpose of setting the cycling travel range on the body limb. In one example, to operate massaging device 700, the user can first insert a body limb into limb opening 725 and then turn on massaging device 700 by moving a slider switch 1205 to it's on position so that motors 703 and 705 begin turning. The user can then allow massaging device 700 to travel to the point on the limb where they wish it to reverse direction, for example, from the hand to the top of the bicep muscle. At that location, the user can press button 1203 so that method 600 running on CPU 711 can save the reversal point. The massaging device 700 can then travel back to its starting location, and then automatically reverse direction again and cycle on the defined range indefinitely or for a set period of time.

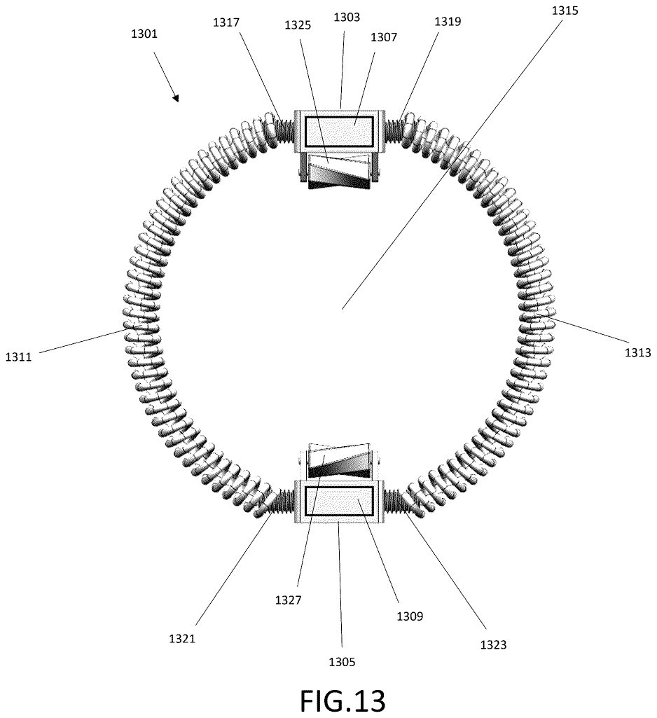

Another embodiment of the self-propelling massaging device 1301 is shown in FIG. 13. In an embodiment, instead of one housing 701, two separate housings 1303 and 1305 can be provided with motors 1307 and 1309 mounted therein. The motors 1307 and 1309 can be dual shaft motors. Two separate massage elements 1311 and 1313 can be utilized. forming a limb opening 1315 between them. A pair of rotational connectors 1317 and 1319 and 1321 and 1323 on each housing can be provided, to simultaneously rotate massage elements 1311 and 1313. Further, side rollers 1325 and 1327 can be mounted on housings 1303 and 1305 to cover and massage the region on the limb not in contact with massage elements 1311 and 1313. In an embodiment, almost the entire body limb can be surrounded or encompassed by massage elements 1311 and 1313. Housings 1303 and 1305 could each have their own batteries and USB charging ports similar to what was already described for massaging device 100 and 700. The user could simultaneously charge both sides by using two USB cables for example. Pressure against the limb during the massage and movement of the device 1301 would help to prevent housings 1303 and 1305 from rotating due to motor rotation.

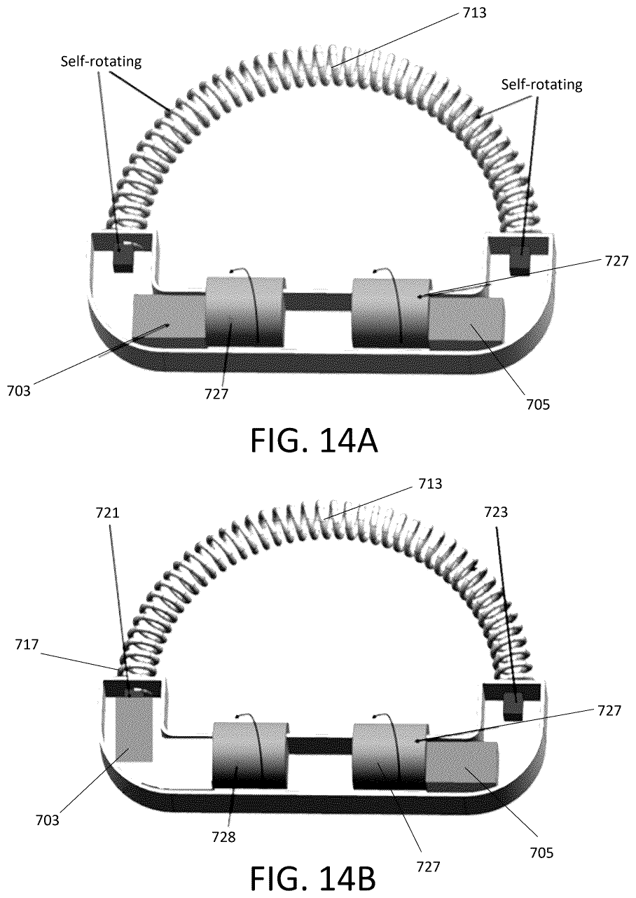

FIG. 14A shows another alternate embodiment, wherein the motors 703 and 705 could instead be connected to secondary massage elements 727, which could be one or more rollers for example as shown, and with massage element 713 not connected to any motors and passively rotating. In another alternate embodiment as shown in FIG. 14B, motor 703 can be used to rotate one cut end 717 of massage element 713, using rotational connector 721. In this case, rotational connector 723 on the opposite side would not be connected to a motor but could just freely rotate. In an embodiment, the motor 705 could instead be connected to secondary massage element 727 to drive its rotation for example, and another secondary massage element 728 could rotate freely on its own as shown without a motor. Many such combinations are possible within the scope of the present invention.

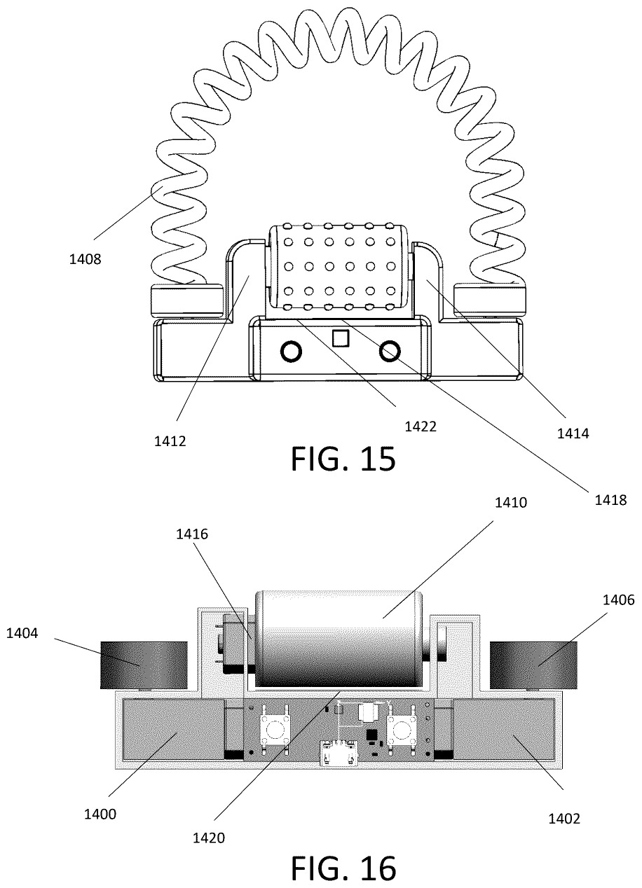

FIGS. 15-16 show another embodiment where motors 1400 and 1402 can have a 90-degree shaft orientation relative to the motor bodies for rotating rotational connectors 1404 and 1406 and connected massage element 1408. A central roller 1410 can be optionally mounted on roller posts 1412 and 1414 and can be rotated by a separate third motor 1416 to help move the massaging device against the limb. Alternately, central roller 1410 and motor 1416 can be omitted. One advantage of using motors 1400 and 1402 with 90-degree shafts is to save vertical space and decrease the height of the device, since the motor bodies can lie flat relative to their shafts.

When central roller 1410 and motor 1416 are omitted, a platform 1418 is available for mounting additional therapeutic elements 1420 which can include in any combination but not limited to LED lights for LED therapy, infrared light elements, RF, laser, heat, cold (such as a thermoelectric module or coil or heat transfer exchanger), percussive or percussion elements (such as those typically used in percussion gun massagers), vibrational motors such as coin motors, piezoelectric, or eccentric based, electrical stimulation such as transcutaneous electrical nerve stimulation (TENS), neuromuscular electrical stimulation (NMES), magnets (electromagnets or permanent magnets), or various pressure delivery components such as by air pressure, water, or fluid pressure.

The present invention can thus also function as a novel delivery system for a wide variety of therapeutic elements 1420, whereby users previously needed to manually move such elements across the body to deliver the therapy but now can be automatically moved on the limbs and torso and other body areas to deliver the therapy. Other embodiments in this application could also be similarly combined with such therapeutic elements 1420.

A shaver 1422 can also be mounted on platform 1418 so that the present embodiment could function as an automatic leg, arm, torso, or even facial shaver. Shaver 1422 could be an electric foil shaver or blade-based shaver as well known in the art. Other embodiments in this application could also be combined with shaver 1422.

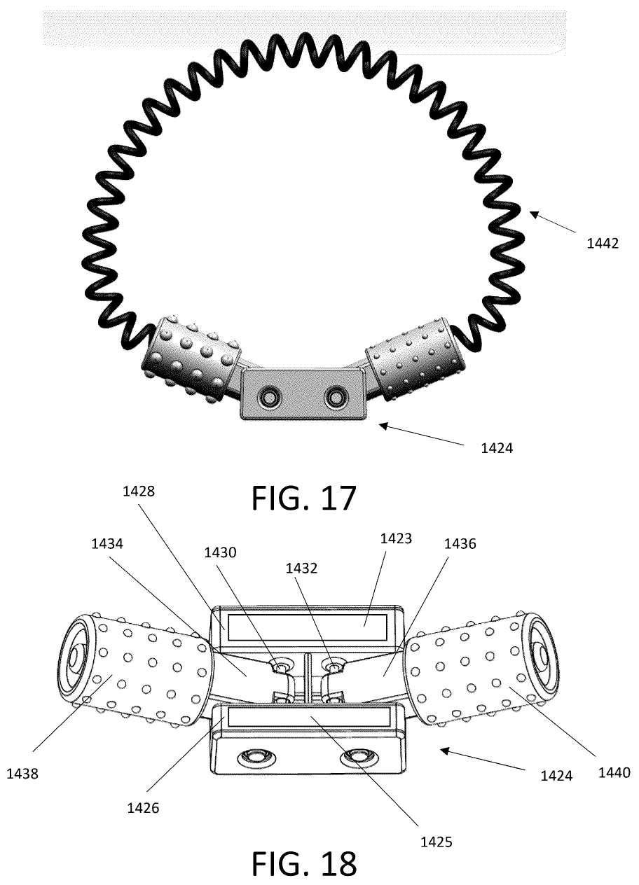

FIGS. 17-22 detail two embodiments similar to the embodiment in FIG. 1 but modified to provide examples detailing how a battery 1423 and a PCB 1425 can be enclosed in the device housing such that the self-propelling massage device is fully self-contained and wireless, without any required external cables or wires or control box 123.

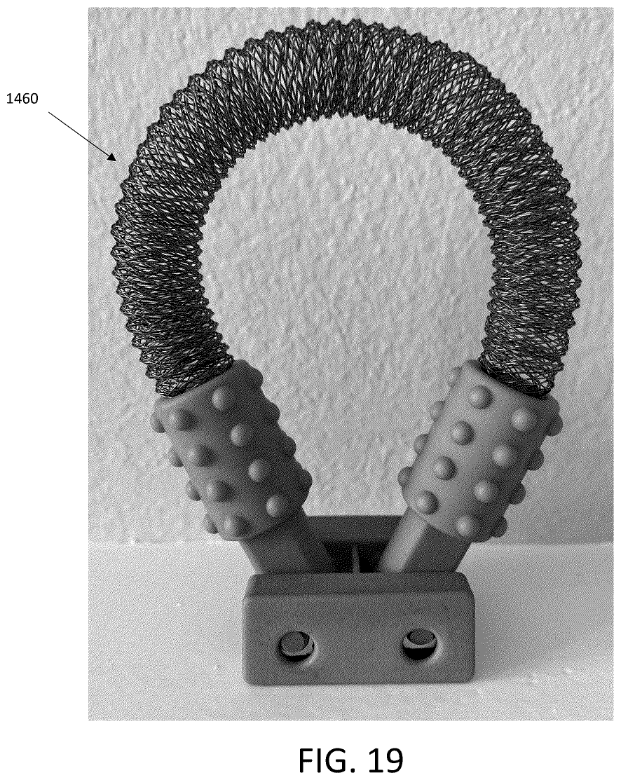

In FIGS. 17-19, a device housing 1424 can comprise a PCB compartment 1426 and a battery compartment 1428 for containing battery 1423 and PCB 1425, wherein said compartments can be connected by motor housing shafts 1430 and 1432. Motor housings 1434 and 1436 (with similarly contained motors as already discussed in FIG. 2), with connected secondary massage elements 1438 and 1440 (similar to the arrangement of secondary massage elements 107 and 109 discussed relative to FIG. 1), and attached massage element 1442, can be rotationally mounted on motor housing shafts 1430 and 1432 as shown for allowing motor housings 1434 and 1436 and secondary massage elements 1438 and 1440 to rotate towards or away from each other to accommodate varying limb diameters as similarly discussed for the embodiment in FIG. 1, as the device moves along a limb. A working prototype of the embodiment in FIGS. 17-18 is shown in FIG. 19.

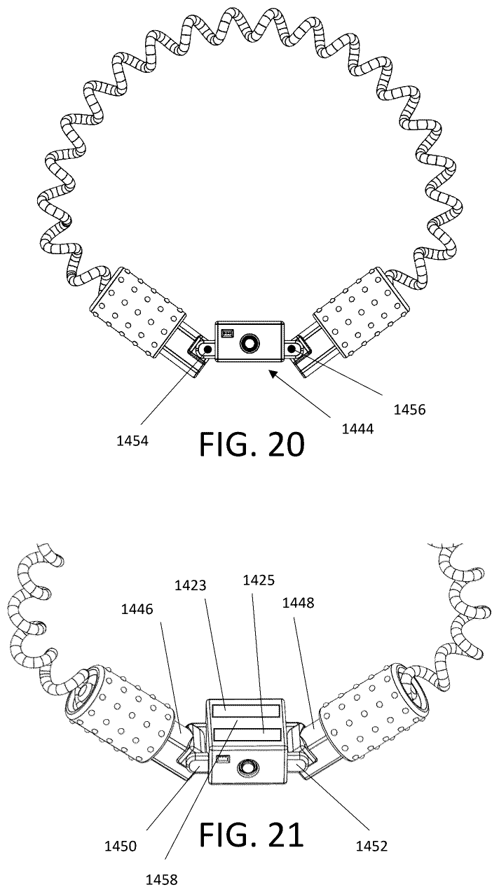

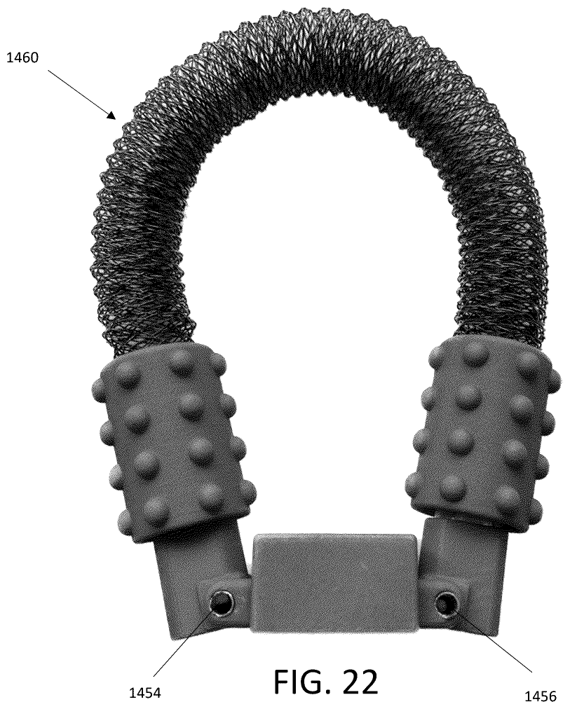

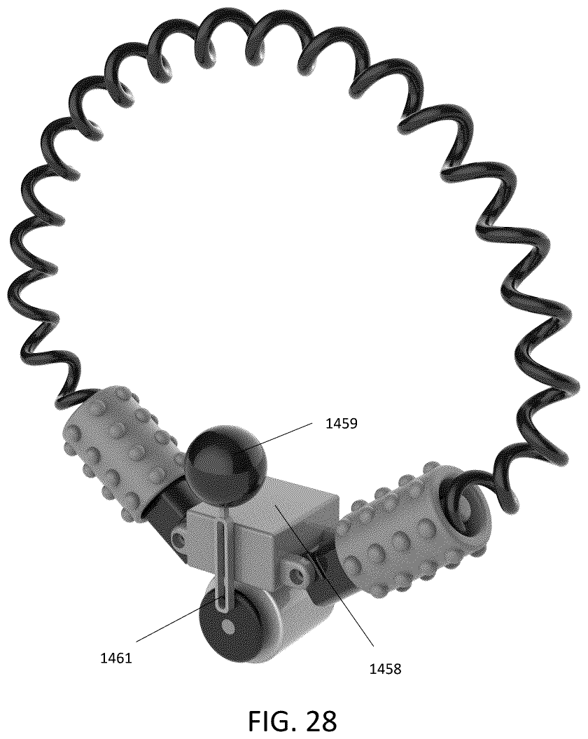

The embodiment in FIGS. 20-22 shows a single compartment device housing 1444 which can contain both battery 1423 and PCB 1425. This version can help decrease the overall size and weight of the self-propelling massage device. A working prototype of this embodiment is shown in FIG. 22. Motor housings 1446 and 1448 can be rotationally mounted on side pivot holders 1450 and 1452 using pins 1454 and 1456 as shown in FIG. 20 and FIG. 22, for allowing the secondary massage elements to rotate towards or away from each other for accommodating varying limb diameters as previously discussed. Pins 1454 and 1456 can be hollow for allowing fully internal travel of electrical wires from motor housings 1446 and 1448 into device housing 1444 for connecting to PCB 1425. The top of device housing 1444 can form a platform 1458 as shown in FIG. 21 for optionally mounting one or more therapeutic elements 1420, or shaver 1422 which can contact the skin as the device travels on a body area. FIG. 28 shows an example of a percussive element 1459 as one of the possible therapeutic elements 1420 mounted on platform 1458 for applying a percussive massage as the self-propelling massage device travels on the body. Percussive element 1459 could be driven by a typical eccentric-based motor mechanism 1461 as well known in the art.

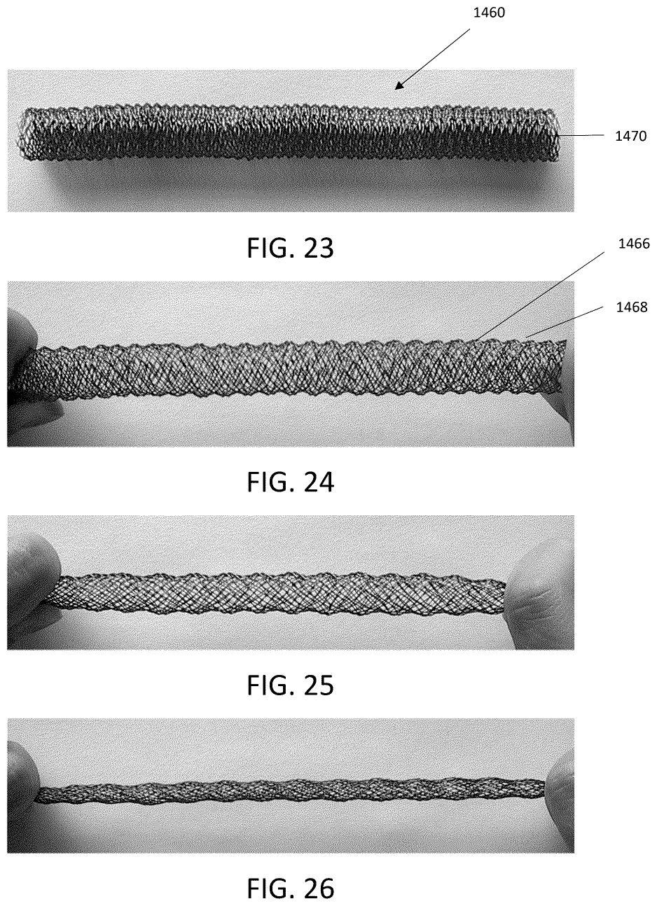

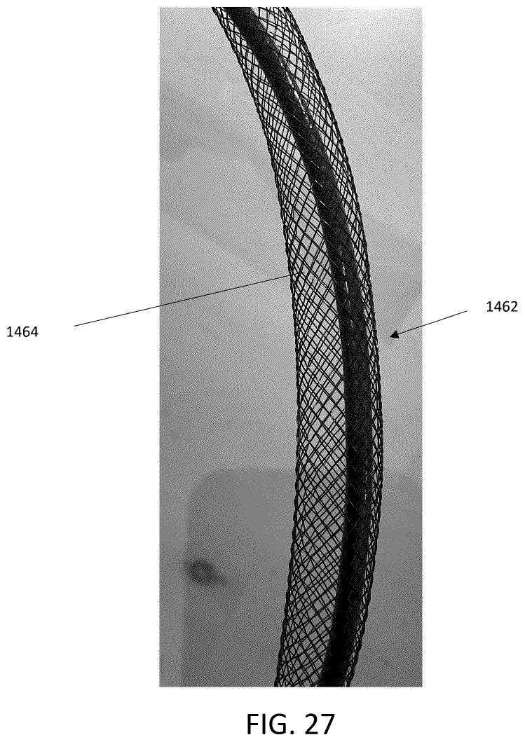

FIGS. 23-26 show an additional alternate structure for a massage element 1460 which can be used in place of previously discussed massage elements in other embodiments throughout this application, such as massage element 117. Massage element 1460 can be formed from a tubular braided wire mesh 1462 as shown in FIG. 27, composed of braided wires 1464, formed similar to braided wire stents for example. A wide variety of braid or weave patterns can be used such as 2 over and 2 under for example, with a variety of wire carrier quantities and wire thicknesses, such as but not limited to 32, 36, 40, 44, or 48 carriers, and 0.0125″ wire. Braided wires 1464 can be made from Nitinol, which can exhibit superelastic properties at room temperature. Alternately, Elgiloy or other alloys can be used as well as stainless steel, nylon, PET, or other plastics or fabrics.

As shown in FIGS. 23-26, massage element 1460 can include corrugations 1466 on its surface 1468 for increasing the radial strength of tubular braided wire mesh 1462. Corrugations 1466 can be formed by placing tubular braided wire mesh 1462 onto a tight-fitting central shaft or rod or mandrel, and then axially compressing the entire length of tubular braided wire mesh 1462 with sufficient force which has the unexpected and surprising effect of causing the surface 1468 of tubular braided wire mesh 1462 to buckle and the length of tubular braided wire mesh 1462 to shorten, causing the formation of corrugations 1466. If Nitinol is used for braided wires 1464, then tubular braided wire mesh 1462 with corrugations 1466 can be heat treated to set tubular braided wire mesh 1462 to tend to stay in a radially expanded configuration as shown in FIG. 23 while at a typical room temperature range, such as but not limited to 18 to 24 degrees C. Tubular braided wire mesh 1462 can then substantially stretch along its axial length as shown in FIGS. 24-26, and while moving along a limb of varying diameter, and then spring back to its radially expanded and axially collapsed length as in FIG. 23 when the stretching force is removed.

Such a massage element 1460 has many desirable properties for the present invention. Corrugations 1466 can act as the mini coils or mini rollers already discussed for tactile sensation, and they increase the radial resistance to radial collapse of tubular braided wire mesh 1462 while moving along a limb, which can help with delivering significant levels of controlled pressure such as between 20 and 120 mm HG for example, which is comparable to what sequential compression devices currently can deliver via air chambers for applications in lymphedema and edema. Corrugations 1466 can also significantly increase the torque transmission capacity of massage element 1460, helping it to resist twisting or kinking when torque is applied to the massage element by the one or more motors. Tubular braided wire mesh 1462 is highly durable especially if formed from Nitinol, though again other alloys and materials can be used as discussed such as Elgiloy. Massage element 1460 can be coated in a variety of possible coatings such as PTFE, urethane, silicone, various polymers, rubber, grafts, or fabrics for contact with skin. Massage element 1460 can have an open central lumen 1470, which is convenient for attaching to rotational connectors as previously discussed, and can also be used to contain and hide the motors and rollers to save space as discussed in a later embodiment. Massage element 1460 is shown in use in the working prototypes in FIGS. 19 and 22.

In addition to a tubular braided wire mesh, additional alternate structures can be used for the massage element, such as a bellows with axially collapsible segments (from metal or plastic), various sleeves such as electrical sleeving, which can be braided and can similarly change axial length, or from laser cut tubing for example, and many other flexible tubular structures within the scope of the present invention, including compression or extension springs.

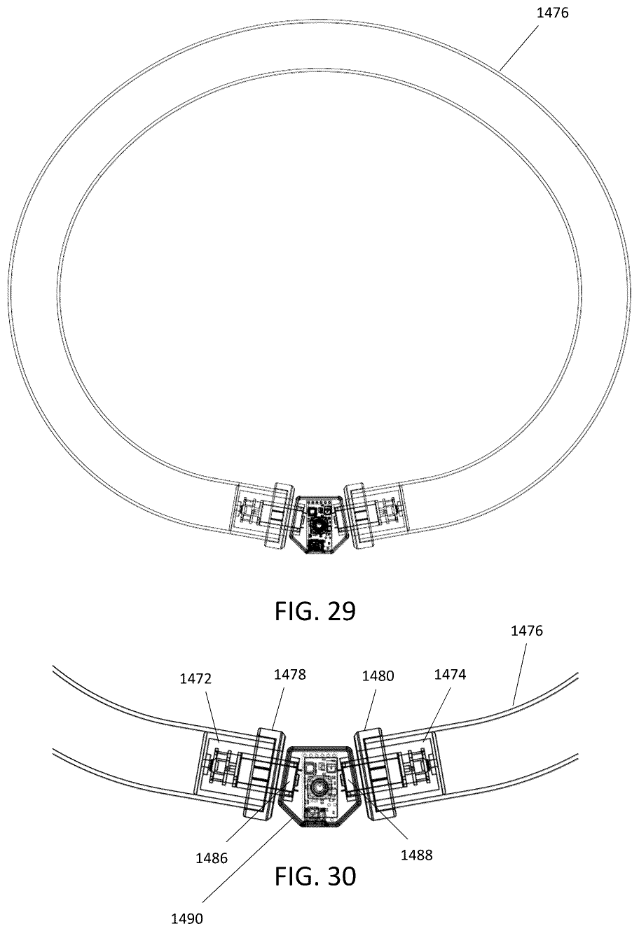

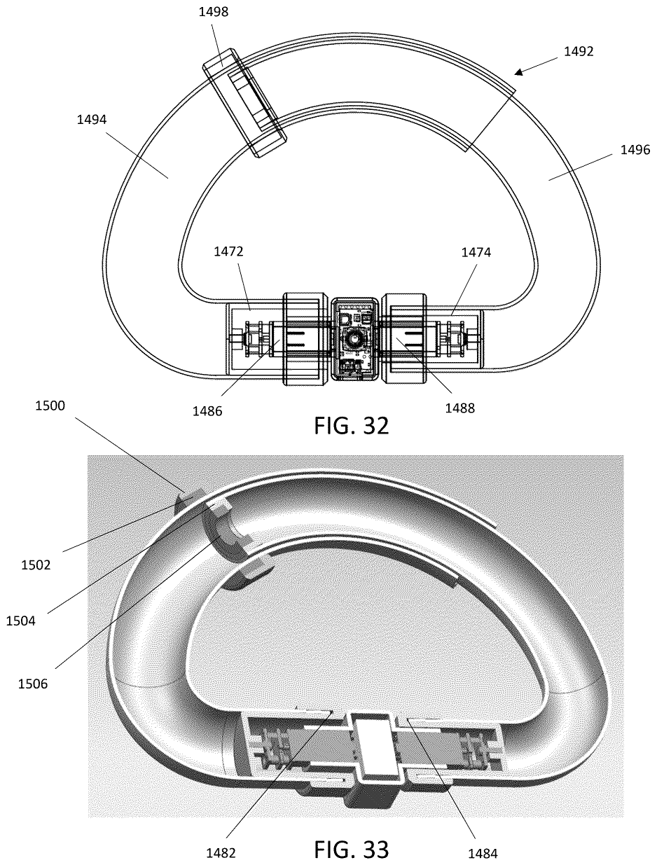

FIGS. 29-30 depict another embodiment of the present invention where rotational connectors 1472 and 1474 can be contained inside a massage element 1476. Rotational connectors 1472 and 1474 can have external massage element holder rings 1478 and 1480 for holding the distal ends of massage element 1476 in channels 1482 and 1484, shown in a cutaway view in FIG. 33. External massage element holder rings 1478 and 1480 can also function as rollers for contact against a user's limb as the self-propelling massage device is moving on a user. Motors 1486 and 1488 can be fixedly attached to a device housing 1490 as shown in FIG. 30 to drive the rotation of rotational connectors 1472 and 1474 for rotating massage element 1476 from within itself, with the additional simplification that a hinge is not required for the pivoting of motors as in a previous embodiment. Massage element 1476 can be similar to massage element 1460 utilizing tubular braided wire mesh 1462, which provides a suitable structure for containing rotational connectors 1472 and 1474. Massage element 1476 can also optionally have corrugations 1466 as previously discussed. Massage element 1476 can alternately be based on any type of tubular flexible structure within the scope of the present invention, made from a wide variety of materials including metals, plastics, or rubber.

Hiding the bulk of rotational connectors 1472 and 1474 inside massage element 1476, as opposed to connecting the massage element to external secondary massage elements as in previous embodiments such as in FIG. 17, can provide several advantages. In this arrangement, massage element 1476 forms a more complete continuous ring around a user's limb, only interrupted by housing 1490 and external massage element holder rings 1478 and 1480. This can save space since the rotational connectors overlap with the volume of the massage element and can offer a more uniform massage sensation since a greater surface area of contact against a limb is provided by the massage element, with consistent properties. This arrangement also can provide for a more appealing and tidier cosmetic appearance, without interruption of larger rollers.

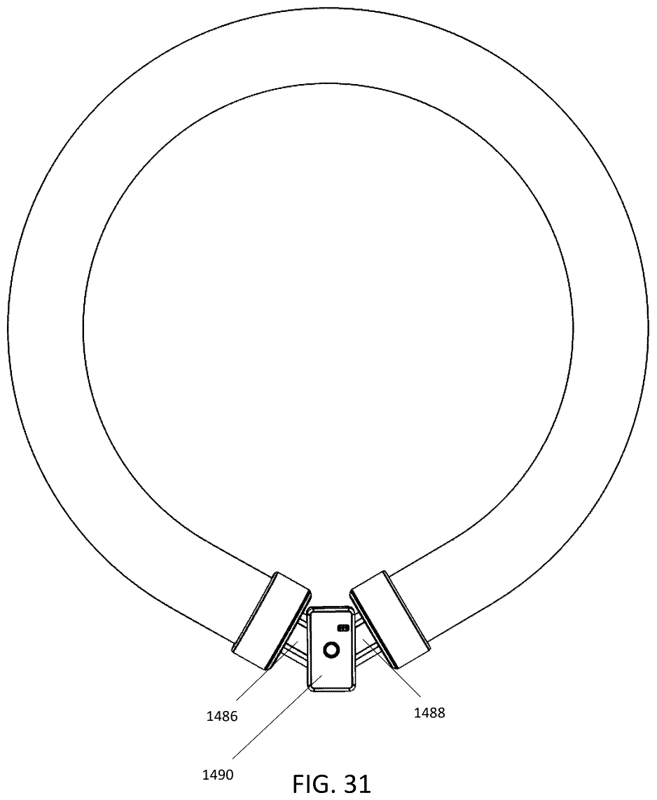

FIG. 31 shows a similar embodiment as in FIGS. 29-30, illustrating a different possible mounting angle for motors 1486 and 1488 on housing 1490, as for example, 30 degrees from the horizontal, but any angle from flat (as shown in FIG. 32) to very steep can be utilized within the scope of the present invention. Generally, a lower angle can help the motors be in line and continuous with the natural curve of the massage element around a limb, to help support its rotation without distorting the massage element. Additionally, any type of shaped enclosure can be utilized for housing 1490 such as rectangular, polygonal, or curved.

FIGS. 32-33 depicts a similar embodiment as in FIGS. 29-32 with the addition of a feature to allow a user to manually change the circumference of a massage element 1492 without needing to remove or replace the massage element. Massage element 1492 can consist of two separate segments, wider segment 1494 attached at one end to rotational connector 1472, and a narrower segment 1496 attached at one end to rotational connector 1474. Wider segment 1494 and narrower segment 1496 can telescopically feed into each other to a variable degree for lengthening or shortening the overall length and circumference of massage element 1492 for setting different ranges of base diameters, for example, when a user switches from legs to arms. Massage element 1492 can be similar to massage element 1460 based on tubular braided wire mesh 1462 as previously discussed and can be made from nitinol or other heat-settable alloys, in which case wider segment 1494 can be heat set at a slightly wider diameter than narrower segment 1496, for allowing narrower segment to be inserted and travel through wider segment 1494 as shown in FIGS. 32-33. Alternately, massage element 1476 can be made from an alternate tubular structure, such as from plastic, rubber, or metals, laser cut, wire based, coil based, non-coiled, corded, bellows, helical, spring-like, slotted, or many other forms within the scope of the present invention.

A massage element adjuster 1498 can be provided to lock or unlock the relative sliding movements of wider and narrower segments 1494 and 1496. Massage element adjuster 1498 can consist of an external ring 1500, with an internally mounted diametrically magnetized ring magnet 1502. Massage element adjuster 1498 is positioned over and can slide over both wider and narrower segments 1494 and 1496. Narrower segment 1496 can have a ring end 1504 closing off its moveable end and also containing a diametrically magnetized ring magnet 1506. When massage element adjuster 1498 is aligned with the position of ring end 1504, and when the north and south poles of the corresponding ring magnets 1502 and 1506 are oppositely aligned, wider and narrower segments 1494 and 1496 are held from sliding relative to each other. In order to adjust the length, the user can rotate massage element adjuster 1498 while holding massage element 1492 to prevent it from rotating, in order to magnetically unlock ring magnets 1502 and 1506 and to allow the desired sliding of narrower end 1496 into or out of wider end 1494 to make the needed length adjustment before sliding back massage element adjuster 1498 over ring end 1504 to again lock the segments. Massage element adjuster 1498 also can function as a roller in this embodiment of the present invention as it moves along and massages a limb. Many alternate mechanisms within the scope of the present invention can be utilized to prevent and allow the relative sliding movements of wider and narrower segments 1494 and 1496. For example, a roller can be provided with a spring-lockable push button which the user can depress to selectively compress or release both wider and narrower segments 1494 and 1496 to prevent or allow their movement (not shown).

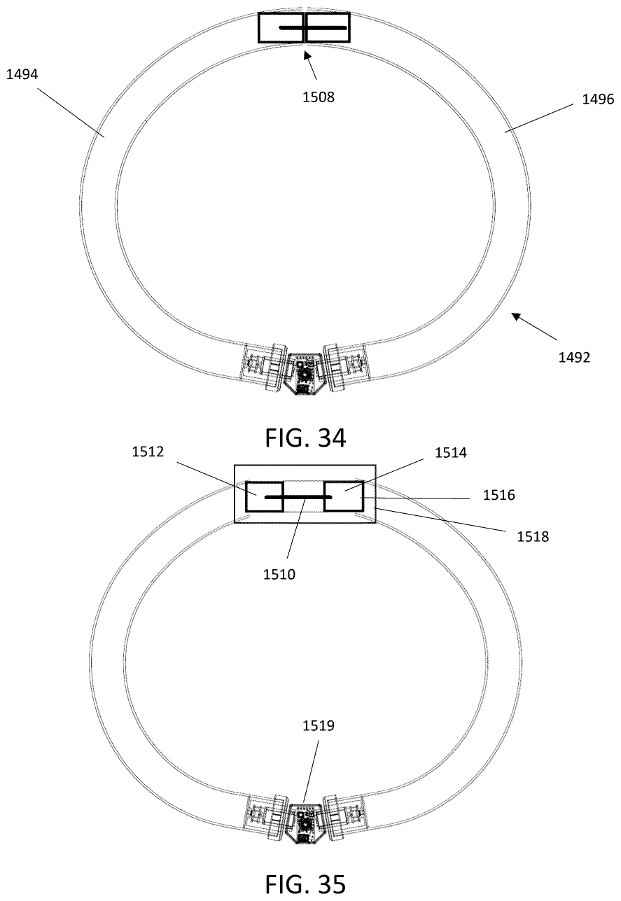

FIGS. 34-35 detail another embodiment for adjusting the length of massage element 1492 utilizing a lead screw 1508 which can function as a linear actuator, and where such an adjustment can occur automatically based on the device firmware and motor control. Lead screw 1508 can consist of a screw shaft 1510, a screw shaft body 1512, and a nut 1514 with a nut body 1516. Screw shaft body 1512 can be attached to one end of wider segment 1494, and nut body 1516 can be attached to one end of narrower segment 1496. In this embodiment, wider and narrower segments 1494 and 1496 of massage element 1492 can optionally be the same diameter. When motors 1486 and 1488 rotate in the same directions, massage element 1492 as previously discussed functions to propel the device along a limb while providing a massage. But if motors 1486 and 1488 rotate in opposite directions, causing wider and narrower segments 1494 and 1496 to also rotate in opposite directions, lead screw 1508 can then come together or move apart to decrease or increase the circumference of massage element 1492. Specifically, screw shaft body 1512 and nut body 1516 can move towards or away from each other. The main purpose of this action is to release pressure from massage element 1492 as it travels away from the body along a limb towards the distal end of the limb. Similarly, when the device travels back towards the body along a limb, lead screw 1508 can come together and tighten to increase and reestablish pressure around the limb from massage element 1492. This is to be consistent with manual lymphatic drainage massages to help move lymph and other bodily fluids in one direction towards the body. In the flowchart in FIG. 6, a step 3a can be added before the massage device reverses direction and moves away from the body, to first rotate the motors in opposite directions for enough time to loosen lead screw 1508 to release pressure on massage element 1492. And then when again returning back to step 3a when the device has reached the distal end of the limb, to now tighten lead screw 1508 and increase pressure on massage element 1492 before reversing direction again for its journey back along the limb towards the body. Step 3a can be optionally disabled by the user if this mode of massage is not preferred by pressing a device button such as button 1203, or by setting an option in a mobile app which can control the device via Bluetooth. In FIG. 35, an external roller 1518 can be provided over massage element 1492 and covering lead screw 1508 so that lead screw 1508 never contacts the user's body. In FIG. 35, a proximity sensor 1519 can be provided on top of device housing 1490 to measure the proximity or pressure from a limb on the device housing as a signal for adjusting the real-time tightness or pressure of massage element 1492 as it moves along a limb to maintain consistent pressure along the entire limb, using lead screw 1508. For example, if massage element 1492 is loosely fitting at any point along a limb such as near a wrist or forearm, there could be less pressure and less proximity relative to proximity sensor 1519 due to a gap there, which could cause the device firmware to then tighten lead screw 1508 to increase proximity or pressure, and the opposite if the proximity or pressure is too high. Proximity sensor 1519 can use many different types of elements including capacitive, resistive, optical, or inductive to measure pressure or proximity. For example, a strain gauge could be used, or a photodiode, or a variable capacitor, or a touch sensor.

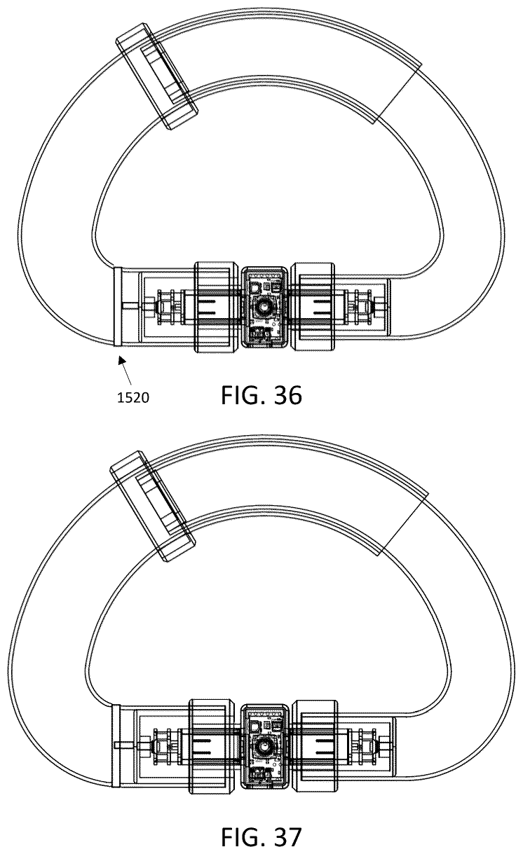

FIGS. 36-37 detail an embodiment which combines the manual massage element adjuster 1498 as shown in FIGS. 32-33 for manual length adjustments, along with a lead screw 1520 for automatic pressure release. In this embodiment, the user can first manually set the overall main length or circumference of massage element 1492 for a target body area, such as a thigh or forearm, to be sufficiently tight at the start of the device movement cycle. Then lead screw 1520 can release pressure prior to the downward movement towards the distal end of the limb. Lead screw 1520 in this embodiment can be placed closer to one of the motors as shown, with a screw shaft at the end of the roller for example, such that the roller can travel along the motor body when the lead screw is activated by rotating the motors in opposite directions.

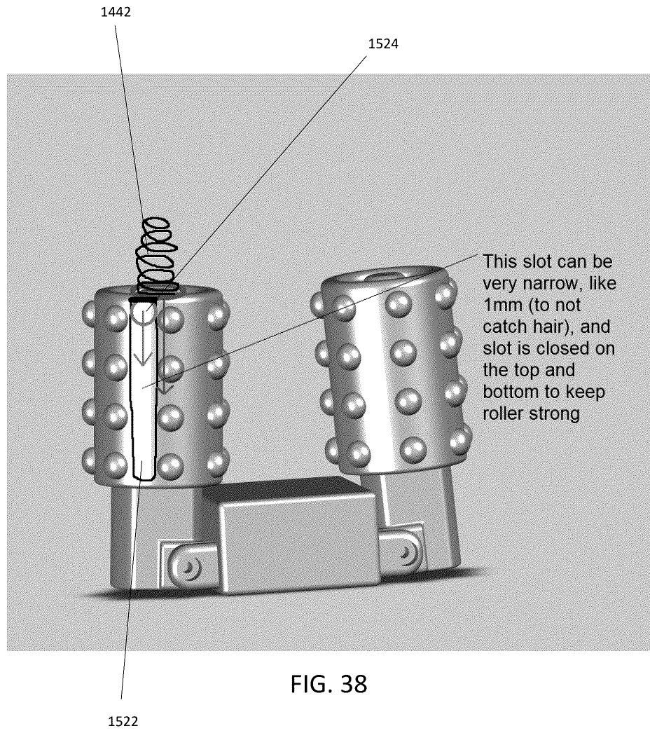

FIGS. 38-43 show several additional embodiments and variations of the present invention. In FIG. 38, a slot 1522 can be provided in the secondary massage elements previously discussed for attaching the massage element, and where an end of the massage element can be retracted or extracted into the roller by the user pulling a handle 1524 upward or downward to effect a length adjustment of the massage element.

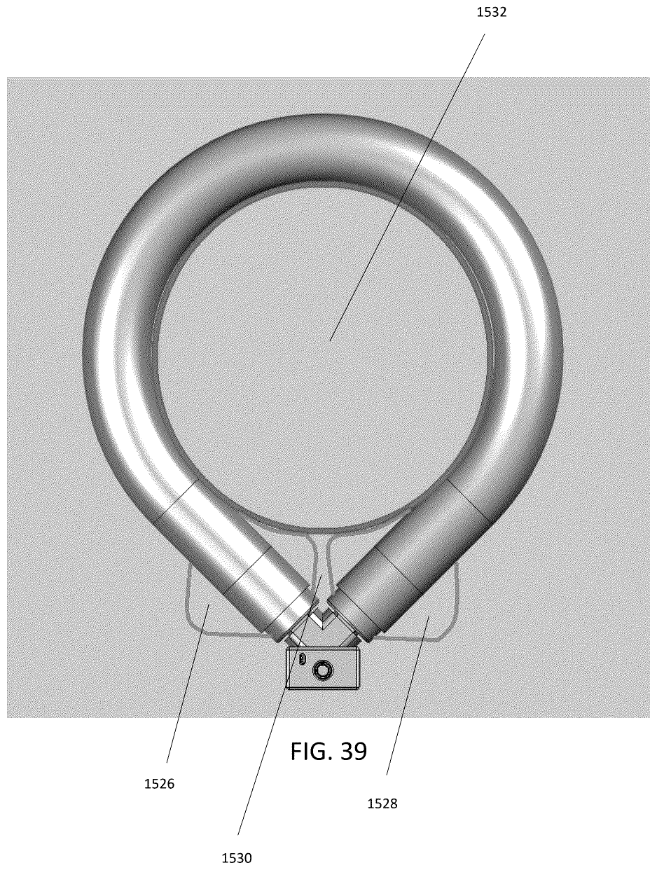

FIG. 39 shows an embodiment utilizing secondary massage elements 1526 and 1528 as previously discussed, functioning both as rollers in contact with a limb, as the rotational connectors to the motors. The difference here is that secondary massage elements 1526 and 1528 can be curve shaped as shown to fill in a gap 1530 which is normally formed when the secondary massage elements attach to the motors at a fixed angle. Gap 1530, which is roughly V-shaped, can be filled in by the curves of secondary massage elements 1526 and 1528 such that a limb opening 1532 has a more complete and continuous circular path in contact with a limb for more uniform and non-interrupted contact around the limb.

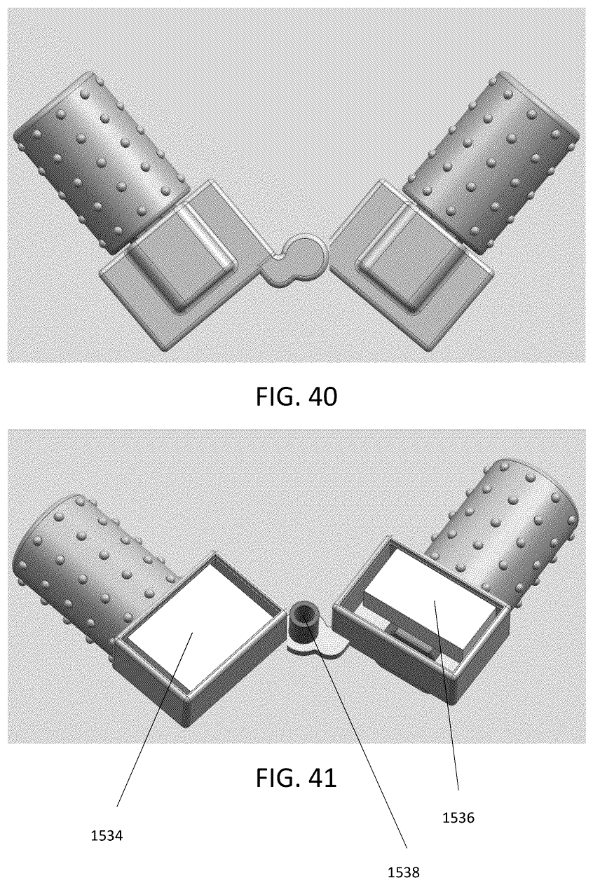

FIGS. 40-41 show an embodiment where a PCB 1534 and a battery 1536 to control and power the device as previously discussed can be housed within the motor housings as shown, with a hinge 1538 between them allowing them to move away or towards each other as the device moves along a limb. This configuration can avoid the need for a third housing for containing the battery and PCB.

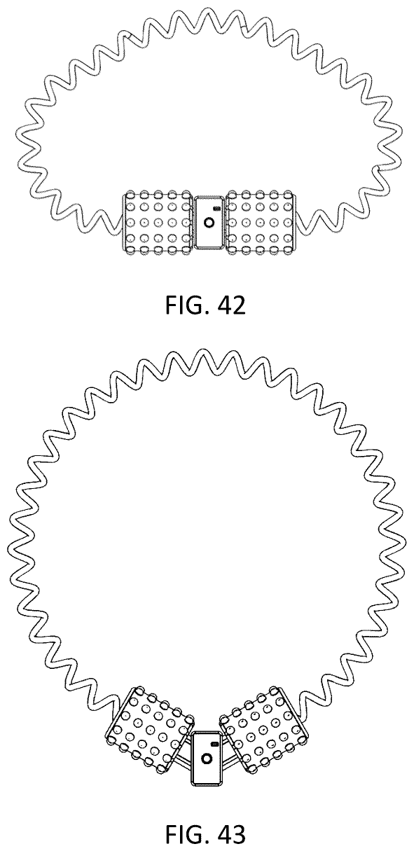

FIGS. 42 and 43 show embodiments similar to the embodiment already discussed in FIGS. 20-22, with the exception that the motor housings do not pivot and are fixedly attached to the battery/PCB housing such that the secondary massage elements (rollers) also remain at a fixed axis angle as they rotate and contact a limb. In FIG. 42, the secondary massage elements are shown attached flat relative to the battery/PCB housing, and in FIG. 43, the secondary massage elements are shown attached at an angle relative to the battery/PCB housing. The goal here is to simplify the device. Fixing the secondary massage element axis angles with respect to a limb to be flat or at a relatively small angle can also allow them to universally travel along any shaped limb without needing the hinging action.

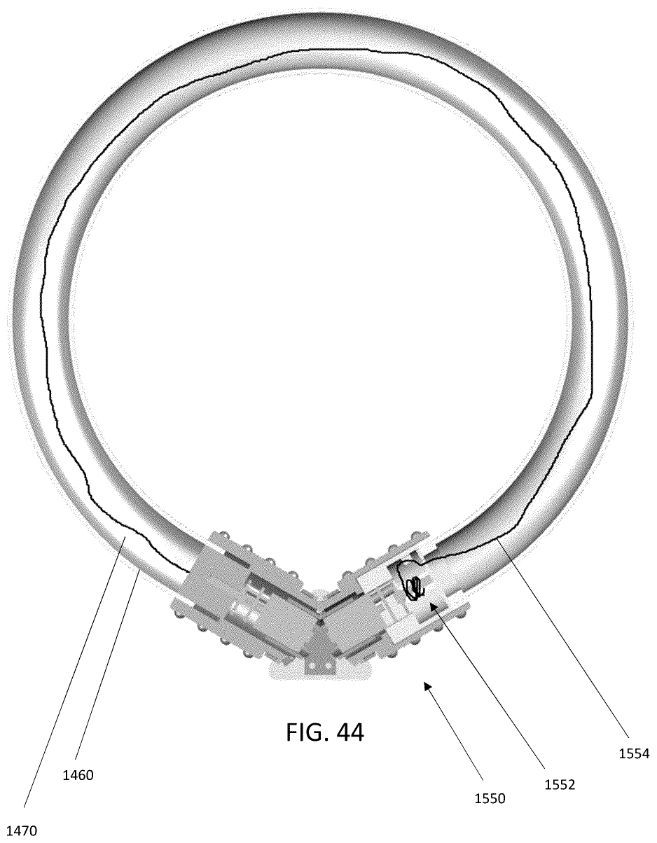

FIG. 44 details another embodiment of the self-propelling massaging device 1550 of the present invention, employing a tensioning system 1552 which can utilize a cable 1554 for applying variable tension or pressure through massage element 1460 as it moves along a body area. Cable 1554 can travel through lumen 1470 of the massage element 1460 as shown sectionally and schematically in FIG. 44. When a pulling force is applied on cable 1554, massage element can be pulled against the body as it rolls, applying a circumferential pressure around a limb or other body area, which can be varied based on the strength of the pulling force on cable 1554.

Massage element 1460 as previously discussed in FIGS. 23-26, is particularly well suited for use with cable 1554 for delivering variable pressure. Corrugations 1466 as shown in FIG. 24 and as previously discussed, function to enhance the radial resistance of the underlying tubular braided wire mesh 1462 for delivering pressure and acting as mini rollers, but also critically function to increase the range of the longitudinal stretch factor of massage element 1460, which is an important aspect of the present embodiment for accommodating and conforming to a wide range of body limb diameters while delivering the required pressure.

The longitudinal or axial stretch factor of massage element 1460 enhanced with corrugations 1466 can be quite dramatic and as much as 6 to 1 as illustrated in FIGS. 23 and 26, whereas a tubular braided wire mesh without such corrugations 1466 would typically have a significantly smaller stretching capacity, perhaps only by 2× or 3× lengthwise, depending on factors such as the braid weave angle. This allows device 1550 with a single massage element 1460 to cover a wide range of body limb diameters, including across arms and legs. For example, about 90% of the U.S. population's arm sizes (from wrist to bicep) fall in the range of 6 to 18 inches. And about 90% of the U.S. population's leg sizes (from ankle to thigh) fall in the range of 8 to 24 inches. Therefore, it is preferable to have a single massage element which can cover a range from 6 to 24 inches, while being able to deliver consistent pressure.

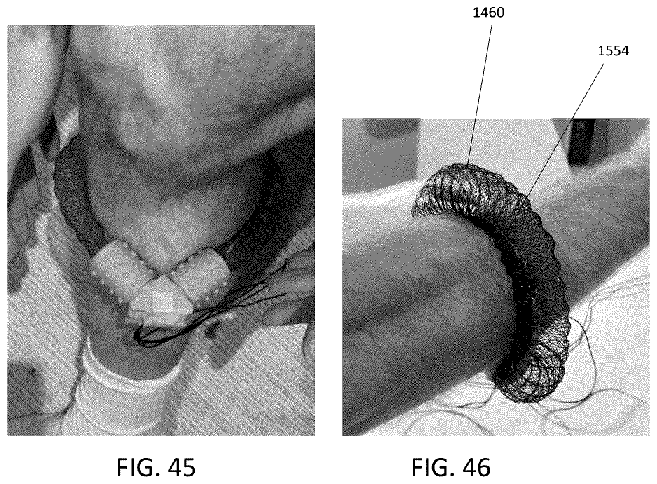

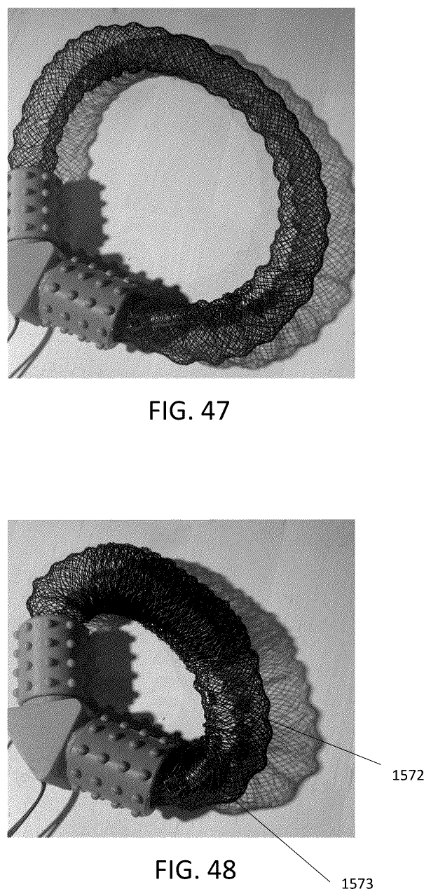

Taking advantage of this increased axial stretch factor, when cable 1554 is tensioned, this not only applies pressure against a body area, but also functions to reversibly shorten the circumferential length of massage element 1460 to conform to and circumferentially hug a wide range of limb diameters being traveled over, such as the calf or forearm as shown in FIGS. 45-46, so that pressure can be uniformly applied around the body area with minimal gaps. As a further example, FIG. 47 shows a prototype of device 1550 where tension on cable 1554 has been released, and massage element 1460 at its resting and longer baseline circumferential length at room temperature. FIG. 48 in turn shows tension on cable 1554 at a near maximum, significantly shortening the length of massage element 1460 for narrower body areas such as the wrist.

When used in device 1550 with tensioning system 1552, massage element 1460 can be composed of Nitinol, Elgiloy, or other heat settable alloys for example, and can be heat treated and set at an intermediate transverse or intermediate tubular braid diameter, corresponding to an intermediate circumferential baseline length at room temperature, so that it can both increase and decrease in length from this baseline length to accommodate the range of needed limb diameters and pressure delivery. For example, take a massage element 1460 having corrugations 1466, and which is about 30 inches long when fully axially stretched, and with a tubular braid diameter collapsed down to approximately 6 mm in this stretched state (similar to FIG. 26), and furthermore about 6 inches long when fully axially compressed (thus a longitudinal stretch factor of about 5), with a tubular braid diameter radially expanded to approximately 20 mm in this state (the max diameter supported by the braid in this example, similar to what is shown in FIG. 23). By partially axially compressing and heat setting such a massage element 1460 (as in FIG. 24 or 25) to normally stay at an intermediate baseline tubular braid diameter and baseline length of about 12 inches at room temperature for example, this would require massage element 1460 to stretch up only by a factor of about two (stretching caused by increased limb diameter) when traveling over wider thighs for example at around 24 inches, and to stretch down by a factor of only about two (shortening caused by active tension on cable 1554 by tensioning system 1552), when traveling over narrower body limb diameters as low as 6 inches or less, such as the wrist. When tension on cable 1554 is released, the heat-treated massage element 1460 can act like a spring, springing back to its heat-set baseline length. Many other size ranges and stretch factors can be used within the scope of the present invention, and previous values are just examples for illustrative purposes.

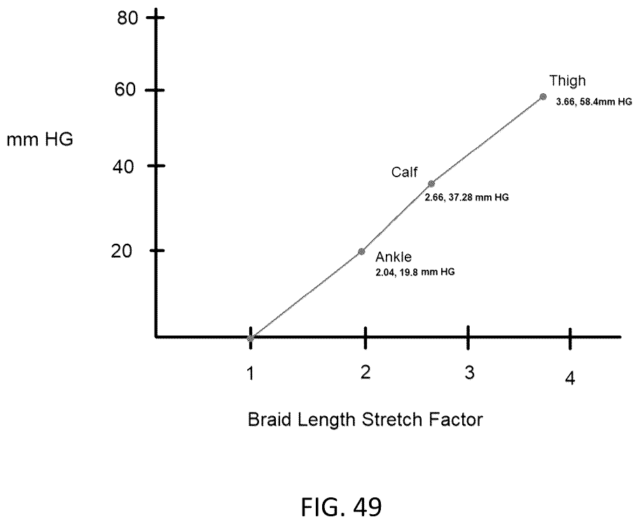

Another advantage of heat setting massage element 1460 at an intermediate transverse diameter is to help minimize the magnitude of the stretch up (longitudinal lengthening) and stretch down (longitudinal shortening) factors utilized to reach and conform to various target body diameters. This is useful for supporting the function of selectively releasing most of the pressure delivered by massage element 1460, and to help reduce the pulling force needed to stretch down massage element 1460 for narrower body areas. As in the previous example, if massage element 1460 only maximally needs to stretch up by a factor of about two (going from 12 inches to 24 inches for example), this reduces the inherent baseline pressure delivered by the stretched and spring-like tubular braid material compared to if the stretch factor was larger. For example, if massage element 1460 was heat set at a fully axially compacted length of 6 inches and then relied on stretching up lengthwise by a factor of 4 to reach 24-inch diameters, the baseline pressure delivered without any added tension by cable 1554 would be much greater than if stretching up only by a factor of two. This is illustrated in a graph in FIG. 49, where pressures in mm HG on the leg versus the lengthwise braid stretch factor were measured and plotted for a sample tubular braided wire mesh with corrugations 1466, utilizing Nitinol wire at about 0.32 mm thickness. As shown by the graph, stretching the braid by about a factor of 2 delivers about 20 mm HG of baseline pressure (also depending on the surface area of the braid), whereas stretching by around a factor of 4 for the same tubular braid delivers much greater pressure, closer to 60 mm HG. This is why stretching by a factor of 4 could be undesirable, because the 60 mm HG in this example would not be easily releasable when device 1550 reverses direction downwards on a wide thigh for example. But if stretching only by factor of two, much less baseline pressure would be applied (closer to 20 mm HG in this example) by massage element 1460. As previously discussed, it is desirable to release pressure on the downward movement for lymphatic massage.

As a further clarifying example, if a user wishes to use tensioning system 1552 and cable 1554 to consistently apply 50 mm HG of pressure for the entire range of distal to proximal travel of device 1550 along a limb, such as from ankle to thigh or wrist to bicep, an intermediate heat-set radial size of massage element 1460 can help support that. Starting from the ankle for example, cable 1554 could be sufficiently tensioned to shorten (stretch down) massage element 1460 to circumferentially hug the ankle, and then further tensioned to deliver the required selected pressure. Then as device 1550 travels upwards on the leg and the leg diameter increases, tension on cable 1554 could be partially and continuously released in small increments by tensioning system 1552, as increased pressure delivery is shared and added by the inherent and increased stretch of the underlying tubular braid by the increasing leg diameter. Then when device 1550 reaches the thigh, cable 1554 can still apply some tension, but significantly less than when at a narrower point to maintain the same 50 mm HG (or any chosen target pressure such as 100 mm HG). Then when device 1550 automatically reverses direction to travel down the leg, all tension in cable 1554 in this example could be temporarily released, resulting only in the inherent baseline pressure applied to the thigh (or other body area) by massage element 1460 (for example 20 mm HG, or significantly less, even as low as 2 mm HG depending on the chosen tubular braid characteristics such as wire thickness and number of ends, and reducing the required stretch factor utilized as previously discussed).

Tensioning system 1552 and cable 1554 help to avoid the need and mechanics for moving the ends of the massage element themselves for shortening or lengthening the deployed massage element as means of applying and controlling pressure, as discussed in previous embodiments. Tensioning system 1552 and cable 1554 simplify how pressure can be applied while simultaneously controlling the length of massage element 1460 and help to make the pressure delivery more independently controllable from the varying circumferential limb diameters massage device 1550 travels over as well as the braid properties of massage element 1460.

Cable 1554 can be a wire, string, tether, thread, rope, coil, line of any kind, chain, spring, flat spring, constant tension spring, power spring, spiral spring, elastic or non-elastic bands, fish line, monofilament, multifilament thread, or other means of delivering pressure or pulling force around a massage element 1460 or other massage elements previously discussed. Cable 1554 can be composed of a wide variety of materials such as polyester, nylon, various metals or alloys, nitinol, Elgiloy, stainless steel, copper, various fabrics, plastics, and other materials as well known in the art. Cable 1554 can be elastic or inelastic.

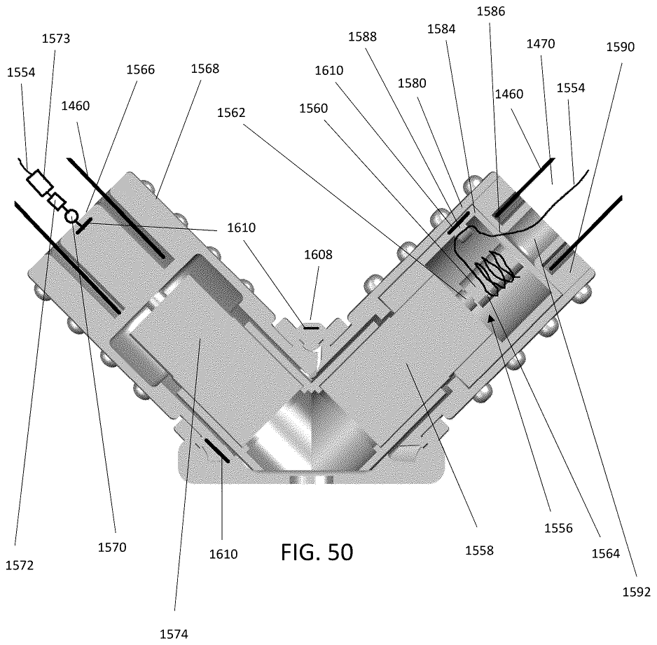

Various mechanisms well known in the art can be employed for tensioning system 1552 for applying tension on cable 1554. As shown in FIG. 50, tensioning system can comprise a winch 1556, which can include a motor 1558 with a spool 1560 on a motor shaft 1562 for spooling up or releasing cable 1554 traveling through lumen 1470 of massage element 1460 for varying its length and the resulting pressure applied by massage element 1460. Spool 1560 can include an attachment point 1564 for securing one end of cable 1554. A winch enclosure 1584 with a cable opening 1586 can be provided around winch 1556 for helping to contain and protect cable 1554 from tangling as it winds and unwinds. The other end of cable 1554 can attach on the opposite end of massage element 1460, for example, to a proximal end 1566 of a roller 1568 for providing a longitudinally fixed point against which cable 1554 can be tensioned or wound. Proximal end 1566 can include an attachment point 1570 such as a hook, and can optionally include a swivel 1572, such as a fishing line swivel, to help prevent the twisting of cable 1554 as roller 1568 rotates when device 1550 moves on the body. A spring 1573, such as an extension spring, can also be provided in-line with cable 1554 near attachment point 1570 for providing some give to cable 1554 when it is tensioned to help avoid constricting a body area too severely.

When motor shaft 1562 and spool 1560 rotate, spool 1560 can wind up or release cable 1554. In order to shorten and apply more pressure with massage element 1460, spool 1560 can rotate to spool up and shorten the length of deployed cable 1554 in massage element 1460, to first conform to the current body limb section, and then further spool up to increase or control pressure on the body section. Conversely to release pressure and to allow massage element 1460 to spring back to its baseline length or partially thereto, spool 1560 can rotate in the opposite direction to release more length of wire into lumen 1470 of massage element 1460, so that when a limb diameter is increasing as device 1550 moves upon it, the circumference of massage element 1460 can also increase, by the stretching caused by an increasing limb diameter.

Motor 1558 can be a relatively low RPM motor using a gear box for higher torque as well known in the art, such as a high torque version of motor N20 or N30, or GM16 though many other motors are possible. Such low RPM gear boxed motors can help resist back-driving when force is applied by a limb onto massage element 1460 and cable 1554. Alternately, motor 1558 can resist back-driving by rotating in the opposite direction to oppose pulling forces on cable 1554 by a user's limb.

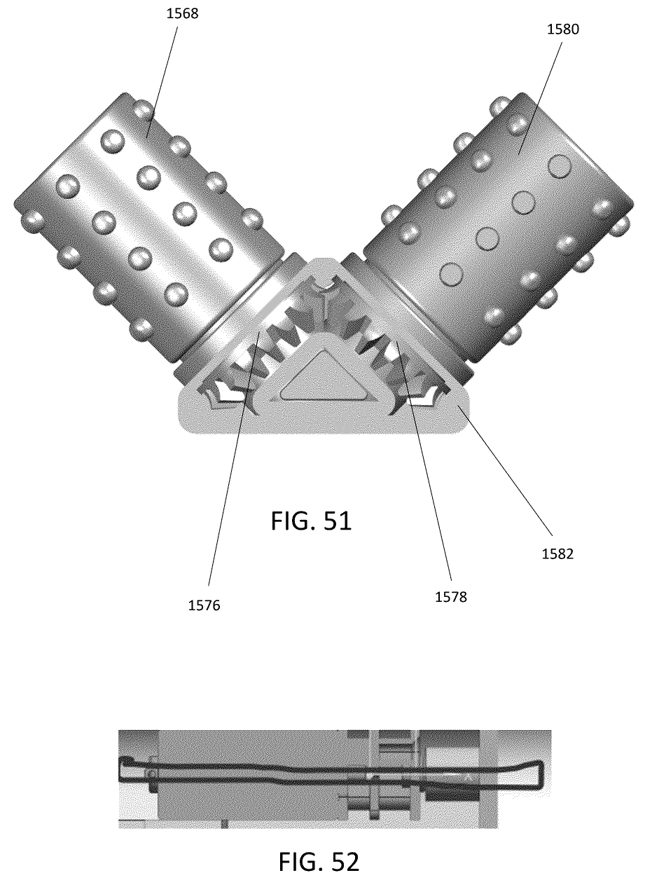

FIG. 51 shows another sectional view of device 1550, illustrating another important advantage of the present embodiment. In order to save space, cost, and weight, device 1550 can rotate both rollers using a single drive motor 1574 as shown in FIG. 50. Roller 1568 can be placed over the shaft of drive motor 1574, and with the body of roller 1568 extending over the body of motor 1574, similar to the arrangement already detailed in many previous embodiments. The difference here is that roller 1568 can have a bevel gear 1576 attached to one end as shown in FIG. 51. The teeth of bevel gear 1576 can interface with the teeth of a second bevel gear 1578 attached to a roller 1580 on another side of device 1550. In this manner, when roller 1568 is rotated by drive motor 1574, second bevel gear 1578 and attached roller 1580 also rotate and at the same speed. When the ends of massage element 1460 are attached to both rollers 1568 and 1580, massage element 1460 can be rotated and rolled up or down on the body as discussed in many previous embodiments, but using a single drive motor, which also can help to extend battery life. Bevel gears 1576 and 1578 can connect at 90 degrees, 120 degrees, 45 degrees, 60 degrees, or any other angle supported by bevel gears well known in the art.

Since the space inside roller 1580 does not need to be occupied by a second drive motor, this space can be utilized to hold the tensioning system 1552, or winch 1556 as shown in FIG. 50, with roller 1580 being rotated around this internal winch by single drive motor 1574. This offers a very space efficient design to help minimize the volume and weight of a housing 1582 of device 1550 as shown in FIG. 51 and also can help with providing an even distribution of mass across device 1550. Another important advantage of using a single drive motor 1574 is that it facilitates cable 1554 to escape the rotating massage element 1460 and attached and rotating rollers 1568 and 1580 system, for connecting to tensioning system 1552. As shown in FIG. 50, single drive motor 1574 blocks the path for cable 1554 to escape roller 1568. For example, even if a longitudinal hole was made in roller 1568 for cable 1554 to exit, cable 1554 would undesirably wind around roller 1568 as it rotates, disrupting the function of tensioning system 1552. But by not having a second drive motor in roller 1580, cable 1554 can escape on that end, in this case, connecting to spool 1560 inside roller 1580. A cable guide 1588 can be provided as part of winch enclosure 1584 as shown in FIG. 50 for changing the direction of cable 1554 so that it reaches spool 1560 in the expected perpendicular orientation for winding and unwinding. A massage element end attachment ring 1590 can be provided above winch enclosure 1584 for fixing one end of massage element 1460 for rotation. Attachment ring 1590 can have an open lumen 1592 for allowing passage of cable 1554 to reach cable opening 1586 and then travel through cable guide 1588 before reaching spool 1560.

Winch 1556 need not necessarily reside in roller 1580. It could be placed in another part of housing 1582, in which case, cable 1554 could escape through the open lumen of roller 1580, and travel to winch 1556 or tensioning system 1552. Alternately, if two drive motors are used in-line with the rollers, another option is to use a hollow central channel motor, as shown in FIG. 52, where both the shaft and body of the motor provide a central open channel for a wire or cable to pass through. A central channel also would need to be provided longitudinally through rollers 1568 and 1580. The disadvantage is that the selection of such hollow central channel motors is more limited, especially for the desired size and torque requirements for device 1550.

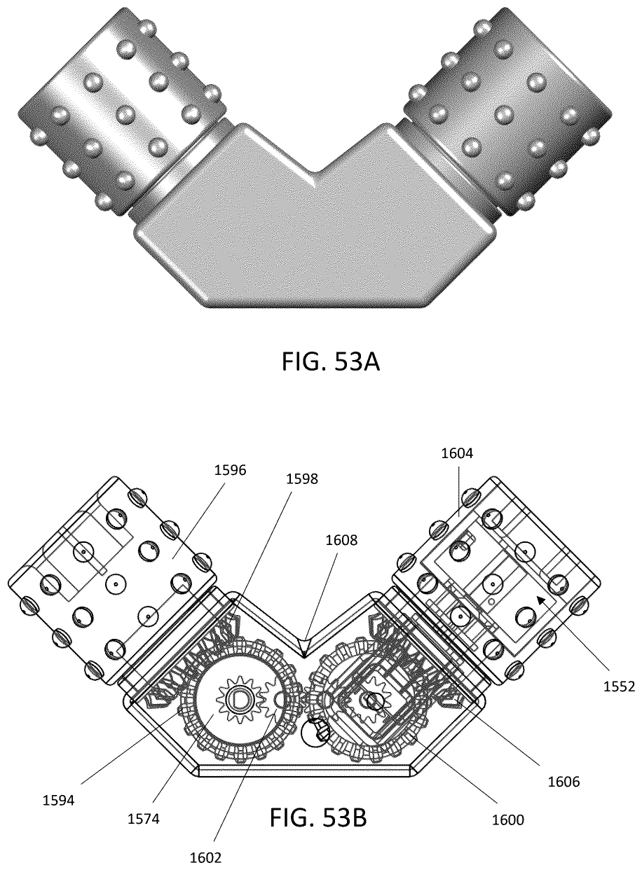

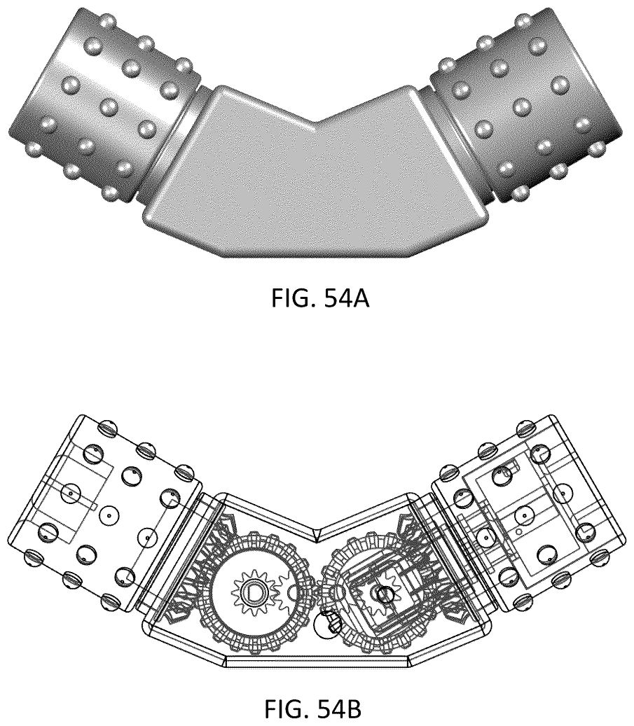

FIGS. 53-54 show an alternate way, compared to the embodiment in FIGS. 50-51, for arranging bevel gears to drive both rollers using a single drive motor. In FIG. 53A-B, single drive motor 1574 is not contained in a roller but lies in a flat orientation in the device housing. A bevel gear 1594 can be attached on the shaft of drive motor 1574 as shown. A roller 1596 with a bevel gear 1598 connected on one end can interface with bevel gear 1594 from the side or diagonally above (or any other angle) as shown to rotate roller 1596. A second bevel gear 1600 can be rotated by bevel gear 1598 by coupling through a gear train 1602, which can consist of a multiplicity of gears, such as two or four gears, and can be spur gears for example, so that bevel gear 1600 rotates in the opposite direction of bevel gear 1594. A second roller 1604, also with a bevel gear 1606 at one end, can similarly interface with bevel gear 1600. Tensioning system 1552 as previously discussed can be contained in roller 1604 as shown or placed in another part of the device housing. One advantage of this arrangement is that the bevel gears attached to rollers 1596 and 1604 need not directly interface as in the previous embodiment. This provides more flexibility on the spacing options between rollers 1596 and 1604, allowing for a variable length limb gap area 1608 at the top of the device housing. As previously discussed, various supplemental massage elements can be mounted here, such as additional rollers, rotating balls, ball transfer bearings, linear bearings, vibrational or percussive elements, electrical stimulation elements, heating or cooling elements, or a variety of sensors previously discussed for measuring the pressure on a limb by device 1550 or measuring heart rate or even blood pressure. Another advantage of the embodiments in FIGS. 53-54 stem from the drive motor lying flat in the device housing, which can help to reduce the overall height of the housing and resulting distance the housing hangs down from the limb as it travels. FIGS. 54A-B show a very similar embodiment with the main change being the relative angle between the rollers, and limb gap area having a less sharp angle. As shown in FIGS. 53A-B, a 90-degree angle is used between the rollers, whereas FIGS. 54A-B shows a 120-angle, though any other angle can be used in the scope of the invention, including a hinge for a variable angle, as well as any other limb gap area size.

Device 1550 can include a sensor 1610 for measuring the tension on cable 1554, and consequently the resulting related pressure applied on a limb by massage element 1460 as it moves on the body. Sensor 1610 can be placed in various locations in device 1550. For example, as shown in FIG. 50, sensor 1610 can be located next to cable guide 1588, or could be placed in-line with cable 1554 near the proximal end 1566 of roller 1568. Sensor 1610 can be connected to a PCB of the present embodiment (similar PCB's were already discussed in detail in previous embodiments), and a battery can be provided in housing 1582 also similarly discussed in previous embodiments.

Sensor 1610 can provide the needed feedback for adjusting in real-time the tension or length of cable 1554 deployed in lumen 1470 of massage element 1460 so as to maintain a specifically set consistent pressure or range of pressures along a limb, while device 1550 travels on the limb. For example, if a target pressure of 50 mm HG is set by the user for the leg, the firmware of the device can adjust the tightness or length of cable 1554 based on feedback from sensor 1610, using tensioning system 1552, or by winch 1556. In the case of winch 1556, spool 1560 can be rotated either direction by the firmware to maintain a consistent sensor reading as the device moves, corresponding to a consistent pressure. And upon reversing direction on the limb, winch 1556 can release all tension in the cable to release pressure on the downward movement.

Sensor 1610 can alternately be placed to more directly measure pressure exerted on the limb by massage element 1460 and device housing 1582. For example, in FIG. 50, sensor 1610 could be alternately placed in the device housing next to roller 1568 to measure pressure on the roller from a limb. Alternately, sensor 1610 could be placed in the limb gap area 1608 to measure contact pressure there.

Sensor 1610 can use many different types of elements including capacitive, resistive, optical, or inductive to measure tension or pressure. For example, a strain gauge could be used, or a photodiode, or a variable capacitor, or a touch sensor.

Sensor 1610 and the device firmware can also be used to determine when to make the decision to reverse direction on a limb as an alternative to using time as previously described. For example, if a mobile app is utilized with device 1550, the app could offer a calibration phase for learning or mapping out the baseline sensor readings or tensioning system adjustments across an arm or leg. In this phase for example, device 1550 could move across the leg from ankle to upper thigh, while maintaining a set pressure such as 10 or 20 or 50 mm HG, while the app records the changes in the sensor pressure readings and/or the necessary adjustments made by tensioning system 1552 to maintain the target pressure, such as the length of cable 1554 wound or unwound by spool 1560, which can be based on the time the winch motor is running. The app could record 10 such sensor value readings and/or 10 tensioning system adjustments per second for example, or with higher or lower frequency. The app could also record real-time user feedback such as the user indicating when the device is located at specific anatomical locations such as the ankle, calf, knee, bottom, middle, or upper thigh. Having constructed and saved such a sensor reading map or tensioning system adjustment map as well as possible user location feedback, the app could then readily infer where device 1550 is located on the same limb when in the normal massage and movement mode. For example, if device 1550 is placed at a random location on the leg and starts moving up, a sequence of adjustments made by tensioning system 1552 to maintain a set target pressure can be compared in real-time to those values recorded during the calibration phase and previously correlated with anatomical location by the user's feedback. The app could estimate with a high degree of probability the current location of device 1550, and with certainty improving based on the length of the trailing sequence values matched. This method can be more resilient against slippage on the limb compared to the time approach previously discussed and could offer a more consistent and accurate reversal point, both on the upper and lower parts of a limb, with any range settable by the user. Alternately, well known machine learning algorithms could be used such as naïve bayes nets or Markov chains to help classify the location of device 1550 based on evidence of sensor values or tensioning system adjustment values, and the previous learning of those values across a limb.

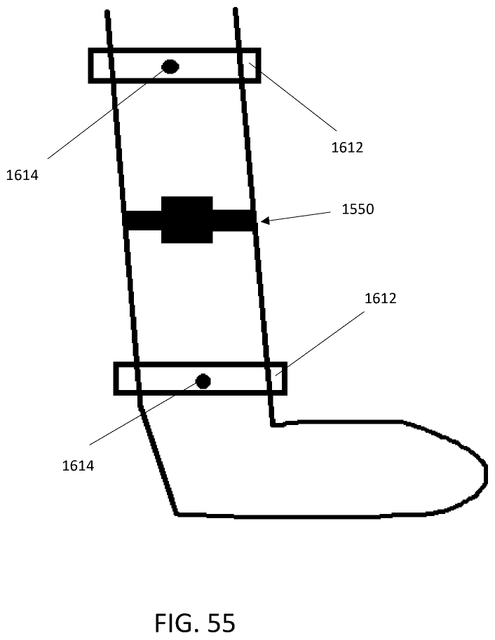

FIG. 55 shows another alternate approach for determining device 1550 reversal locations on a limb. Band markers 1612 can be used for marking the travel range of device 1550 on a limb which the user can position as desired. Band markers can be elastic or non-elastic bands, belts, ribbons, adhesive patches or rings, or other encircling structure, and can contain a magnet 1614 for example, or RFID element, or have a detectable optical pattern for example. Device 1550 can in turn include a magnetic sensor or a hall effect sensor for sensing proximity to magnet 1614, or can include an RFID sensor, or an optical sensor or reader for detecting a pattern on band markers 1612, for determining when to reverse direction.

Tensioning system 1552 can alternately employ other well-known mechanisms for applying a pulling force, such a linear actuator, lead screw, a linear motor, rack and pinion, retraction mechanism such as those used in a typical tape measure with a power spring or spiral spring or constant force spring, or even be manually tensioned by the user manually pulling and securing cable 1554 such as by using a knob or wheel or dial, as alternate ways for applying tension or winding cable 1554 and adjusting the length of massage element 1460. Tensioning system 1552 could also be used with any of the previously discussed massage elements, not limited to massage element 1460.

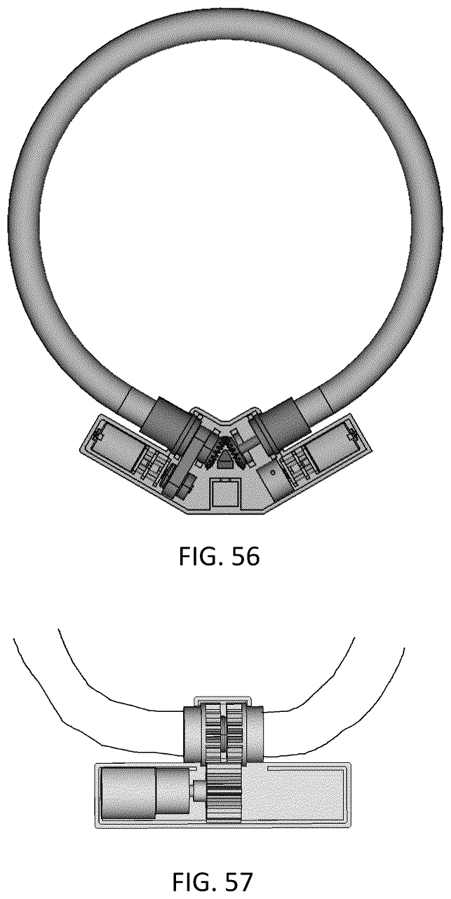

FIGS. 56-71 detail a further series of related embodiments and variations of the present invention, whose elements and arrangements can be utilized in combination with any embodiments in this application.

FIG. 56 shows a drive belt driven by a motor for rotating one of the massage element rollers. Using a drive belt provides additional options for the placement of the drive motor, which can reside side by side or underneath the driven roller for example. As an alternative to a drive belt, a roller chain can be used.

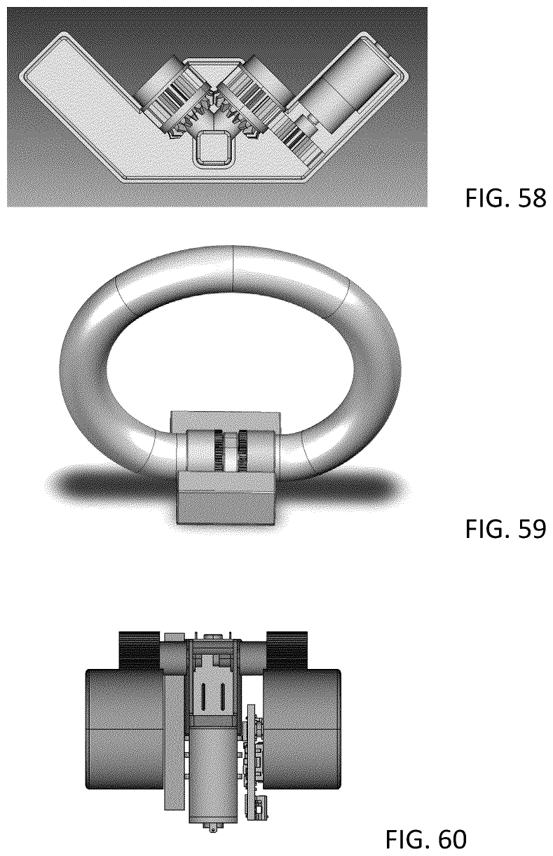

FIG. 57 shows a motor with a spur gear on its shaft for driving both ends of the massage element, which can have short length spur gears on its two ends interfaced with the motor shaft gear. FIG. 58 shows a similar arrangement, except that the motor shaft gear only drives one bevel gear for rotating one end of the massage element, and this bevel gear in turn rotates another bevel gear for rotating another end of the massage element.

FIG. 59 shows a single drive motor directly driving one of the massage element rollers, and with the second massage element roller mounted in-line on the motor body. A nylon bearing can be used to facilitate the rotation of this second roller on the motor body, and to pass cable 1554 through the nylon bearing through a channel in the bearing. A central pedestal between the two rollers can hold the motor body. A gear train can be used to transmit rotation from the driven gear to the mounted gear.

FIG. 60 shows a dual-shaft motor for driving both massage element rollers, which can utilize two gears as shown for driving the rollers as a way to allow cable 1554 to escape (as previously discussed).

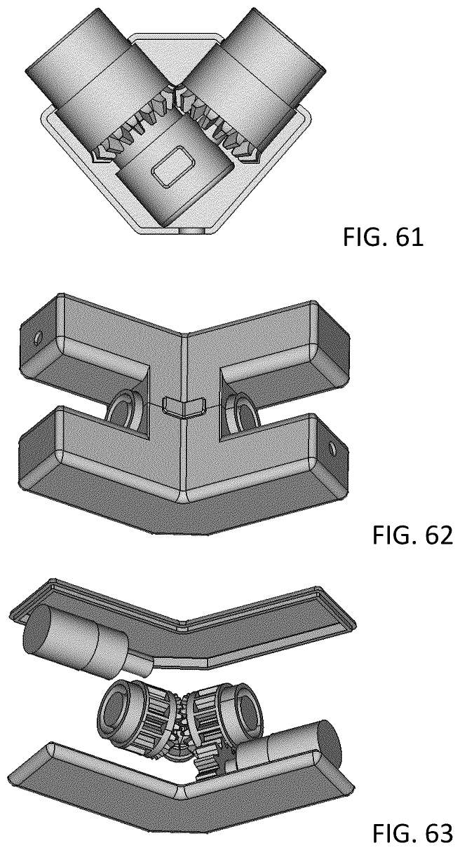

FIG. 61 shows a simple variation with a roller directly driven by a drive motor, and with a side post mounted on the motor body for mounting a bevel gear connected to a second massage element roller which interfaces with a bevel gear connected to the drive roller.

FIGS. 62-63 show an arch or double-V shaped housing which can potentially provide more stability and less wobbling on a limb. FIG. 63 shows the roller drive mechanism, very similar to the embodiment described in FIG. 58. A winch motor is also shown.

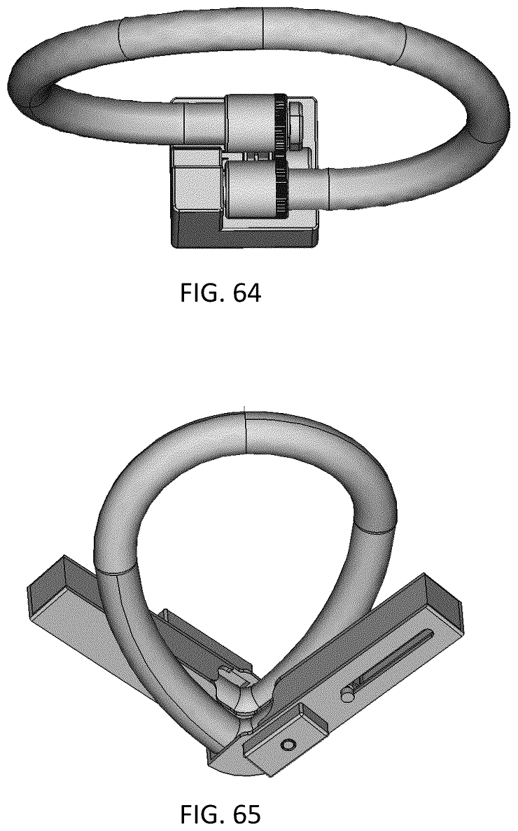

FIGS. 64-65 detail two embodiments showing how the massage element ends can be arranged in a spiral orientation rather than coming together in-line as in previous embodiments. A possible advantage here is less of a gap in coverage, as the spiral can encircle an entire limb, albeit with a transverse gap between the massage element ends. FIG. 64 shows a single drive motor driving both massage element rollers using a gear and gear teeth receptacles on the rollers. FIG. 65 shows a V or arch shaped design with two wings. The ends of the massage element can extend into these wings by a variable length as the way to tension or shorten the massage element for providing pressure on a limb. The massage element ends can be manually moved into the wings using the sliders as shown. Alternately, two lead screws driven by lead screw motors can be included in the wings for automatically pulling or pushing the massage element ends in the wings.

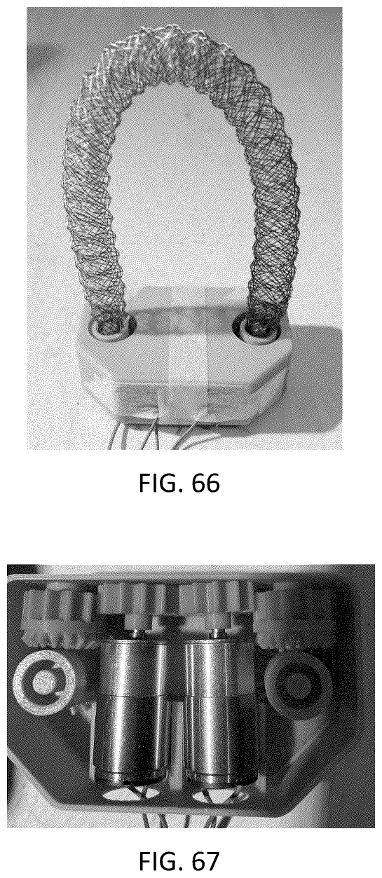

FIG. 66 shows a variation where the massage element is oriented perpendicular to the device housing such that the massage element forms a U shape. Rollers can be mounted on the surface of this housing. One possible advantage here is reducing gaps in coverage by compressing a limb directly against a flat top surface of the housing. An exemplary gear train is shown in FIG. 67 for driving the massage element ends.

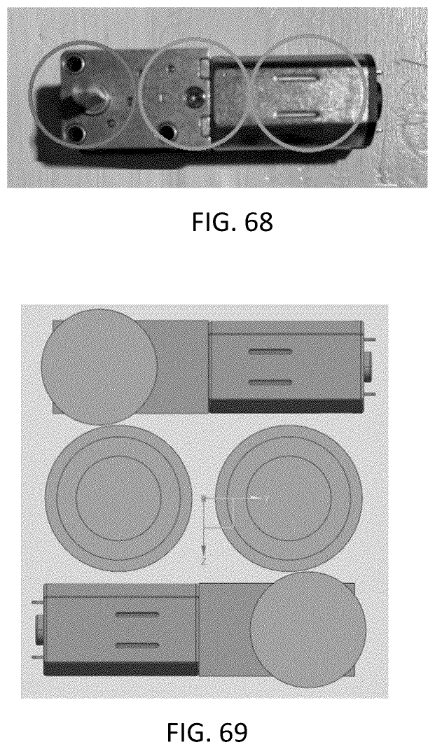

FIGS. 68-69 show the usage of one or motor motors with a 90-degree shaft for driving the massage element ends, perpendicularly oriented relative to the 90-degree motor body as shown by the circles. The massage element ends can have spur gears on the end, driven by spur gears attached on the 90-degree shafts as shown.

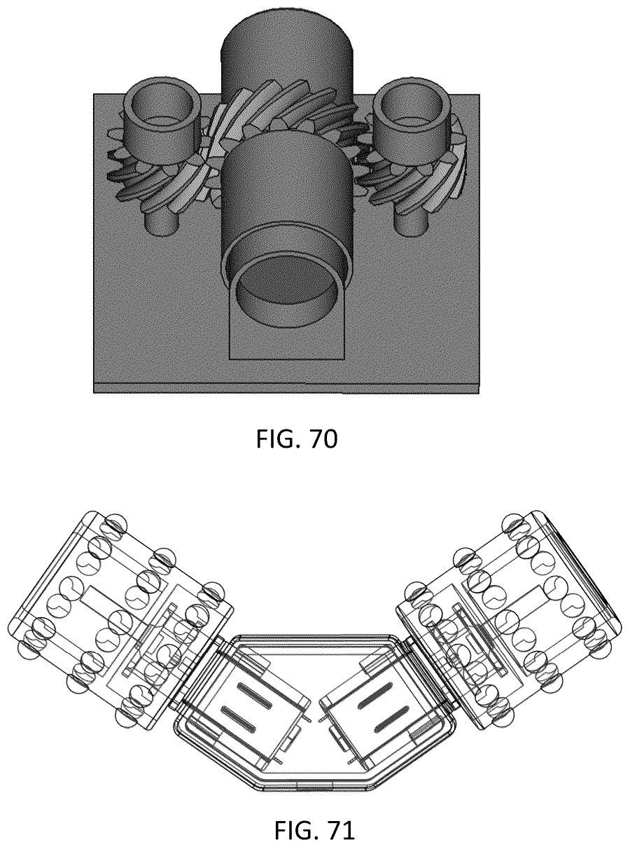

FIG. 70 shows a crossed-helical gear arrangement where the two rollers and gears driving them can have non-intersecting axes with the driving helical gear mounted over the motor body.

FIG. 71 shows a minimalistic version of the present invention in a hexagonal housing shape, with two motors mounted for directly driving two rollers connected to both ends of the massage element. The angle between the motors can be 90 degrees, 120 degrees, or any other angle, or a hinge can be used between the motor holder allowing a variable angle between the rollers. Furthermore, if such a hinge is used, an internal spring such as a compression spring can be included in the housing for biasing the angle between the motors to be on the minimum end of the range of angles.

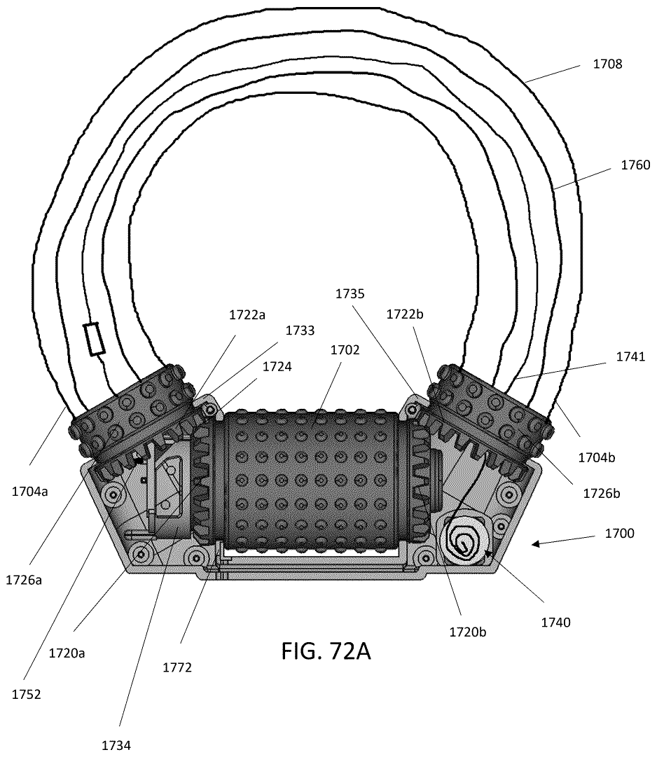

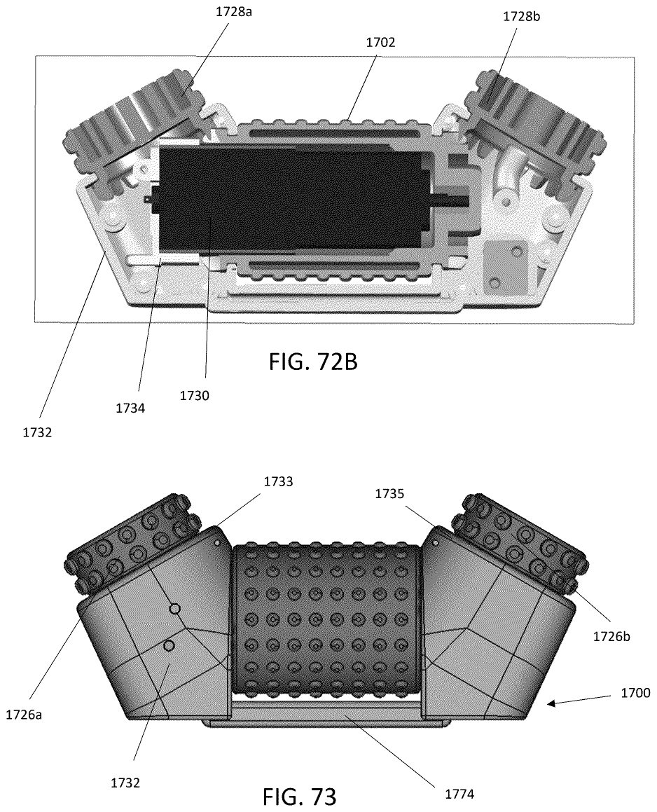

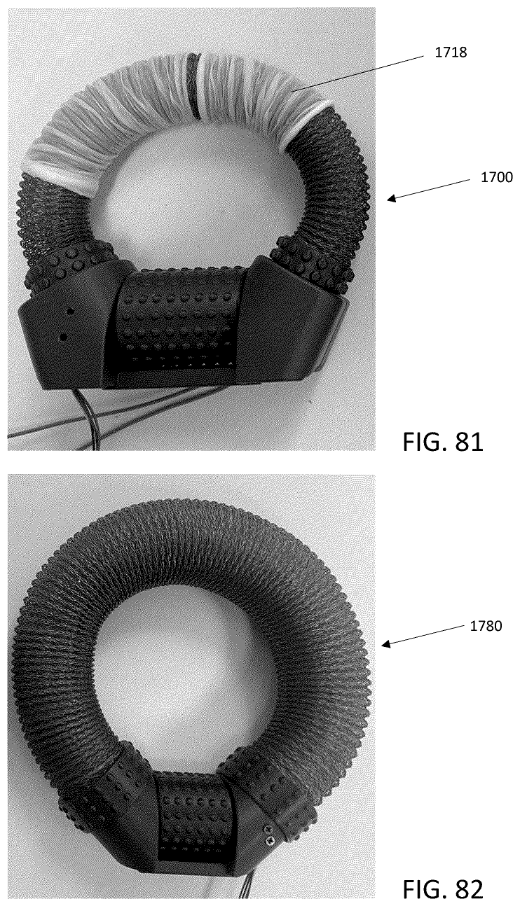

FIG. 72A shows a cutaway view of another embodiment of the self-propelling massaging device 1700 of the present invention, employing a center roller 1702 which can be disposed between ends 1704 of a massage element 1708 as shown with ends 1704a and 1704b. FIG. 73 shows massaging device 1700 with a housing 1732 in a closed state, and FIG. 81 shows a functioning prototype of massaging device 1700.

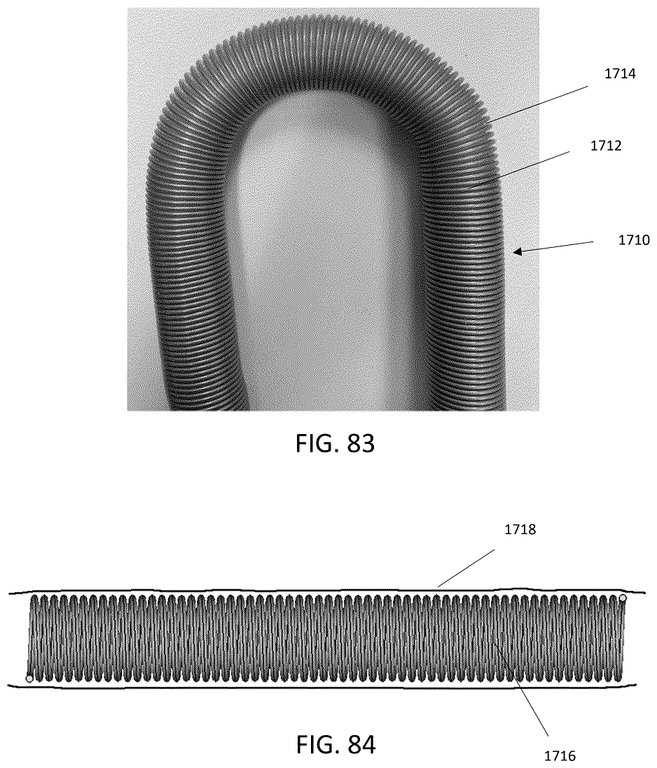

Massage element 1708 can be based on any previously discussed massage elements such as the tubular braided wire meshes or coils or alternate structures like bellows. Massage element 1708 can also be similar in structure to a flexible vacuum hose 1710 as shown in FIG. 83, which can include a metal coil 1712 and an outer covering 1714 which can increase torque transmission capacity. Outer covering 1714 for example can be made from rubber, PVC, polyurethane, thermoplastic, latex, silicone, or other materials. The outer surface of hose 1710 may be ribbed or non-ribbed. Massage element 1708 can also be more generally a coil 1716 as shown in FIG. 84 with a flexible outer layer 1718 made from rubber, PVC, polyurethane, thermoplastic, latex, silicone, or other materials, or can be like a probe cover. Coil 1716 can be made from metal, plastic, rubber, or other materials and can be similar in function to a spiral coiled extension spring which resists longitudinal extension and radial collapse. Massage element 1708 may also be a compound structure such as a combination of a tubular braided wire mesh as discussed in previous embodiments but also having a central supporting flexible core such as coil 1716. This combination can provide the texture and tactile qualities of a tubular braided wire mesh, as well as its torque transmitting capacity especially when it has corrugations 1466 previously discussed, while further reinforcing the mesh internally from radial collapse with the supporting core, as well as helping it further resist twisting or kinking when rotating. Any structure of massage element 1708 as discussed in previous embodiments may utilize outer cover layer 1718, partially shown in FIG. 81.

Center roller 1702 can have one or more center roller gears 1720 disposed along its length as shown in FIG. 72A with gears 1720a and 1720b. Center roller gears 1720 can engage with one or more massage element driver gears 1722 as shown with gears 1722a and 1722b. Center roller gears 1720 and massage element driver gears 1722 can be bevel gears, spiral bevel gears, spur gears, hypoid gears, cross-helical gears, or other gear types, although the bevel gear variety is shown in FIG. 72A for both. Center roller gears 1720 and massage element driver gears 1722 can be mounted and engaged at a fixed angle 1724 relative to each other. Angle 1724 can be any angle but typically in the range of 30 to 90 degrees. Alternately, center roller gears 1720 and massage element driver gears 1722 can be hingeably mounted.

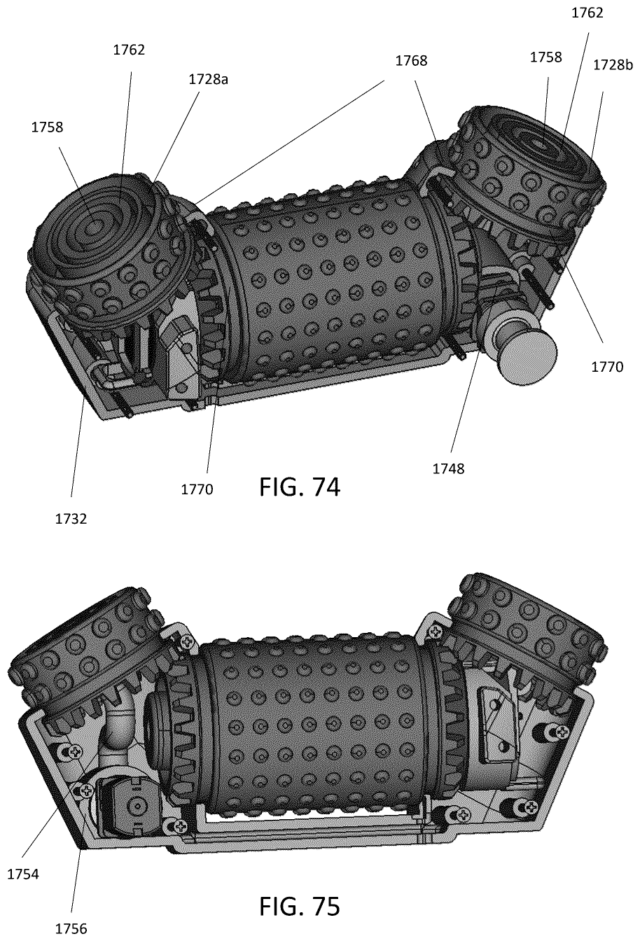

As shown in FIG. 72A, massage element driver gears 1722 can have integrated massage element rollers 1726 for holding and rotating ends 1704 of massage element 1708, for rotating massage element 1708 around its longitudinal axis relative to housing 1732. As shown in FIGS. 72A and 73, housing 1732 can have first and second ends 1733 and 1735 where massage element rollers 1726 can be mounted, thereby rotatably coupling massage element 1708 to first and second ends 1733 and 1735 of housing 1732 and forming a limb opening as previously discussed. As shown in FIG. 74, and sectionally in FIG. 72B, massage element rollers 1726 can each have one or more channels 1728 for holding ends 1704 as shown with channels 1728a and 1728b in FIG. 74. For example, ends 1704 can be glued into channels 1728 or releasably held by many other means such as with a set screw, releasable clamps, screw/thread, spring loaded pins, locking tabs, magnets, and other ways.

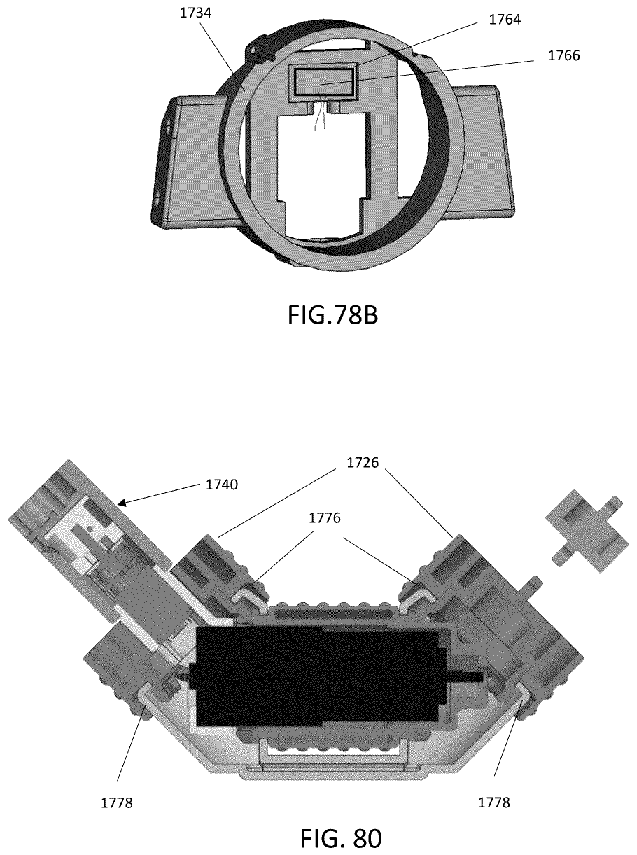

Center roller 1702 can house or partially house a driver motor 1730 as shown sectionally in FIG. 72B for rotating center roller 1702. Driver motor 1730 can be secured to housing 1732 of massaging device 1700 by utilizing a motor holder 1734 as shown in FIGS. 72A, 72B, 74, and a close-up view in FIG. 78A. Motor holder 1734 can for example hold and secure driver motor 1730 to housing 1732 by utilizing one or more retention lugs 1736 which can be inserted into one or more motor holder receptacles 1738 in housing 1732 as shown in FIGS. 78-79.

As shown in FIG. 72A, massaging device 1700 can utilize a winch 1740 similar to winch 1556 previously disclosed in FIG. 50, providing selectable tension to massage element 1708 with similar related components previously disclosed, including a cable 1741 which travels through the lumen of massage element 1708. A main difference in this present embodiment is that winch 1740 can be contained inside housing 1732 instead of a roller, which can simplify the implementation.

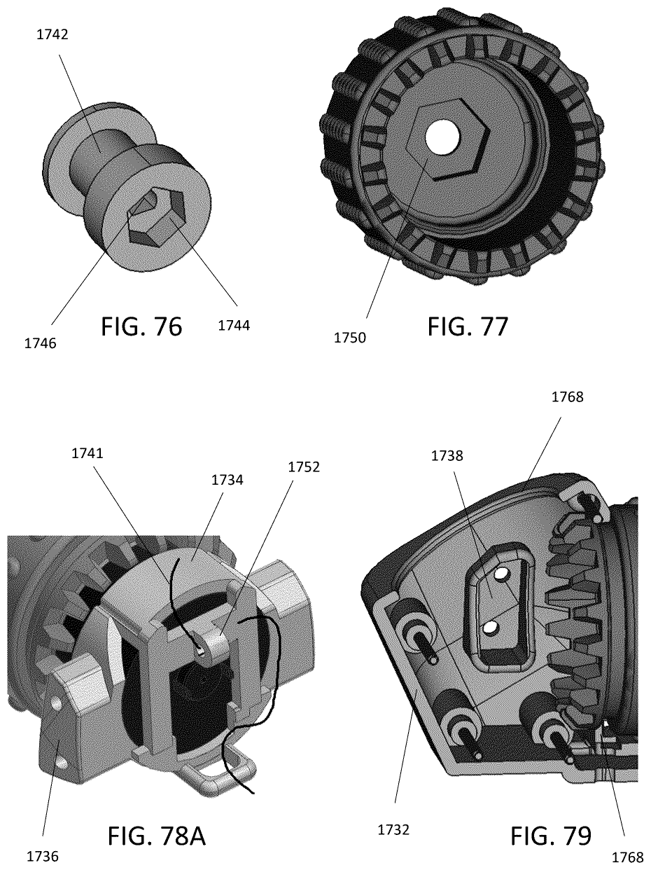

A spool 1742 of winch 1740 is shown in FIG. 76 around which cable 1741 can wind or unwind to control the tension of massage element 1708. Spool 1742 can have a nut 1744 into which the motor shaft of a winch drive motor 1748 (shown in FIG. 74) is inserted. Nut 1744 can have a D-cut shaft receptacle 1746 with a flat edge. The advantage of using nut 1744 to transmit torque to spool 1742 is to prevent the winch motor shaft from chewing through the plastic material of spool 1742, since nut 1744 has a much larger surface area than the winch motor shaft and can distribute the load. Similarly in FIG. 77, a nut 1750 can be used for transmitting torque to center roller 1702 by driver motor 1730. Nuts 1744 and 1750 can be made from a metal for example like stainless steel or aluminum.

As shown in FIG. 78A, motor holder 1734 can have a cable mount 1752 for attaching one end of cable 1741. An advantage of using cable mount 1752 is that a swivel is not needed as in winch 1556, since cable mount 1752 is not rotating and twisting cable 1741.

As shown in FIG. 75, winch 1740 can further include a cable guide 1754 with an internal channel through which cable 1741 travels, and this channel can feed into a winch cover 1756 which can enclose spool 1742 along with any wound cable 1741. Cable guide 1754 can help prevent cable 1741 from catching on massage element driver gears 1722 or center roller gears 1720, or from tangling inside housing 1732.

As shown in FIG. 75, as winch 1740 winds or unwinds, cable 1741 can travel in a path from spool 1742 through winch cover 1756, then through cable guide 1754, then through a lumen 1758 of massage element roller 1726b as shown in FIG. 74, then through the lumen of massage element 1708 as shown in FIG. 72A, and then through lumen 1758 of massage element roller 1726b to attach to cable mount 1752. Optionally, a cable insulator 1760 can be used for insulating cable 1741 from directly contacting massage element 1708 as it applies tension. This can help to reduce friction between cable 1741 and massage element 1708, especially if a braided tubular wire mesh is used for the massage element. Cable insulator 1760 can be a coiled structure which can longitudinally stretch along with massage element 1708, such as many previously disclosed structures such as coiled phone cords or extension springs. Also a spiral cable wrap can be used or various stretchable sheaths know in the art. As shown in FIG. 74, cable insulator channels 1762 can be included in massage element rollers 1726 for securing cable insulator 1760. In this arrangement, cable insulator 1760 can rotate together with massage element 1708 when massage element rollers 1726 are rotating. This can help reduce friction between cable insulator 1760 and massage element 1708.

FIG. 78B shows the backside of motor holder 1734, which may include a sensor mounting receptacle 1764 for receiving a sensor 1766, similar to sensor 1610 previously discussed for measuring tension in massage element 1708. Sensor 1766 for example can be a strain gauge or other sensor type including but not limited to those previously discussed. When cable 1741 is tensioned by winch 1740, tension on cable mount 1752 can strain or bend motor holder 1734 which can be detected by sensor 1766 as part of the previously discussed feedback system for controlling pressure in the massage element.

As shown in cutaway view in FIG. 74 and FIG. 79, housing 1732 can include rim guides 1768 for holding and supporting the rotation and engagement of both center roller gears 1720 and massage element driver gears 1722. Center roller gears 1720 and massage element driver gears 1722 can have rim channels 1770 into which rim guides 1768 are fitted.

As shown in FIG. 72A, an alternate sensor location 1772 for sensor 1766 can be provided adjacent to rim guide 1768 for center roller gears 1720. When pressure from a limb is applied onto center roller 1702, this pressure can be transmitted by rim channels 1770 to cause straining or bending of the area near rim guide 1768, thus affecting a sensor placed there. The present embodiment may include sensors in one or more locations to help confirm the pressure signal.

Massaging device 1700 can include a battery 1774 as shown in FIG. 73, such as a flat rechargeable battery as previously discussed, as well as a PCB as also previously discussed in many previous embodiments, for powering and controlling the device, and both can be placed in various locations inside or on housing 1732.

FIG. 80 shows an alternate location for placing winch 1740, which is inside one of massage element rollers 1726 and extending if needed into massage element 1708. This arrangement can help reduce the size of housing 1732. A device battery can also similarly and optionally be included in one or more element rollers 1726 and extending if needed into massage element 1708 as a further way to reduce housing size.

FIG. 80 also shows an alternate way of rotationally mounting massage element rollers 1726 onto housing 1732, where massage element rollers 1726 have recesses 1776 which can fit over necks 1778 of housing 1732. This arrangement is also shown in FIG. 82 for a prototype 1780. The advantage is that any gaps between massage element rollers 1726 and center roller 1702 can be greatly reduced such that nearly the entire surface of massaging device 1700 is in rotational contact with a limb at is travels, minimizing friction from any dragging of housing 1732 against the limb.

When massaging device 1700 in FIG. 7A and FIG. 81 is operated, driver motor 1730 rotates clockwise or counterclockwise, causing center roller 1702 to rotate, which in turn causes center roller gears 1720 to rotate massage element driver gears 1722, which drives the simultaneous rotation of massage element rollers 1726 together with attached ends 1704, causing massage element 1708 to rotate in a forward or reverse direction, such that when massaging device 1700 is worn over a limb, the device can travel selectably up or down the limb as discussed in previous embodiments. One advantage of this embodiment is that center roller 1702 can provide an actively rotating roller surface in any gap between ends 1704 of massage element 1708, which can help reduce drag and friction against a limb, and to help propel massaging device 1700 along the limb. Roller 1702 can also provide the benefit of additional stimulation for the limb. Massage element rollers 1726 can also be in contact with a limb and can include texture features such as small surface bumps as previously discussed. Center roller 1702 can also include such similar surface features.

Driver motor 1730 and/or winch drive motor 1748 can include a gear reduction gearbox for suitable speed and torque, which can be for example a planetary gearbox or spur gear box, or other type of gear box. Driver motor 1730 and/or winch drive motor 1748 can for example be a brushed or brushless motor, or coreless motor, and can optionally use rare earth magnets to increase torque.

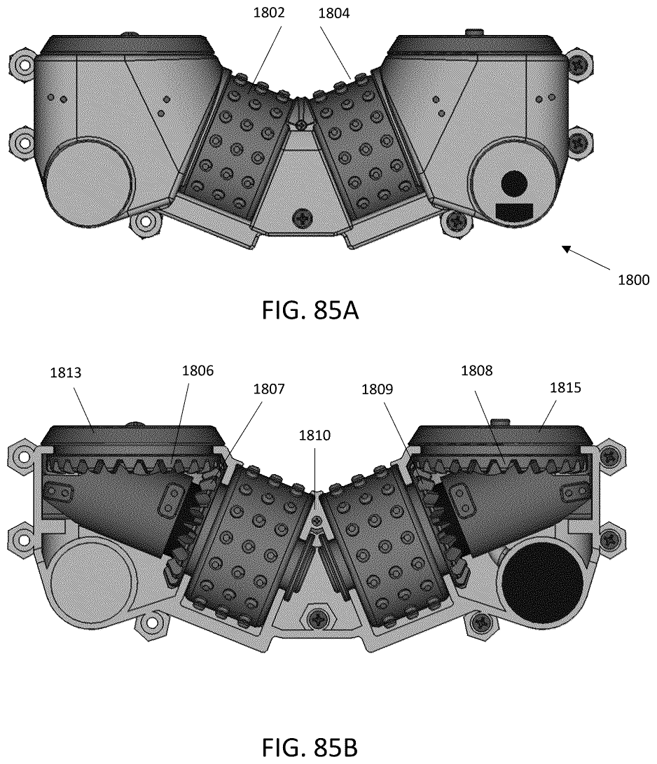

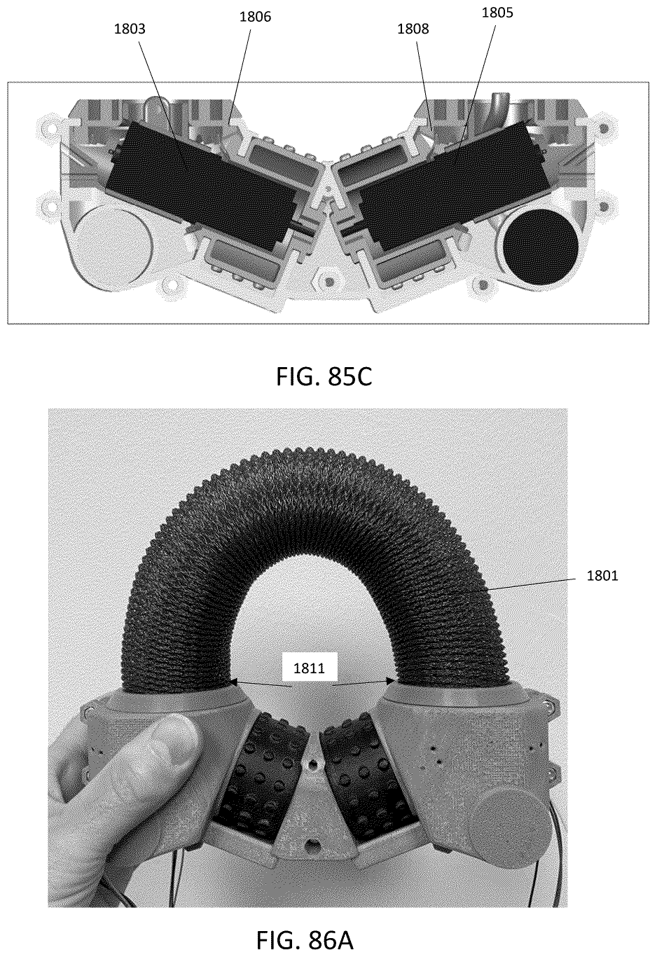

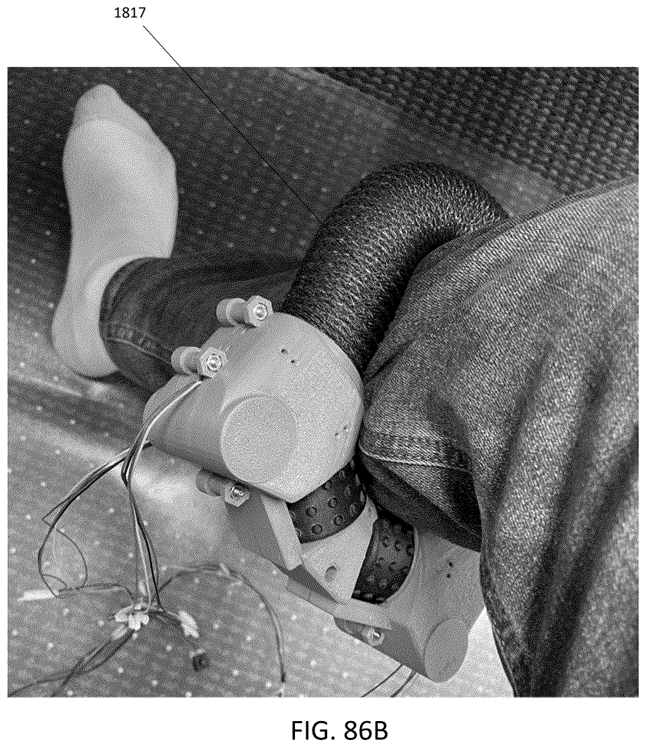

FIGS. 85A-C shows a massaging device 1800 similar to the embodiment of massaging device 1700 described in FIG. 72A, with a key difference being that massaging device 1800 can include two center rollers 1802 and 1804 rather than one. Center rollers 1802 and 1804 can each contain its own driver motors 1803 and 1805 as shown in FIG. 85C, similarly mounted as previously described for massaging device 1700, and with a similar gearing arrangement for driving a massage element 1801 (shown in FIG. 86A), except that each center roller 1802 and 1804 can in turn have its own center roller gears 1807 and 1809 for driving one end of massage element 1801 as shown in a cutaway view in FIG. 85B.

Massage element driver gears 1806 and 1808 can optionally have more gear teeth than the center roller gears 1807 and 1809 which they engage with, and have a larger outer diameter as shown. This can provide a mechanical advantage for greater torque delivered to the massage element than the rated torque provided by driver motors 1803 and 1805, and as visible in FIG. 85C, allows placing massager element driver gears 1806 and 1808 and the corresponding massage element rollers 1813 and 1815 further inwards to cover more of the driver motor bodies while still being able to clear the driver motors and motor holders as they rotate, which also has the important effect of reducing a distance 1811 between the ends of massage element 1801 as shown in FIG. 86A, and allowing center rollers 1802 and 1804 to be shorter in length. This reduced distance 1811 or gap can help the device conform to a greater range of limb diameters, such as from the ankle to upper thigh and without slipping down at the ankle, since it allows proportionally more circumferential coverage of the limb by the stretchable massage element relative to the device housing length. Again, for brevity, only key differences are pointed out relative to the previous embodiment.

Massaging device 1800 can provide several additional advantages over the previous embodiment. By including two center rollers 1802 and 1804, an angle 1810 between them (shown in FIG. 85B) can be fixedly set to help the device better universally conform to any limb surface as it travels, as opposed to using a single center roller flat against a limb, and this angle can be independently selected relative to the chosen fixed angle between massage element driver gears 1806 and 1808 and center roller gears 1807 and 1809 previously described, allowing the axes of massage element rollers 1813 and 1815 as well as massage element 1801 to lie in a different direction than the axes of center rollers 1802 and 1804. In this manner, the massage element, massage element rollers, and center rollers all together can better approximate a circular limb opening (FIG. 86A), and to better cradle, stretch, and wrap around a limb to avoid gaps between the device housing and limb as it travels. Such cradling can also help to prevent the tilting of the device housing as the driver motors face resistance, by better supporting and holding the housing against the limb. Furthermore, by utilizing two driver motors 1803 and 1805, twice the torque can be imparted onto the massage element so that it is less likely to stall under high winch pressures. Additionally, by mounting two driver motors 1803 and 1805 at opposite ends of the device housing and with the motor bodies facings outwards as shown sectionally in FIG. 85C (and motor shafts facing inwards), this further helps to stabilize and prevent tilting of the housing by taking advantage of a desirable leverage effect: Since the housing generally tilts or pivots at the points where the motor bodies are mounted/restrained and when the motors shafts face resistance, by increasing this mounting distance and by utilizing more than one driver motor, a greater lever arm distance is created requiring less holding force to prevent tilting. Also in this arrangement, the massage element ends can coincide with the positions of the motor body ends which further helps to hold the device at those tilting points to further restrain the device from tilting, especially when the winch cable holds the massage element with pressure against the encircled limb. Furthermore, by utilizing a coil 1817 or other reinforcement member inside massage element 1801 as shown in FIG. 86B, kinking or twisting of massage element 1801 can be reduced or eliminated when torque is applied to massage element 1801. Massage element 1801 can be a tubular braided wire mesh as previously discussed and can be made from nitinol or other elastic material and can include corrugations 1466 previously discussed.

FIG. 86A shows a functioning prototype of massaging device 1800, and with the device actively rolling and massaging a calf muscle in FIG. 86B, while utilizing winch pressure.

Optionally, massaging device 1800 can be driven by a single driver motor, and using a gearing arrangement between the center rollers. For example, a similar gearing arrangement as shown in FIG. 51 could be utilized, with center roller 1802 for example driving center roller 1804 with a similar bevel gear connection.

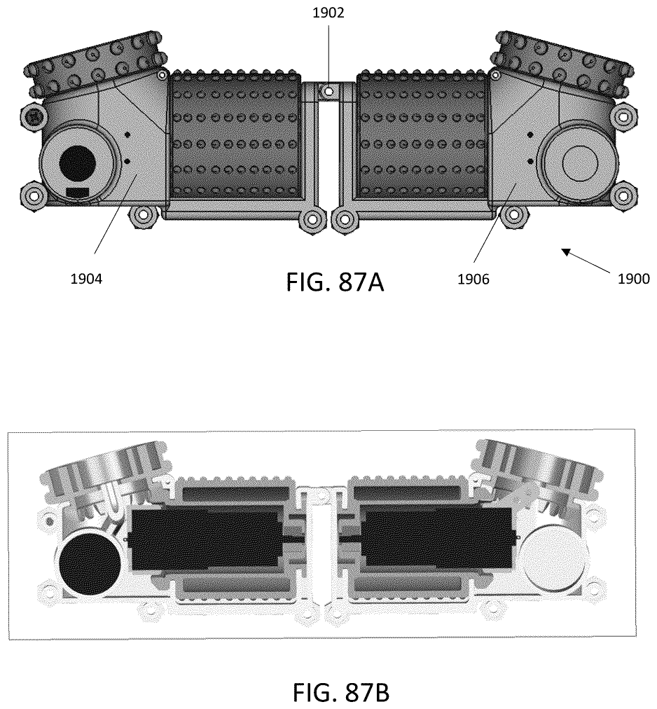

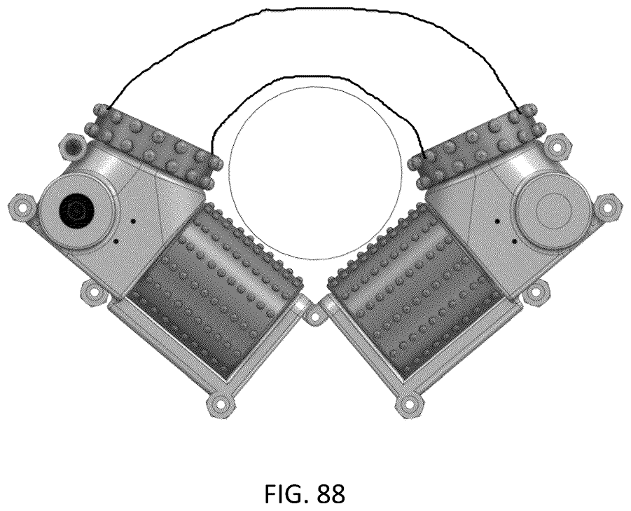

FIGS. 87A-B shows a massaging device 1900 similar to the embodiment of massaging device 1800, with a key difference being that massaging device 1900 can include a hinge 1902 between the center rollers, giving the device even more flexibility in conforming to wider range of limb diameters as it travels by allowing the angle between the center rollers to vary as needed. For example, this angle can be relatively flat as shown in FIG. 87A when the device is over a wide limb area such as the upper thigh, or a sharp angle (for example close to 90 degrees) as shown in FIG. 88 when the device is over narrower limb areas such as the ankle or wrist. This dynamic adaptation helps to reduce any gaps between the encircled limb, and the massage element, massage element rollers, and center rollers as the device travels along a limb.

Massaging device 1900 can consist of two halves 1904 and 1906, each similar to housing 1732 of massaging device 1700 (or similar to splitting massaging device 1800 down the middle along angle 1810 into two housings), but each with a single driver motor, massage element driver gear, massage element roller, center roller gear, and center roller, and with only one of the housings containing a winch as shown sectionally in FIG. 87B. Housing halves 1904 and 1906 can be hingeably connected with hinge 1902. Hinge 1902 can be a simple pin-based hinge, a spring-biased hinge, offset, flush, or concealed hinge, and many other types possible. Hinge 1902 can be placed near the top of the housing halves 1904 and 1906 to maintain a relatively fixed distance between the inner ends of the center rollers as the housing halves rotate through the full angle range. Such a hinged arrangement also can have the desirable effect of allowing the winch cable pressure to tend to close the hinge and rotate the center rollers and massage element rollers inwards towards the limb as shown in FIG. 88 for example, to further improve the consistent radial pressure against the limb.

In FIG. 87B, the massage element driver gears and corresponding massage element rollers are shown at the ends of the driver motors much like the embodiment in FIG. 72A, resulting in longer center rollers. But massage element driver gears and the corresponding massage element rollers can be similarly arranged as discussed for massaging device 1800 to be situated further inwards over the driver motors to reduce the lengths of center rollers and further reduce the distance between the massage element ends.

Much like massaging device 1800, massaging device 1900 is similarly very effective at resisting and preventing a tilting effect of the housing as the device travels along a limb and delivers pressure, with the outwardly-mounted motor bodies helping to support this effect as well as the conforming hinge and angle between the center rollers also serving to hold the device stable.

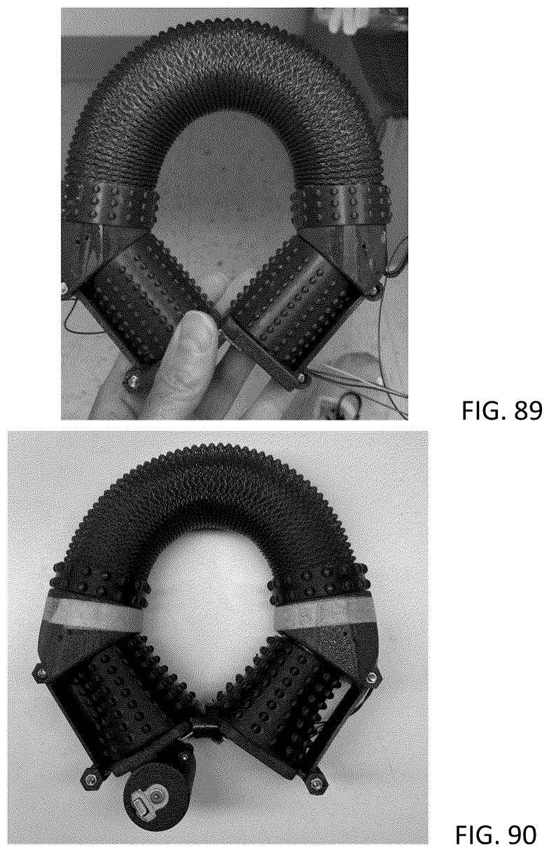

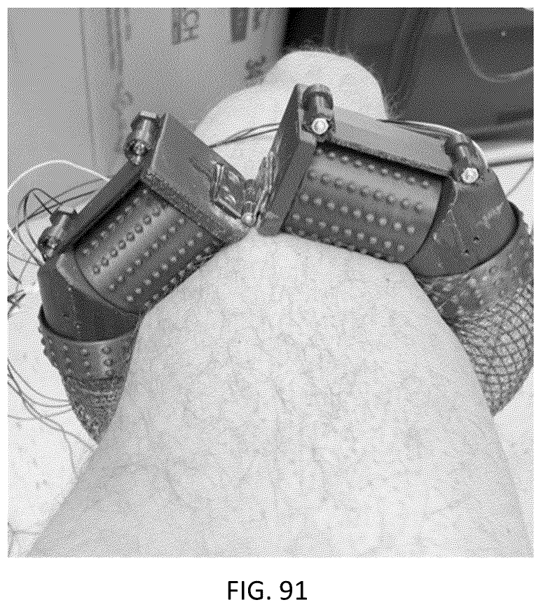

FIGS. 89-90 show several functioning prototypes of massaging device 1900, with the winch shown in an alternate central location between the hinged center rollers in the prototype in FIG. 90. FIG. 90 also shows how the diameter of the center rollers can optionally vary along their lengths, such as in a bell shape, to aid in filling any minor gaps between the device and limb. FIG. 91 shows the device actively traveling on the leg after crossing the knee, with the device housing in this case facing upwards on the leg and clearly showing that the housing is not tilted.

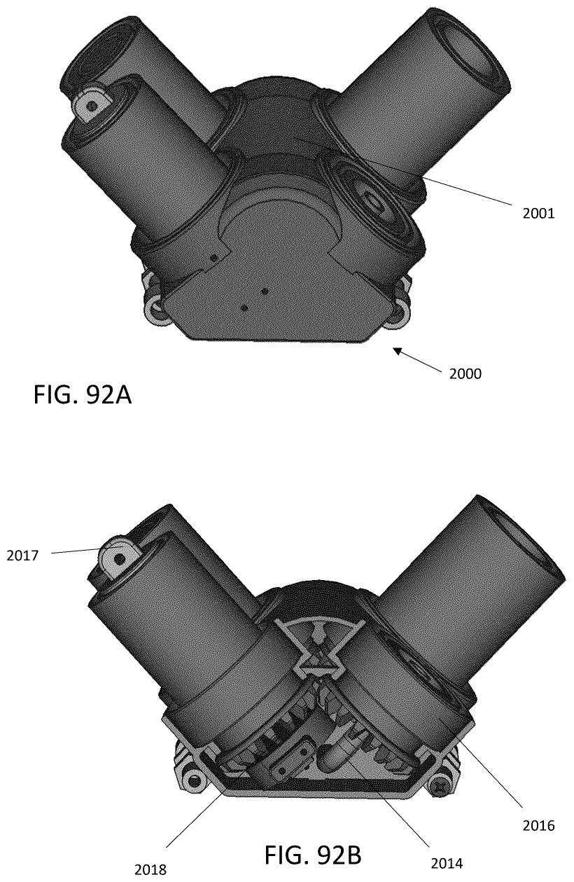

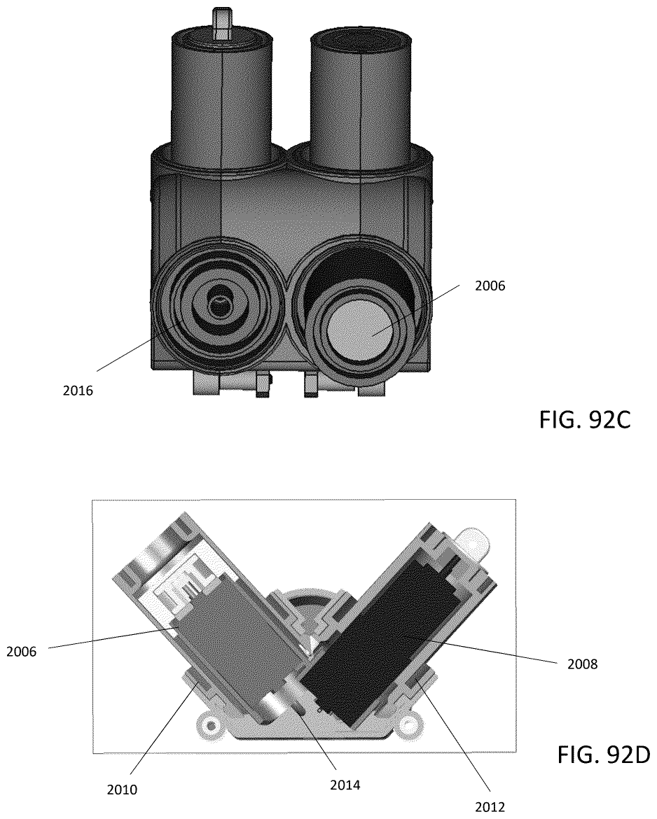

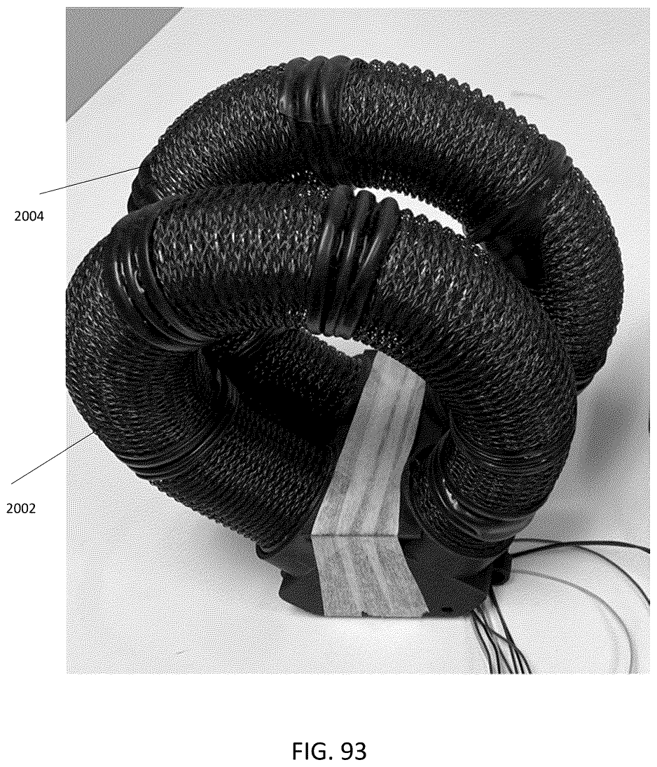

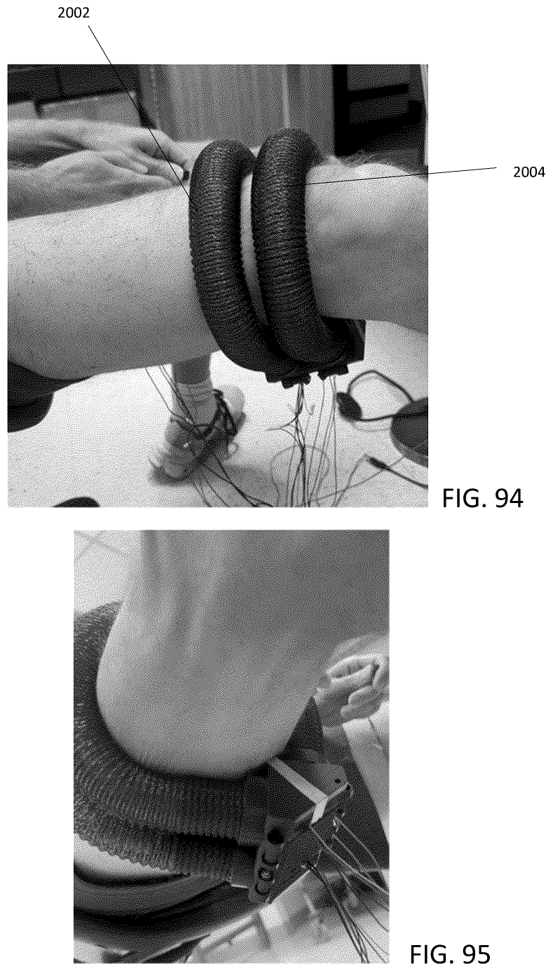

FIGS. 92A-D shows a massaging device 2000 similar to device 1550 detailed in FIGS. 44-51, with a key difference being that massaging device 2000 essentially consists of two such devices 1550 situated next to each other (in the direction of the limb travel axis) and formed into a single housing 2001, and thus utilizing two side-by-side massage elements 2002 and 2004 for traveling along a limb as shown up-close in FIG. 93 in a functioning prototype, and with FIGS. 94-95 showing this embodiment actively moving along a leg. Additionally, massage elements 2002 and 2004 of this embodiment can generally be longer relative to the device housing length than in the previous center roller embodiments, which can provide a larger range of limb diameter accommodation since the massage elements having longer baseline lengths for stretching due to the massage element ends coming closer together in a V orientation.

FIG. 92D and FIGS. 50-51 sectionally show the similarity between these embodiments, with massaging device 2000 also utilizing a winch 2006 and a driver motor 2008 compactly situated inside the rollers for driving the rotation of the massage element ends of massage element 2004, and with these rollers in a similar geared arrangement such that driver motor 2008 can drive both rollers as previously described for example, with a bevel gear connection as in device 1550. One difference is that the rollers driving the massage element ends can have skirts 2010 and 2012 as shown in FIG. 92D at the proximal ends of the rollers for securing the massage element ends such that the rollers are then not visibly exposed but contained within the rotating massage elements.

Another key difference in massaging device 2000 relative to device 1550 is that a cable guide tube 2014 can be provided which guides the winch cable proximally out of its roller (instead of distally through the coaxial massage element as in device 1550) and into an adjoining roller 2016, which is driven by a second driver motor 2018 on the other side of massaging device 2000 in a similar gearing arrangement. This results in roller 2016 not being rigidly obstructed with anything inside of it other than the end of massage element 2002 and any internal support coil (coil discussed in the embodiment in FIG. 72A).

In this arrangement, massage element 2002 can be the therapeutic pressure-providing element, with the winch cable running out of roller 2016, through massage element 2002, and attaching to a hook 2017 at the end of the roller at the other side, previously discussed. Massage element 2004 in turn helps to provide support and stability of massaging device 2000 and to help prevent it from tilting as it moves along a limb, while also providing a supplemental massage sensation and helping to propel the entire device along the limb in either direction and reduce the risk of stalling when under high winch pressure. By not obstructing roller 2016 with an internal driver motor for example, massage element 2002 can also better conform to a range of limb diameters from ankle to upper thigh for example when the winch cable pressure is activated, since massage element 2002 is able to bend inwardly (at least at the unobstructed end) to better conform to the limb, especially on the ankle. Also keeping roller 2016 unobstructed internally helps it function better as a seat for a pressure sensor (previously discussed), since lateral forces on this roller are not restricted by a rigid internal member.

When the user operates massaging device 2000, it is generally worn on the limb with the pressure-providing massage element 2002 leading the way forwards up the limb, and massage element 2004 holding up the rear, as shown in FIG. 94, though it can be reversed if desired.

By utilizing two active massage elements 2002 and 2004, massaging device 2000 can provide a number of advantages, such as reducing tilting of the housing, helping the device to travel along the foot or hand, and even cross the heel, providing an added sensation from two massage elements, and additionally helping to reinforce the up-the-limb lymphatic fluid flow from the trailing massage element. Alternately, a winch could be similarly provided in massage element 2002 so that both massage elements 2002 and 2004 can provide active pressure, with equal pressures or varying levels of pressure to create pressure gradients, pressure zones, or similar pressure effects to zones offered by pneumatic compression devices.

There are many additional possible variations of gear trains, drive belts, massage elements, device housings and rollers, and combinations of gears and belts and many previous embodiments for achieving the self-propelling and related functions of the massaging device of the present invention, and all within the scope of the present invention. Some of these variations are now briefly presented at a high level, in the following figures and additional descriptions, but should be understood for completeness in the context of the already fully disclosed previous embodiments.

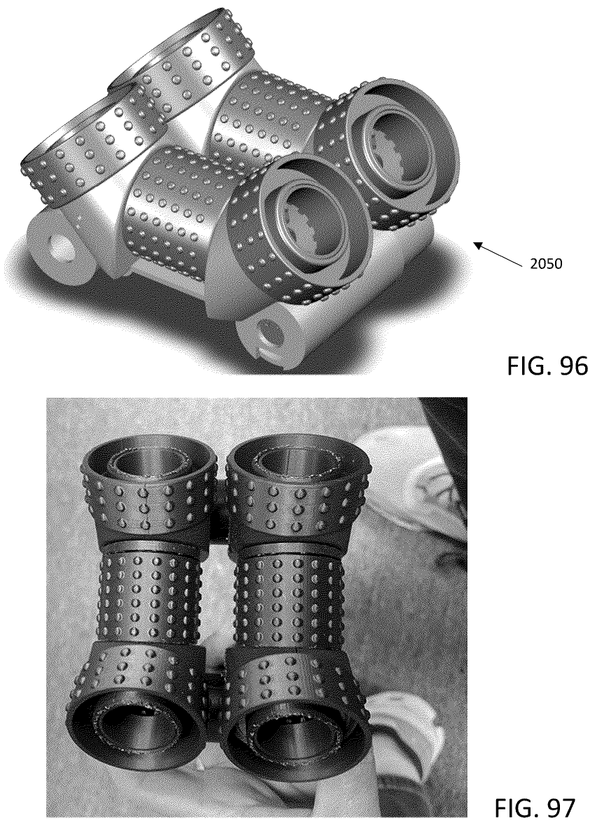

FIGS. 96-97 show an embodiment of a massaging device 2050 based on the center roller design of massaging device 1700 shown in FIG. 72A, but with two such devices fused together into a single housing and also utilizing two massage elements much like in the previous embodiment, but with two active center rollers to help propel the device and drive the massage elements together, with similar advantages as the previous embodiment.

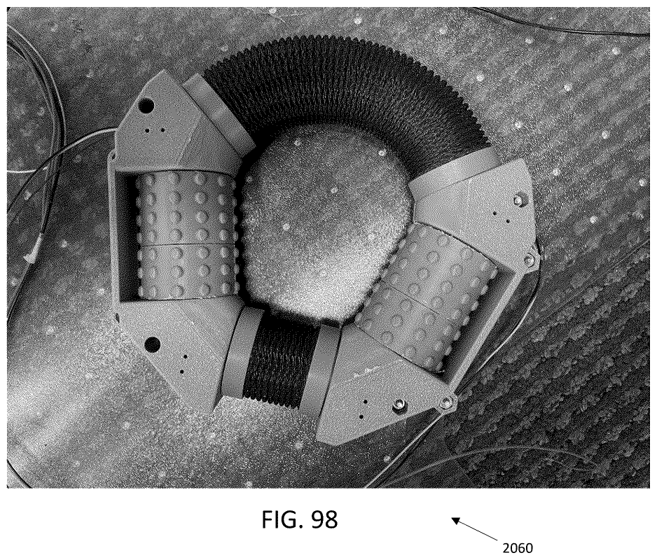

FIGS. 98-100 show multi-housing versions of the previous center roller designs utilizing multiple instances of a housing similar to the housing of massaging device 1700 or massaging device 1800, and with multiple separate segments of massage elements, all arranged into one loop.

FIG. 98 shows a massaging device 2060 with two such center roller housings. The massage elements can be the same or different lengths. For example, a very short and stretchable massage element can be included as shown which can function much like a hinge of the previous embodiments for allowing angular change of the housings and their center rollers relative to each other but can also rotate for reducing friction and helping to propel the device. And a longer massage element as shown provides the stretch range and massage.

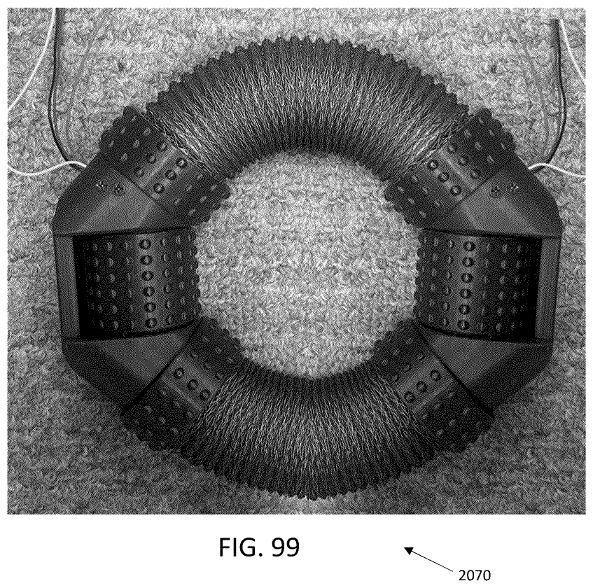

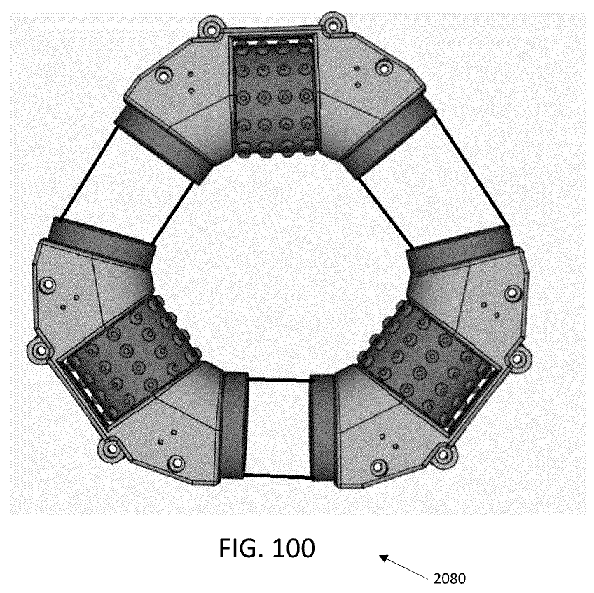

FIG. 99 shows a similar massaging device 2070 with two same-length massage elements all arranged in a single ring.

FIG. 100 shows a similar massaging device 2080 but with three housings, three center rollers, three massage elements, and three drive motors, with each housing contributing torque to each of its two adjacent massage elements.

The devices of FIGS. 98-100 generally all involve a tradeoff where a larger surface area of the devices is taken up by the rollers and housings for providing the radial pressure on the limb, which can be desirable in some cases for the sensation provided, but at the cost of less stretching range due to less massage element length overall. Winches in these variations can for example be located inside one of the massage elements as previously disclosed, or within one or more of the housings.

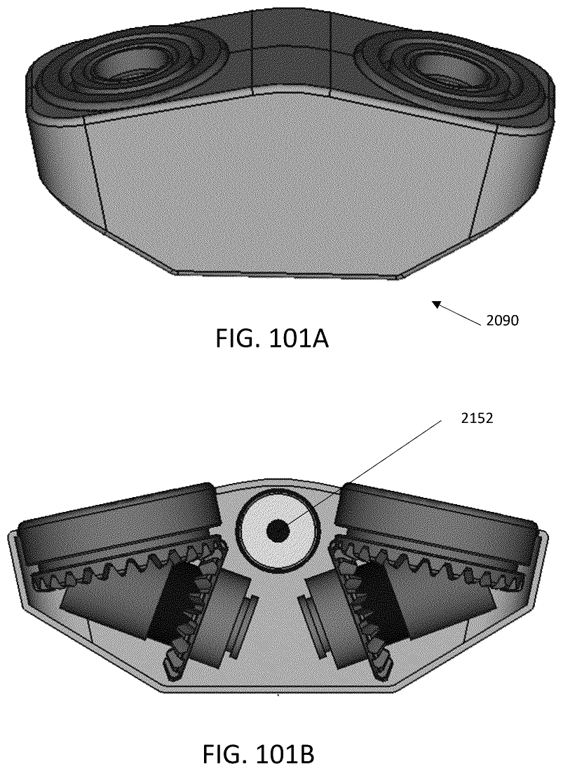

FIGS. 101A-B show another example of a massaging device 2090 of the present invention, where there are no exposed center rollers or massage element rollers. The massage element rollers can be fully enclosed in the device housing, and each roller can be driven by its own driver motor such as using a simple bevel gear connection as shown and previously described. The winch can be placed between the massage element rollers as shown. While such a design offers simplicity and can successfully drive the rollers, it can suffer from tilting and friction of the exposed housing rubbing against the limb as it moves.

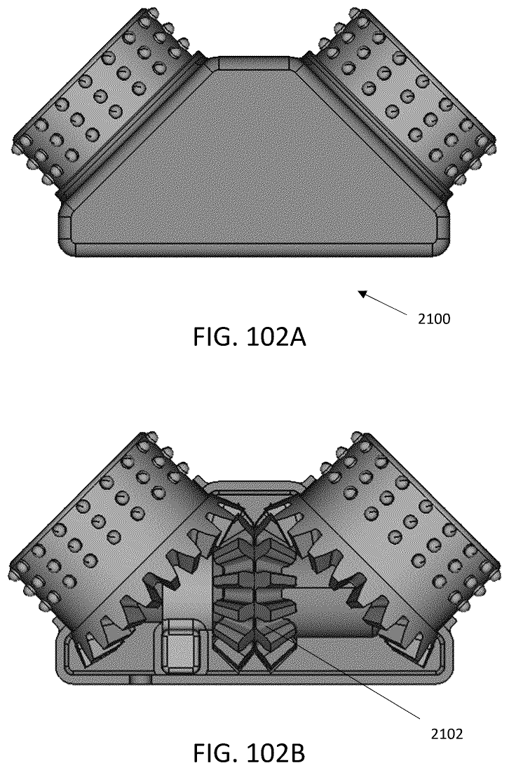

FIGS. 102A-B show another example of a massaging device 2100 of the prevent invention, utilizing a double-sided bevel gear 2102 situated over and rotated by a single driver motor for simultaneously rotating both massage element ends in the required directions for correctly driving the device.

The two previous embodiments can be enhanced for less tilting by moving outwards the motor mount locations or location for example, by making the housings wider, and extending the lengths of the motor holders to those outer peripheral edges of the housing to take advantage of the previously described lever arm effect, so the tilting point by the motor is shifted outwards and thus requires less force to counteract.

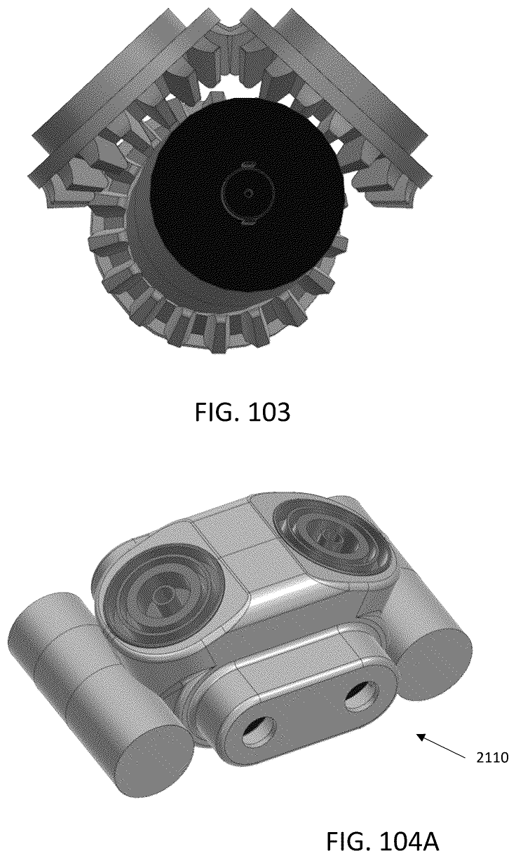

FIG. 103 shows another possible gear train for driving the massage element gears. In this example, a single driver motor is situated not across the housing but in the longitudinal direction in which the device travels along the limb. As shown, a bevel gear can be provided on the motor shaft which rotates only one of the massage element gears. The second massage element gear is in turn rotated by the first massage element gear (such as via a bevel gear connection). The second massage element gear cannot be directly connected to the motor gear because it would rotate in the wrong direction in this case.

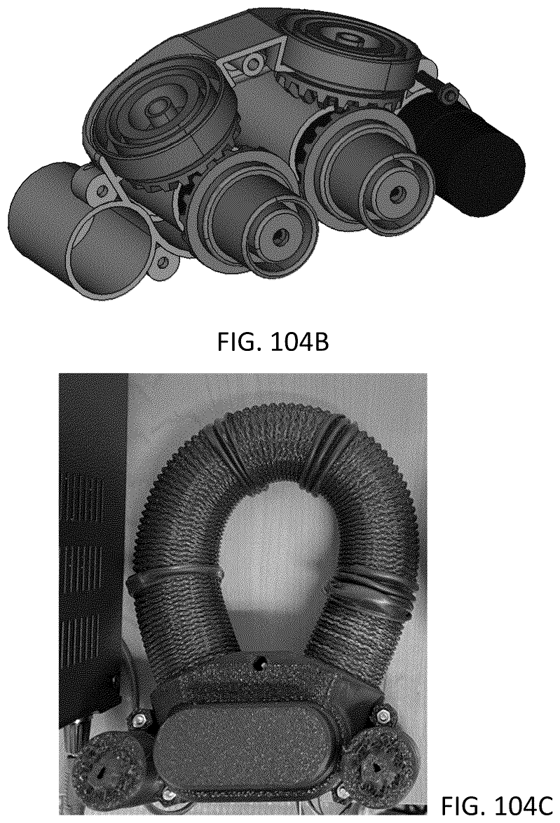

FIGS. 104A-C show another example of a massaging device 2110 of the prevent invention, utilizing two drive motors longitudinally mounted in the limb travel axis direction. Each motor can have bevel gears on its shaft for driving massage element gears and rollers mounted above it as shown in FIG. 104B, with a winch motor placed on one of the sides of the device as shown. A prototype of this device is shown in FIG. 104C.

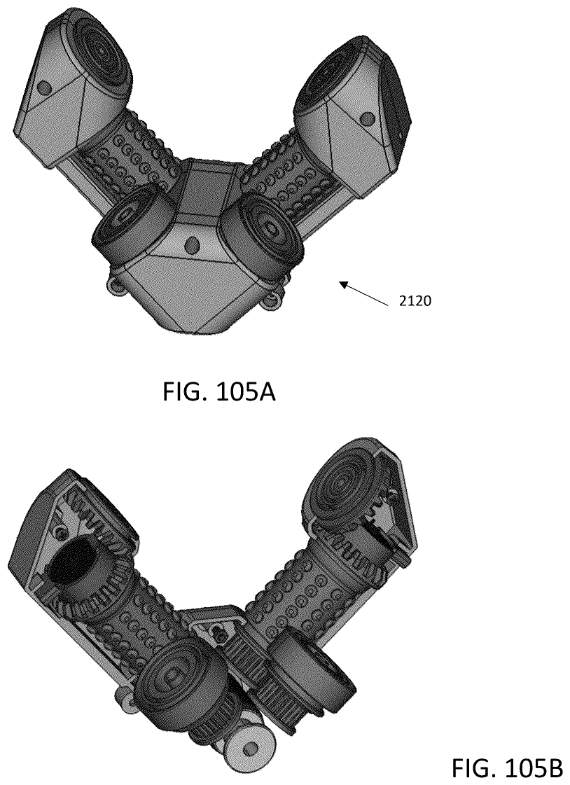

FIGS. 105A-B show another example of a massaging device 2120 utilizing drive belts to rotate the massage element rollers. In this case, two driver motors can be provided for directly rotating two motor rollers (rollers situated over the motors as shown), and with drive belt pulleys fixed at the ends of the motor rollers. The motor rollers can be oriented in a V shape for conformance to a limb. The pulleys at the ends of these motor rollers can engage via drive belts with pulleys mounted on the bottoms of the massage element rollers such that each motor roller and the massage element roller it drives rotate in the same directions. A second support massage element can be provided between the motor rollers using two bevel gears as shown for helping to prevent the device from tilting or sagging as it moves. A winch can be included near the bottom or side of the device for example.

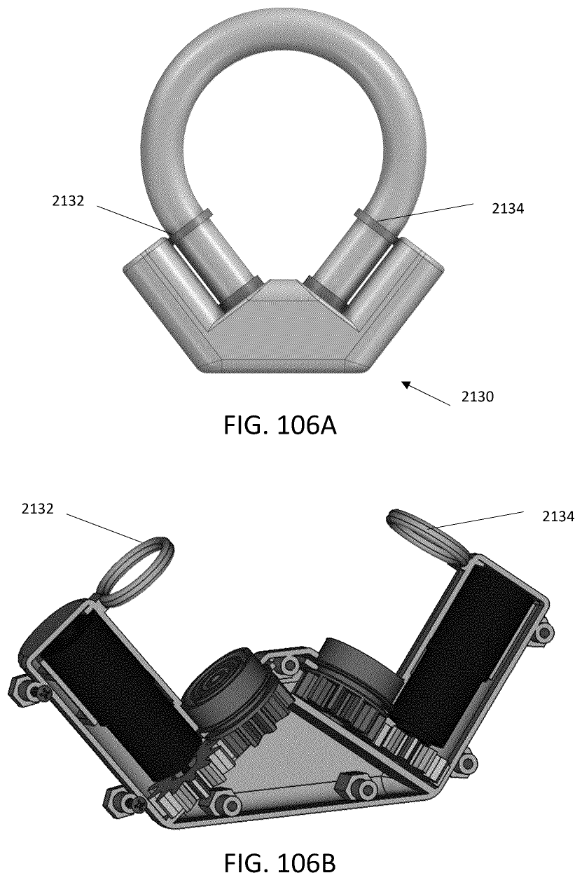

FIGS. 106A-B show another example of a massaging device 2130 with a wing shape housing. Driver motors can be situated in these wings as shown for driving spur, helical, or herringbone type gears (or other gear types) for driving similar massage element gears and their corresponding massage element rollers. Massage element holders 2132 and 2134 through which the massage element is fed, can be provided as part of the device housing, which can help reduce tilting of the device while only adding minimal friction for rotation of the massage element. When the housing attempts to tilt, it would also need to tilt the massage element encircling the limb. When the massage element is tightened with the winch, it can provide an effective support for preventing this undesirable tilting action.

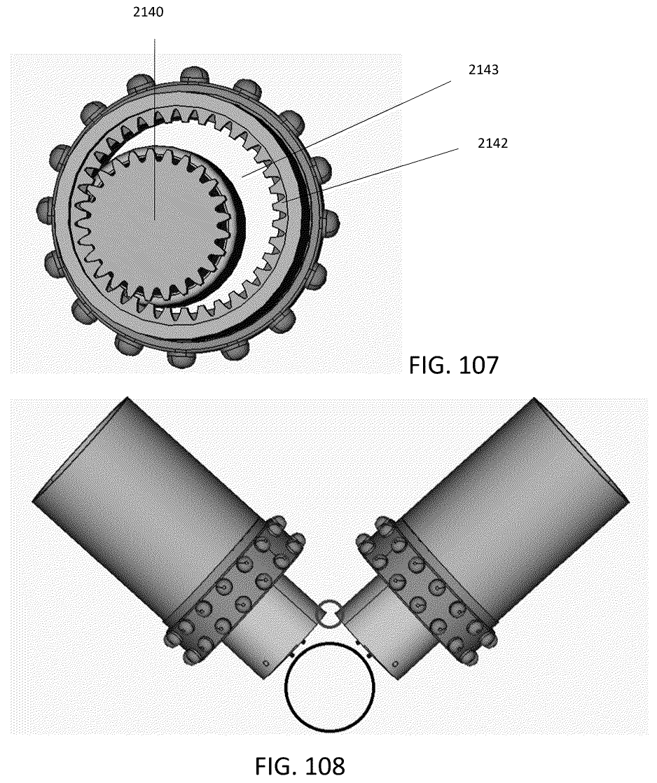

FIG. 107 shows an alternate gear train for driving a massage element roller, utilizing an internal gear 2140 and a ring gear or planetary gear 2142. In this arrangement, the driver motor can be inserted and contained off-center within the massage element roller and partially within the massage element itself as shown in FIG. 108. Two such driver motors and gear trains and massage element rollers can be provided and hinged as shown, along with a winch placed below or on one of the sides of the device for example.

The advantage of this gear train is that it allows the passage of the winch cable through a space 2143 created by the off-center internal gear 2140 and driver motor as visible in FIG. 107. Previously as discussed, if the driver motor is directly driving a massage element roller with the roller situated over its shaft and over the motor body, the motor blocks the escape of the winch cable. This arrangement would allow it while keeping the benefit of the efficient space arrangement of placing a driver motor inside the massage element. Also this gear train allows the motors to be situated at variable distances into the massage element ends, providing a good balance between space efficiency while allowing the massage element to more easily conform to any limb diameter by not being excessively blocked internally.

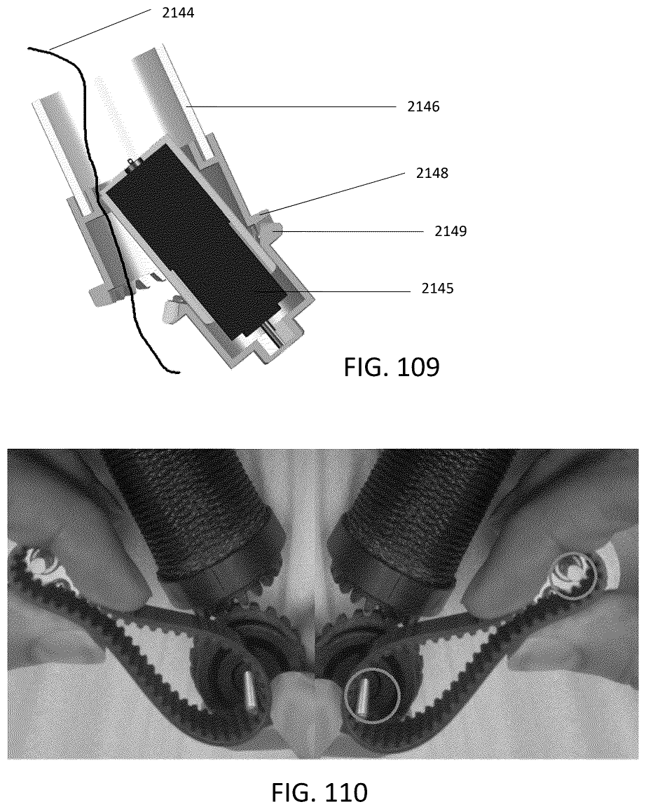

FIG. 109 shows an alternate gear train whose purpose also is to allow the passage of a winch cable 2144 when a driver motor 2145 is placed at least partially into a massage element 2146. In this case, driver motor 2145 can be inserted at an angle into massage element 2146 and using two bevel gears 2148 and 2149 engaged at a small angle to couple the motor shaft rotation to the massage element roller rotation. The angle of the motor relative to the massage element creates a gap through which winch cable 2144 can escape as shown, and through which driver motor 2145 can be held via a small motor holder.

FIG. 110 shows an alternate gear train and belt driver combination. Here two drive motors can be positioned longitudinally and above the level of the massage element gears. Drive belts with pulleys can be used as shown to drive bevel gears which in turn drive the massage element gears. This arrangement can provide the advantage of a higher center of mass of the motors for more stability.

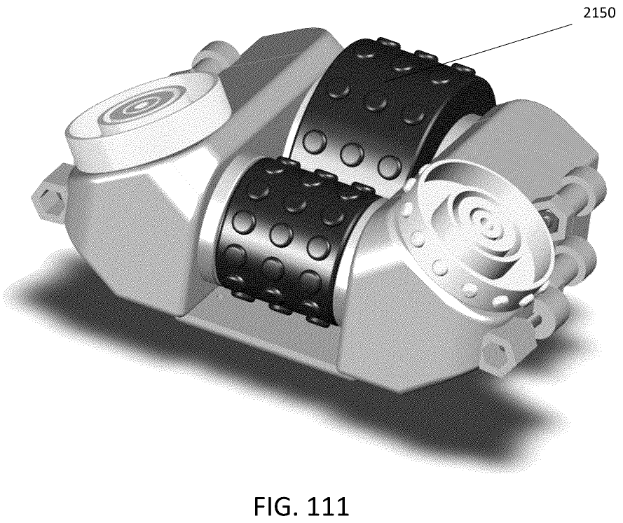

FIG. 111 shows a typical center roller embodiment discussed in previous embodiments, but with a passive large roller 2150 added on one side of the device to help support the device upright and resist tilting as the device travels along a limb.

One alternative pressure sensing approach is now described which can be used with any of the previous embodiments for determining the real-time pressure exerted by the winch cable together with the massage element, rollers, and device housing around a limb. Previous embodiments discussed various pressure sensors such as strain gauges placed at strategic points around the device housings to measure bending or flex as a proxy for pressure. In this new approach, sensing the current usage of the driver motors can provide a proxy for winch pressure. Since the winch cable runs directly through the massage element as discussed for applying pressure against the massage element and limb, when the cable is tightened, it immediately increases the load experienced by the drive motors. This in turn immediately increases the current usage which makes for convenient gauging of pressure. A standard current sending module such as an INA226 module can be used for example to measure this current change. For example, a brushless BLDC driver motor might require about 150 mAH to drive the massage element with no winch pressure. But when pressure is increased to a maximum point, this current usage might temporarily spike to for example 600 or 700 mAH. This range can be calibrated against radial pressures in mmHg. For example at 700mAH, it's possible to temporarily apply 150 mmHG or more to the limb while the device continues to move. Such a current sensing approach can replace the previously discussed pressure sensors or can serve as a supplementary signal.

As shown in FIG. 101B, a rotary encoder 2152 such as a magnetic rotary encoder or optical rotary encoder can be provided next to the spool of the previously discussed winch (for any embodiment) for measuring the real-time deployment length of the winch cable. This encoder and corresponding firmware can count the rotations of the spool for calculating the deployed length. Knowing this length can help to maintain a consistent radial limb pressure exerted by the winch cable due to the Law of Laplace where the pressure exerted by the winch cable is inversely proportional to the radius of the object or limb it is wrapped around. For example, when the device is wrapped around the upper thigh with a much larger radius than the ankle, a proportionally greater tension force in the winch cable may be provided to maintain the same radial pressure compared to for example when the device is wrapped around the ankle with a much smaller diameter. This is particularly useful when measuring tension in the cable as the limb pressure sensing means, such as with sensor 1766 in FIG. 78B, or by utilizing a load cell such as a dual threaded rod load cell, or a tension/compression or in-line load cell which can measure pulling force on a winch cable. Knowing the length of winch cable deployment can also help to avoid overwinding or unwinding too far so as to cause winding again which can confuse the device and lead to pressure release or increase functions being mixed up. In the previously disclosed hinged embodiments, it's also possible to use the extent of the hinging as measured by a rotary encoder or other sensor as a proxy for knowing the current limb diameter, since the hinge is generally flat when over a large diameter limb and angled steeply when over the narrowest limb areas.

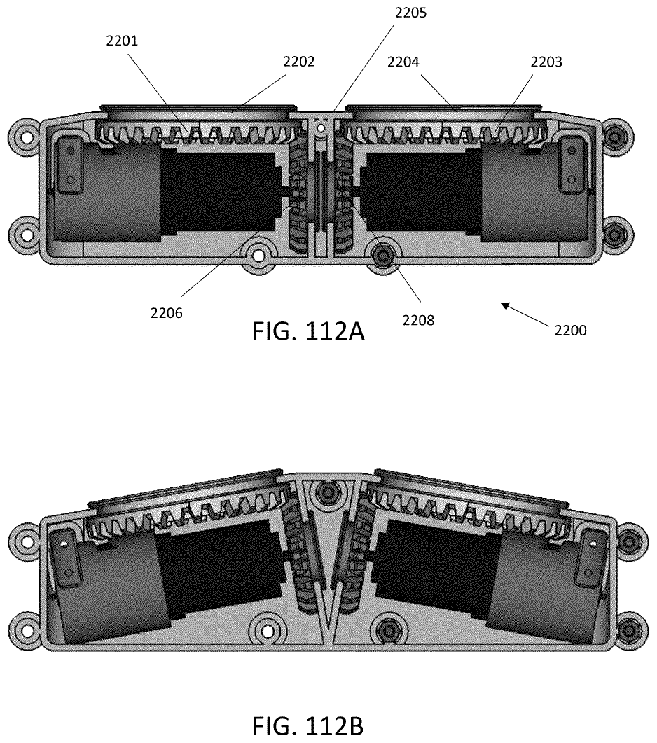

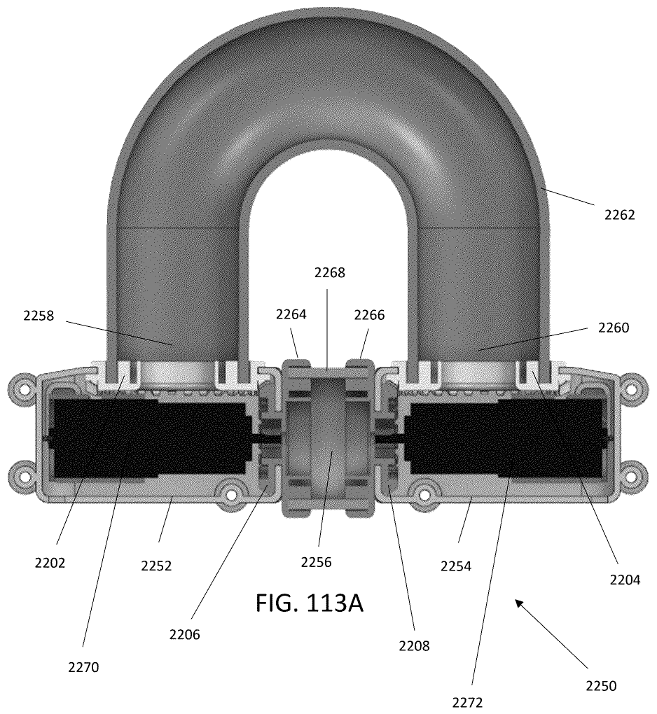

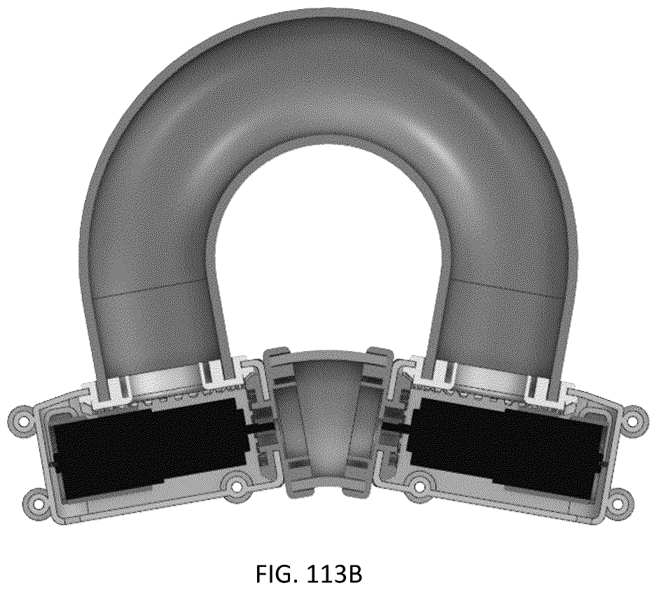

FIGS. 112A-B show another example of a massaging device 2200 of the present invention, similar to massaging device 2090 in FIGS. 101A-B with some additional refinements, where massage element rollers 2202 and 2204 can also be flush with a top surface 2205 of the device housing, which helps to minimize any gaps between the limb and top surface 2205 when a limb is placed into the limb opening of the massage element. In this embodiment, two driver motors can be used to drive motor gears 2206 and 2208 which engage with and drive massage element gears 2201 and 2203 mounted above them as shown and attached to massage element rollers 2202 and 2204. In this embodiment, the driver motors can be situated flat in the housing creating a very space efficient gear train for rotating the massage element—one that helps to minimize the thickness of the device housing as well as the gap distance between the massage element ends. In this embodiment, the massage element ends can be perpendicular to top surface 2205 (shown in a similar embodiment in FIG. 113A). In FIG. 112B, the driver motors are shown alternately mounted at an upward angle along with motor gears 2206 and 2208. Massage element rollers 2202 and 2204 can also be angled outwards here which can help the massage element better conform to wide limb areas like the upper thigh while still conforming adequately on the ankle. In this embodiment, the motor holders can be mounted at the outside and top areas of the device housing as shown, which can help reduce the tilting effect as previously discussed when the driver motors experience resistance.

FIGS. 113A-B show another example of a massaging device 2250 of the present invention, similar to massaging device 2200 in FIGS. 112A-B, but with the housing split into two halves 2252 and 2254, and with an added hinging element 2256 between them as shown for allowing housing halves 2252 and 2254 to rotate outwards along with massage element ends 2258 and 2260 of a massage element 2262 as shown in FIG. 113B. This allows the housing and massage element 2262 to dynamically adapt while the device travels along a limb for better conformity to the limb.

In FIG. 113A, hinging element 2256 can be a hinge, a bellows, or other accordion type structure, or a structure similar to any of the massage elements previously discussed. For example, as shown, hinging element 2256 can be a short massage element 2268 such as a tubular braided wire mesh previously discussed, which can optionally include corrugations 1466 on its surface for enhancing its radial strength as well as improving its torque transmission capacity. Short massage element 2268 can be mounted on both of its ends to hinge rollers 2264 and 2266, which can be attached to motor gears 2206 and 2208. This allows driver motors 2270 and 2272 to drive the rotation of both massage element 2262, as well as hinge rollers 2264 and 2266 along with short massage element 2268 between them. In this embodiment, hinge rollers 2264 and 2266 along with short massage element 2268 function similarly to the center rollers discussed in many previous embodiments, except that short massage element 2268 can stretch and bend and transmit rotation all at the same time. This helps to propel the device and avoids a stationary surface between massage element ends 2258 and 2260 dragging against the skin. Also this variation of hinging element 2256 helps to avoid pinching skin since the gap distance between massage element ends 2258 and 2260 is always closed and filled by short massage element 2268, whereas a typical hinge placed here could cause significant pinching as it opens. Massage element 2258 and short massage element 2268 can both contain an internal coil as previously discussed to reduce kinking and twisting.

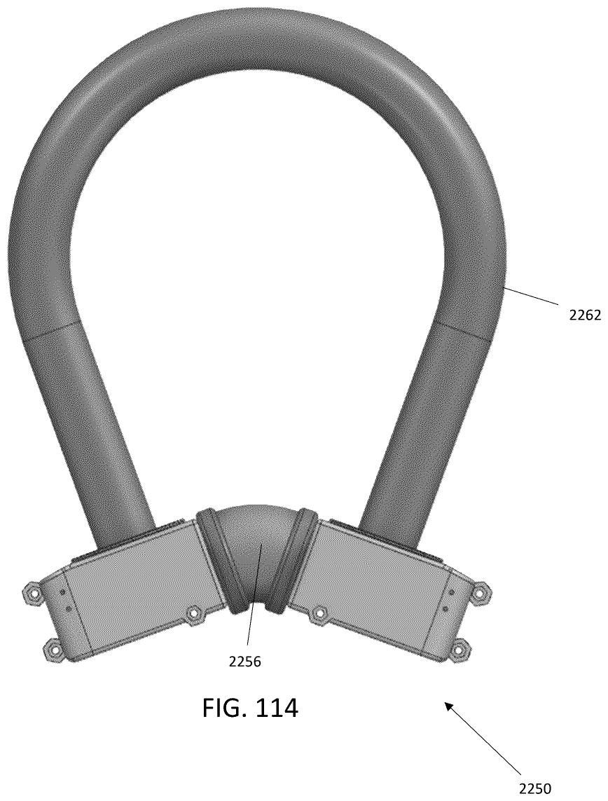

FIG. 114 shows massaging device 2250 as it may appear when massage element 2262 has been stretched to a considerable degree such as when traveling on the upper thigh of the leg, and with hinging element 2256 allowing housing halves 2252 and 2254 along with massage element 2262 to adapt to the shape of the limb.

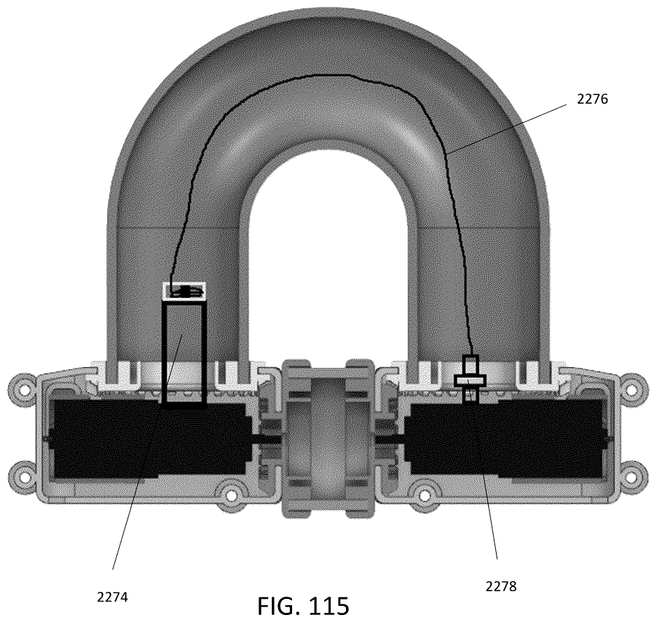

FIG. 115 shows massaging device 2250 with an added winch 2274, similar to winches previously discussed, shown here for example mounted in one end of massage element 2262, though winch 2274 could be placed in many other areas of the housing as previously discussed, such as on one side of the housing. A cable 2276 can travel from winch 2274 through a lumen of massage element 2262 to a pressure sensor 2278 for measuring the tension of cable 2276 and the resulting constriction of massage element 2262. Pressure sensor 2278 can be a load cell for example for measuring a pulling force.

It should be notated that in some of the previous embodiments, the massage element end rollers as an option, need not be in contact with the user's skin, as they can be internal rollers for the purpose of rotating the massage element ends.

In light of the technical advancements provided by the proposed disclosure, it shall be noted that the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true spirit being indicated by the following claims.

What is claimed is:

1. A self-propelling massaging device, the device comprising:
a housing having first and second ends;
a massage element having a first end, a second end, and a longitudinal axis, said massage element being configured to be rotatably coupled to the first and second ends of the housing and to form a limb opening; and
at least one drive motor in the housing configured to rotate the massage element about its longitudinal axis relative to the housing;
wherein massage element is configured to travel along the limb as the at least one drive motor rotates.

2. The device of claim 1, further comprising one or more rollers on the housing, wherein said one or more rollers are driven by the at least one drive motor.

3. The device of claim 2, wherein the one or more rollers comprise first and second rollers which are configured to be coupled to the first and second ends of the massage element.

4. The device of claim 3, wherein the first and second rollers are driven by a single drive motor.

5. The device of claim 3, comprising first and second drive motors coupled to the first and second rollers respectively.

6. The device of claim 3, wherein the housing is configured to hold the rollers in a V-shaped orientation.

7. The device of claim 3, wherein the housing is configured to hold the rollers in a parallel orientation.

8. The device of claim 3, wherein the housing is configured to hold the rollers in a laterally offset orientation.

9. The device of claim 3, wherein the rollers have hinged connections to the housing.

10. The device of claim 1, wherein the massage element is configured to longitudinally stretch over the limb.

11. The device of claim 10, wherein the massage element comprises a coil, a cord, a stretch band, a bellows, or a tubular braid mesh.

12. The device of claim 1, wherein the massage element comprises a tubular massage element.

13. The device of claim 12, further comprising a tensioning member disposed in a lumen of the tubular massage element.

14. The device of claim 13, wherein the tensioning member comprises a cable.

15. The device of claim 14, further comprising a tension motor in the housing, wherein the tension motor is configured to draw on at least one end of the cable to controllably constrict the tubular massage element about the limb.

16. The device of claim 15, further comprising a spool coupled to the tension motor and configured to take up the at least one end of the cable as the tension motor is driven.

17. The device of claim 16, further comprising a sensor configured to measure a pressure applied on the limb by the tensioning member.

18. The device of claim 17, further comprising a feedback system configured to control a tension force applied by the tension motor based on an output of the sensor.

19. The device of claim 1, wherein the massage element is detachable and replaceable from The device.

20. The device of claim 1, wherein the massage element is configurable with a plurality of textured protrusions for causing an enhanced massage stimulation to a body part.

21. The device of claim 1, wherein the massage element is made of elastic material.

22. The device of claim 1, wherein a diameter of the massage element dynamically adapts to a diameter of a body part as The device travels along the limb.

23. The device of claim 2, wherein the rollers are configured to function as secondary massage elements as The device travels along the limb.

24. The device of claim 23, wherein the rollers each comprise a plurality of protruding elements around an outer surface thereof to provide an enhanced massage stimulation to the limb.

25. The device of claim 1, further comprises a control unit for controlling operation of The device, wherein the control unit is disposed on or within the housing.

26. The device of claim 25, wherein the control unit is configured to control at least one of:
setting a distance range for each cycle of movement of the massage device along a body part,
controlling speed of rotation of the at least one drive motor, and powering-on or powering-off of The device.

27. The device of claim 25, wherein the control unit is configured to autonomously control the massaging device.

28. A method for massaging a user's body limb, said method comprising:
placing the user's body limb in an opening of a massaging device so that a massage element of the massaging device at least partially surrounds and contacts the user's body limb;
turning on a drive motor within the massaging device to cause the massage element to rotate about its longitudinal axis and to travel along the user's body limb to massage the user's body limb as it travels.

29. The method of claim 28, wherein the massage element stretches over the user's body limb to apply constricting tension on the user's body limb as the massage element travels along the user's body limb.

30. The method of claim 28, further comprising controlling tension on a tensioning element within the massage element as the massage element travels along the user's body limb, wherein tension on the tensioning element is controlled in response to pressure on the user's body limb measured by a sensor.
